(19) United States
(12) Patent Application Publication
(10) Pub. No.: US 2017/0024827 A1
(43) Pub. Date: Jan. 26, 2017

(54) DASHBOARD INTERFACE, PLATFORM, AND ENVIRONMENT FOR SUPPORTING COMPLEX TRANSACTIONS AND DERIVING INSIGHTS THEREFROM

(71) Applicant: AON SINGAPORE CENTRE FOR INNOVATION STRATEGY AND MANAGEMENT PTE., LTD., Singapore (SG)

(72) Inventors: Stephen P. MCGILL, Ware (GB); Stephen W. CROSS, Dalkey (IE); Stephen John Martin MILDENHALL, Oak Park (IL)

(73) Assignee: AON SINGAPORE CENTRE FOR INNOVATION STRATEGY AND MANAGEMENT PTE., LTD., Singapore (SG)

(21) Appl. No.: 15/286,405

(22) Filed: Oct. 5, 2016

Related U.S. Application Data
(63) Continuation-in-part of application No. 14/294,046, filed on Jun. 2, 2014, now abandoned.
Application No. 14/294,046 is a continuation-in-part of application No. 13/469,331, filed on May 11, 2012, now abandoned.
Application No. 14/294,046 is a continuation-in-part of application No. 13/469,355, filed on May 11, 2012, now abandoned.
Application No. 14/294,046 is a continuation-in-part of application No. 13/284,566, filed on Oct. 28, 2011, now abandoned.
Application No. 14/294,046 is a continuation-in-part of application No. 13/284,628, filed on Oct. 28, 2011, now abandoned.
Application No. 14/294,046 is a continuation-in-part of application No. 13/284,518, filed on Oct. 28, 2011, now abandoned.
(60) Provisional application No. 61/488,131, filed on May 19, 2011.
(60) Provisional application No. 61/488,126, filed on May 19, 2011.
(60) Provisional application No. 61/488,131, filed on May 19, 2011.
(60) Provisional application No. 61/488,126, filed on May 19, 2011.
(60) Provisional application No. 61/488,131, filed on May 19, 2011.
(60) Provisional application No. 61/488,126, filed on May 19, 2011.
(60) Provisional application No. 61/488,131, filed on May 19, 2011.
(60) Provisional application No. 61/488,126, filed on May 19, 2011.

(51) Int. Cl. G06Q 40/08

(52) U.S. Cl. CPC G06Q 40/08

(57) ABSTRACT

A dashboard interface, platform and environment for supporting transactions and deriving insights therefrom, in a preferred embodiment, includes a pipeline report graphical user interface including rows identifying renewal opportunities, row each involving a client and product, an interest registration graphical user interface for registering interest in a particular renewal opportunity presented in the pipeline report graphical user interface, a stages of interest tracking graphical user interface for tracking negotiation progress between a client and a provider, and a detailed interest tracking graphical user interface for tracking negotiation details related to the particular renewal opportunity.

### CROSS-REFERENCE TO RELATED APPLICATIONS

The present application is a continuation-in-part of and claims priority to U.S. patent application Ser. No. 14/294,046 filed Jun. 2, 2014. U.S. patent application Ser. No. 14/294,046 is a continuation-in-part of: U.S. patent application Ser. No. 13/469,331 filed May 11, 2012, which claims the benefit of U.S. Provisional Patent Application No. 61/488,131 filed May 19, 2011; U.S. patent application Ser. No. 13/469,355 filed May 11, 2012, which claims the benefit of U.S. Provisional Patent Application No. 61/488,126 filed May 19, 2011; U.S. patent application Ser. No. 13/284,566 filed Oct. 28, 2011, which claims the benefit of both U.S. Provisional Patent Application No. 61/488,131 and U.S. Provisional Patent Application No. 61/488,126; U.S. patent application Ser. No. 13/284,628 filed Oct. 28, 2011, which claims the benefit of both U.S. Provisional Patent Application No. 61/488,131 and U.S. Provisional Patent Application No. 61/488,126; and U.S. patent application Ser. No. 13/284,518 filed Oct. 28, 2011, which claims the benefit of both U.S. Provisional Patent Application No. 61/488,131 and U.S. Provisional Patent Application No. 61/488,126. The disclosure of each of the aforementioned applications is incorporated herein by reference in its entirety for all purposes.

### BACKGROUND

Insurance brokers act as intermediaries for their clients, which may be entities seeking insurance coverage for certain risks. Insurance brokers bring clients together with insurance providers (known as “insurance carriers”) who may be willing and able to provide the desired insurance coverage on beneficial terms for the client.

In bridging these two sides of the market, brokers may capture client requirements and details of risks that need to be insured. Insurance brokers may advise the client on what type of coverage should be considered by the client and the potential products offered by insurers that might be suitable to the client's needs, as well as advise on related matters (e.g., how the insurance policy coverage may be structured). Insurance brokers record client instructions and observations relating to proposed coverage, and then seek quotes from carriers on the basis of each client's requirements to find the coverage that best satisfies the client's needs in all respects. These records are generally inputted into one or more broker computing devices.

Brokers thus act effectively as the client's advocate in the markets in relation to its insurance needs. Accordingly, brokers aim to be a trusted advisor to their clients, to whom they owe their primary fiduciary duties. In order to achieve this aim, however, it is imperative that brokers are knowledgeable about the offerings of carriers, that they provide sound recommendations, and that they complete the process as quickly as possible for the client. Traditionally, this aim has been achieved in a largely unscientific manner, with brokers providing subjective advice on the basis of their personal experience with carriers and their instincts.

### SUMMARY OF ILLUSTRATIVE EMBODIMENTS

The present application describes dashboard user interfaces, methods, systems, and transactional environments for manipulating complex transaction data to identify trends and opportunities in a marketplace. An implementation of the dashboard user interface, system, and environment may be referred to herein as a Broker Dashboard. The Broker Dashboard may be a portion of an overall aggregation system called a global risk insight platform (GRIP). A broker, through the GRIP Broker Dashboard, can advise clients on making advantageous insurance decisions.

The GRIP system may advance the insurance sector by introducing for the first time a fact-based platform that allows brokers to support advice with sound statistical analysis. Generally, GRIP may utilize data collated by a broker in the course of its worldwide brokering operations to help predict, on the basis of past behavior, insurance carriers that are likely to have an appetite for a particular type of client risk, and to offer coverage appropriate to that client's needs. The GRIP technology captures key statistics obtained from business operations around insurance markets worldwide. It seeks to advance traditional broking services by introducing statistical analysis and modeling drawn from a broad pool of data which can support client decision-making. Its innovative technology permits a broker to harness the market insight that accompanies the company's placement of hundreds of thousands of deals brokered globally each year.

GRIP functions to collate and process historical and aggregated information crucial to the insurance policy decisions specific to buyers and sellers separately by class and geography around the globe. The information provided includes various transaction statistics that do not include individual trade pricing data. The data is presented in a user-friendly format that indicates in general terms the extent and approximate value of coverage which carriers are quoting and binding in particular classes and territories. Sophisticated algorithms allow a broker to predict insurance buying behavior in the coming months, thereby informing strategic marketing and buying decisions, and enabling its clients to stay ahead of the market.

Brokers and other entities may only be able to view global risk insight platform data specific to their country, region, state or other category used to identify a subset of data. Carriers are also able to obtain accumulated information on classes of business and territories in which they are interested. This benchmarking exercise allows carriers to assess in general terms how they are performing relative to their peers, which enables them to improve their products and services, and to make them more attractive to potential clients. Moreover, the platform provides insight into market conditions across multiple geographies. As such, access to global risk insight platform technology will provide an indirect benefit of forging a more coherent marketplace, by facilitating cross-border coverage.

Both sides of the market also benefit from an ‘introduction’ function, which brings together clients whose insurance policies are due for renewal and those carriers that have the risk appetites for that client's custom, typically in competition with the incumbent insurer. Clients benefit because the introduction of additional carriers increases competition among carriers for client business. The introduction function is another example of an insurer utilizing through a global risk insight platform the wealth of prior transaction data that it has at its disposal. The traditional means of brokering introductions between clients and carriers at renewal time was somewhat haphazard and reliant entirely on the knowledge possessed by individual brokers. GRIP may introduce a sophisticated and systematic introduction service which allows proactive matching of client needs to carrier risk appetite and which, in turn, allows all parties to deploy their resources more efficiently and objectively. It also enables a insurer to better understand the market as a whole and thereby to obtain the best terms and conditions for its clients, as an insurer continues to open its client renewal portfolio to all carriers, irrespective of whether they procure solutions offered by GRIP.

GRIP may create an increased degree of transparency in insurance markets, which on the one hand alerts brokers and their clients to market conditions worldwide, while on the other encourages carriers to offer clients increasingly differentiated offerings. In seeking to create this “virtuous circle,” the platform ensures that the global risk insight platform simultaneously protects from disclosure any confidential information that has the potential to facilitate collusion in the market.

The benchmarking service offered by GRIP may be one of the elements that provides the power to support brokers' instincts with facts and statistics across all major insurance markets. GRIP's ability to generate benchmarking statistics is currently the best tool to support brokers' instincts with facts and statistics across all major insurance markets. As mentioned above, before the development of GRIP, insurance broking involved a significant degree of subjective advice, based on the personal experiences of individual brokers. That subjectivity (and hence lack of precision) was not a necessary by-product of a competitive market, insofar as it did not yield more competitive negotiations in terms of range or price. On the contrary, it often led to market aberrations because of the inability of brokers to assess accurately many types of risk across various sectors and geographic regions.

Brokers predominantly used only their own instinct and experience to form an educated guess on the likely direction of insurance markets in order to obtain the best deals for their clients. This may have led to an inability of brokers to identify market aberrations in terms or pricing for similar lines of business for similar client industries in different geographic territories. It became commonplace for clients to demand more sophistication from their brokers, but no information tools previously existed to address the problem.

By inputting transaction data into a “state of the art” technology offering, GRIP may allow brokers to identify the carrier and policy structure that best suits each of the individual client's needs with far more speed and accuracy than may be generally available in the broking industry today. Because input of GRIP data occurs at both the quotation stage as well as at the bind stage, GRIP can draw insight to the shape of markets as they emerge. Brokers can predict the likely movement of markets with much greater precision, across a variety of product lines, than was possible prior to its introduction.

In some embodiments, GRIP trading data may be collected at three key points during the process of placing an insurance policy: first, when an insurer informs carriers about a client policy opportunity (known as a “trade” or a “submission”); second, when the chosen carriers provide their response to a policy proposal (“quote” or “decline”); and third, when the client decides which carrier option it wants to accept (a “hit”, a “win” or a “bind”). Opinion data is collected by way of responses to questionnaires. The information is collected by brokers and directly inputted by them into a GRIP database at the time of collection.

In some embodiments, GRIP provides two services: (1) the information provided to brokers for use with their clients; and (2) the information provided to carriers procuring global risk insight platform services. Both elements rely on the same underlying data, but each provides different levels of insight, presented in different ways. This differentiation is designed both to satisfy the commercial drivers of the different sides of the market and the desire to be competition law compliant. For example, carriers that access a global risk insight platform can access a basic (carrier-generic) information screen or (for example, for those carriers having a higher level subscription to the global risk insight platform) an individually tailored information screen, each known as a “carrier dashboard.” By contrast, brokers, on behalf of their clients, can only access specifically selected information (e.g., a stock viewpoint or customized portal) available through the “broker dashboard.” Each broker, in some embodiments, has a specialist dashboard, which is tailored to his own area of expertise.

GRIP allows brokers to identify the carrier and policy structure that best suits each of its individual client's needs with far more accuracy than is generally available in the broking industry previously. Because the input of GRIP data occurs at both the quotation stage as well as at the bind stage, the global risk insight platform can see the shape of markets as they emerge. Brokers can predict the likely movement of markets with much greater precision, across a variety of product lines, than was possible prior to its introduction.

GRIP may also introduce much more efficiency into the brokering process. Brokers can use GRIP to analyze by industry, segment, product and region, a carrier's record in converting trades into quotes and quotes into binds, thereby having a more precise view of those carriers with the strongest risk appetite for their clients. It can also look at factors such as retentions and limits, and begin to discern the different risk appetites of carriers for a particular product, based on a carrier's prior trading behavior and clients' own buying habits. This allows brokers to target submissions towards a range of carriers who are likely to have an appetite for a particular risk.

Because the GRIP technology may be able to provide information on market conditions in a variety of countries, it has the potential to promote cross-border and even pan-European trading where this is in the interest of a particular client. Because GRIP has a complete data set for trades which pass through its channels, it can show, for example, whether it might be more beneficial for a client to place a particular policy in Paris or in Amsterdam, assuming that a carrier is willing to write a risk across EU borders.

Another use of GRIP is the introduction service which it facilitates, through which carriers are given insight into when clients' existing insurance contracts are coming up for renewal. This effectively enables an insurer to institute on behalf of its clients an informal tender process for business which might not otherwise have been subject to much competition. This creation of greater visibility has the potential to invite greater interest in a client's customs and therefore more options for clients, whereas that client might otherwise have been tempted simply to renew its policy with the incumbent carrier. The introduction tool facilitates a systematic approach to understanding the options available to a client matching their needs with carrier deliverables. It also greatly improves carriers' ability to deploy their limited resources in the most effective way to meet client needs.

Again, however, the transparency created through the use of GRIP technology also inures to the benefit of carriers, insofar as the type of information to which they have access allows them to put together more robust, competitive service offerings. It is not the sort of transparency whose effect, nor whose intention, is to diminish the availability of competitive options. Instead, insurers can expect that with better information with which to communicate, brokers will be more up-to-date with the carrier's risk appetite and their value proposition, and will have a better understanding in general of clients' requirements and needs and their operating performance in relation to their peers. This will make interactions more efficient and effective allowing brokers to better provide value to clients and carriers and allow both reinsurers and carriers to serve the needs of their mutual clients in a better and faster manner.

As used herein, peers of a GRIP subscriber may be identified using a variety of techniques. In a first example, peer metrics may correspond to a top N (e.g., five, eight, ten, etc.) performers within the insurance marketplace. Performance may be determined based upon premium share, market share, or performance specific to a metric presently being accessed by a subscriber. In another example, subscribers of the insurance marketplace may be grouped by type (e.g., carrier, broker, reinsurer, etc.) and ranked within the group. In a particular example, carriers may be ranked based upon a weighted analysis of factors such as trade volume, pricing value, and premium share. From within the list of ranked subscribers, peers may be identified as being the nearest X above and Y below the present subscriber (e.g., three above and two below the present subscriber within the ranked list). In a more customized example, subscribers may be ranked based upon factors identified by the present subscriber. For example, the subscriber may list M factors (e.g., premium share, feedback score, quote to bind ratio, etc.) based upon relative importance to the subscriber, and using the ranked list the global risk insight platform may generate a ranked list of subscribers from which to identify the nearest (e.g., X above and Y below) peers to the present subscriber. In a further example, the subscriber may supply a threshold number of competitors, by name, to the global risk insight platform for use in presenting peer comparison data. The threshold, for example, may be selected to avoid the ability of the subscriber to identify competitor metrics as belonging to a particular competitor.

All data available to carriers on GRIP may be retrospective. Prior to being made available to carriers, the data may undergo a rigorous “cleansing” to ensure that data made available meets established standards. Data may also be processed by a processing entity, first to identify and correct anomalies, and then to perform the necessary analytics. The data undergoes this process for a period usually around 45 days, prior to being released into the global risk insight platform system on a quarterly basis. Upon its release, it is mingled into a data pool made up of significantly older data points, themselves anonymized and aggregated. This pooling process is designed to ensure that there can be no possible facilitation of any collusive practices, whether in theory or in practice, through the introduction of the data introduced quarterly.

In various embodiments, GRIP may provide hit rate, market flow, conversion rate, declination rate, broker insights, pipeline, statistics and other types of information to users.

Hit rate represents the proportion of quotes issued by a carrier which ultimately result in the provision of binding policies. As with quote rate, this information is particularly useful to brokers using a broker dashboard or portal to assess the likelihood that a particular carrier will be accepted by a client. For each phase, a dashboard or portal may track the market as a whole, and also allows a carrier to compare itself against the aggregate average performance of its anonymous top five competitors (e.g., top five performers within a certain realm of the insurance marketplace, five performers most similar to the present subscriber, etc.).

Market flow information may be available to carriers utilizing GRIP. Information may be presented on an annualized basis and is updated quarterly, through the process of mixing more recent information with existing older, anonymized, aggregated data. Again, it may be presented on a percentage basis, against the total book of business for a particular product, client industry and region. Users can also split the information to show incumbent against non-incumbent carriers.

Conversion rate represents the proportion of trades which ultimately re suit in binding quotes. It may be calculated by multiplying submission rates by quote rates and then by hit rates. As with submission rates, knowledge of conversion rates can allow a carrier to focus on particular industries and products in which it has an appetite for risk, and to greatly improve its service offering.

A carrier dashboard or portal may provide overviews from both the carrier and client perspective on the reasons why insurance proposals have been declined. This information is input by the broker at the time that either the carrier or the client declines a quote, and is selected from one of twenty standardized declination reasons. The carrier may then be presented with the top five reasons for declination (as a percentage of the total reasons for declination), and split further according to the carrier's preferences by reference to product, industry and deal size. The declination rationale data tool is clearly performance enhancing, as it enables carriers to determine key areas in which their performance can be improved.

A broker insights screen may be provided to present clients with key customer opinion data. It may be based on the established Net Promoter Score (“NPS”) customer loyalty metric. At its root, an NPS rating is obtained by asking customers, on a “0 to 10” rating scale, how likely they would be to recommend a product to a friend or colleague. Based on their responses, customers are categorized into one of three groups: Promoters (9-10 rating), Passives (7-8 rating), and Detractors (0-6 rating). The percentage of Detractors is then subtracted from the percentage of Promoters to obtain a Net Promoter Score. Under the NPS system, companies are encouraged to supplement this question with further queries, thereby soliciting the reasons for a customer's rating of that company or product. These reasons can then be provided to front-line employees and management teams for follow-up action.

A GRIP dashboard or portal may provide two elements in a pipeline opportunity monitoring section. The first is a statistical analysis of an insurer's renewal book of business, while the second is a report of upcoming policy renewal opportunities. A pipeline statistical analysis tool may show for each selected geographic area the total number and total value of renewal possibilities on a reinsurer's book of business falling due in the next six months. Carriers can view this information by product or by industry. This tool assists carriers in planning their future business. Brokers do not have access to the carrier dashboard.

A pipeline report tool may list opportunities arising from existing policies that are brokered which are due for renewal in the near term. The information available in this case includes client name, industry, product, approximate deal size, region, and month of maturity.

### BRIEF DESCRIPTION OF THE FIGURES

FIGS. 1A through 1F illustrate dashboard user interfaces for reviewing and analyzing insurance transaction information and other statistical data collected via an insurance marketplace environment.

FIG. 2 illustrates a process flow diagram of an example method for preparing a report regarding target opportunities.

FIGS. 3A, 3B, and 3F illustrate example scatter plots for presenting information in a benchmarking report.

FIGS. 3C through 3E illustrate example bar graphs for presenting information in a benchmarking report.

FIGS. 4A and 4B illustrate example charts demonstrating sector distributions in a benchmarking report.

FIGS. 5A through 5C illustrate example bar graphs demonstrating product category distributions in a benchmarking report.

FIGS. 6A through 6F illustrate example bar graphs demonstrating product metric comparison to a selected peer group in a benchmarking report.

FIGS. 7A through 7C illustrate example scatter plots demonstrating product metric comparison to a selected peer group in a benchmarking report.

FIG. 8 illustrates a process flow diagram of a method that may be used to generate insurance transaction statistics.

FIG. 9 illustrates a screen adapted to receive transaction data through a set of input fields.

FIG. 10 illustrates a display embodiment showing a set of aggregate insurance premiums mapped by geographic region with corresponding trade counts.

FIG. 11 illustrates a display arrangement that maps aggregate insurance premiums for each of set of insurance carriers.

FIG. 12 illustrates a display arrangement of insurance transaction statistics that includes a premium amount of aggregate bound policies and an aggregate trade count statistic associated with each of a set of insurance carriers.

FIG. 13 illustrates a display arrangement of insurance transaction statistics that include submit-to-quote ratios associated with each of a set of insurance carriers.

FIG. 14 illustrates a display arrangement of transaction statistics including carrier declined submissions.

FIGS. 15A through 15C illustrate display arrangements involving pricing trends and rate changes.

FIG. 16A illustrates a trading flow display arrangement of one of three key metrics over a period of time.

FIG. 16B illustrates a submission flow graph for an insurance segment where only the selected carrier is plotted with an average competitor line.

FIG. 17 illustrates a data display arrangement of key metrics for four previous quarters for both a selected insurance carrier and top competitors to the insurance carrier.

FIGS. 18A and 18B illustrate display arrangements of carrier losses.

FIG. 19A illustrates a display arrangement of aggregate carrier declination reasons.

FIG. 19B illustrates a data display arrangement of insurance policy trade declination reasons for a carrier.

FIG. 19C illustrates a data display arrangement of insurance policy trade declination reasons for a client.

FIG. 19D illustrates a detail analysis of insurance policy trade declination reasons.

FIG. 20A illustrates a display arrangement of broker insights based on carrier performance survey(s).

FIG. 20B illustrates that the broker insights display arrangement may include options to display details on carrier performance based on a lifecycle segment of the broking process.

FIG. 21A illustrates a pipeline data display arrangement showing transaction opportunities for an insurance carrier forecast over an upcoming period of time.

FIG. 21B illustrates a report that may be generated from a pipeline display.

FIGS. 21C and 21D illustrate pipeline data display arrangements showing transaction opportunities for which one or more brokers initially registered interest via the global risk insight platform.

FIGS. 22A and 22B illustrate data display arrangements of premium share showing statistics of carrier written premium and overall premium share across a broker company's top insurance product lines.

FIG. 23 illustrates an exemplary portal screenshot that includes risk data.

FIG. 24 illustrates an example screenshot presenting high level summary information regarding competitive performance of a reinsurer within a global market.

FIGS. 25A through 25F illustrate example screenshots presenting benchmarking of the performance of a reinsurer against a group of peer competitors.

FIGS. 26A and 26B illustrate example screenshots presenting a premium flow analysis between geographical regions.

FIG. 26C illustrates an example screenshot presenting a cross sale analysis demonstrating penetration of a reinsurer's business.

FIG. 26D illustrates an example screenshot of a cedent purchase pattern analysis.

FIG. 26E illustrates an example screenshot of a performance analysis of a reinsurer compared to overall market pricing.

FIG. 27 illustrates a flow chart of an example method for determining strategic and tactical components of performance metrics.

FIGS. 28A and 28B illustrate various aspects of an exemplary architecture implementing a global risk insight platform (GRIP).

FIGS. 28C and 28D depict a web server connected via a network to a number of tablets and other web-enabled devices through which a user may initiate and interact with the GRIP system.

FIG. 29 is a block diagram of an example distributed computing environment including a cloud computing environment.

### DETAILED DESCRIPTION

The present disclosure describes methods, systems, and transactional environments for supply knowledge and insight to insurance brokers, reinsurance brokers, and insurance carriers in an insurance marketplace environment. Aspects of the present disclosure discuss aggregating insurance transaction data and generating insurance policy transaction statistics (also referred to herein as insurance transaction statistics or just transaction statistics) for display to an insurance broker or reinsurance broker via a computing device (e.g. through a dashboard user interface). Data on insurance policy transactions may be collected from each of a number of subscriber (insurance and reinsurance) computing devices that are located across a wide geography. The data may be filtered for specific parameter values and these parameter values may be aggregated across the number of computing devices. Insurance policy transaction statistics may then be generated based on the aggregated data and organized into unique data combinations and display arrangements to assist a broker in servicing insurance clients and insurance carriers. The insurance policy transaction statistics may then be made available for display on one or more of the computing devices via a broker dashboard user interface or a reinsurance dashboard user interface.

Aspects of the present disclosure describe methods, systems, and transactional environments enabling entities (insurance carriers, reinsurance carriers, and insurance brokers) to interact with a global risk insight platform and insurance marketplace environment via graphical user interface dashboards. The terms entity and subscriber are each used herein to describe one or more of insurance carriers, reinsurance carriers, and insurance brokers. Each dashboard includes a number of controls configured, upon selection, to present the entity (insurance carriers, reinsurance carriers, and insurance brokers) with information relevant to the type of entity. The controls presented to a particular entity may be configurable based upon a user profile. For example, an insurance carrier may select various features (widgets, controls, and/or other information displays) to include within a customized dashboard. The level of customization, in some embodiments, may be based upon a subscriber level associated with the particular subscriber (e.g., customization may be an option based upon payment of an additional fee). In another example, features provided within the dashboard may be designated in part upon a user authorization level. For example, an insurance broker employed by a brokerage may have access to a limited view of business metrics, while a CEO or board member may have unlimited access to business metrics.

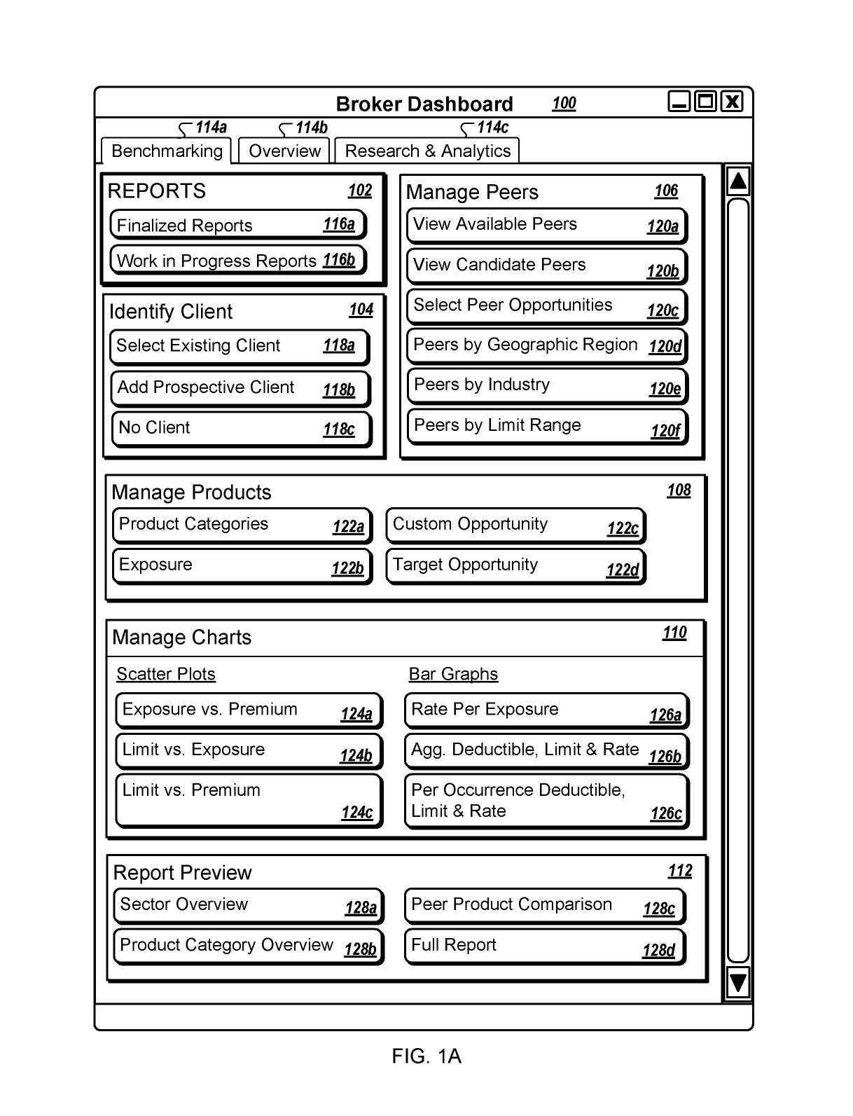

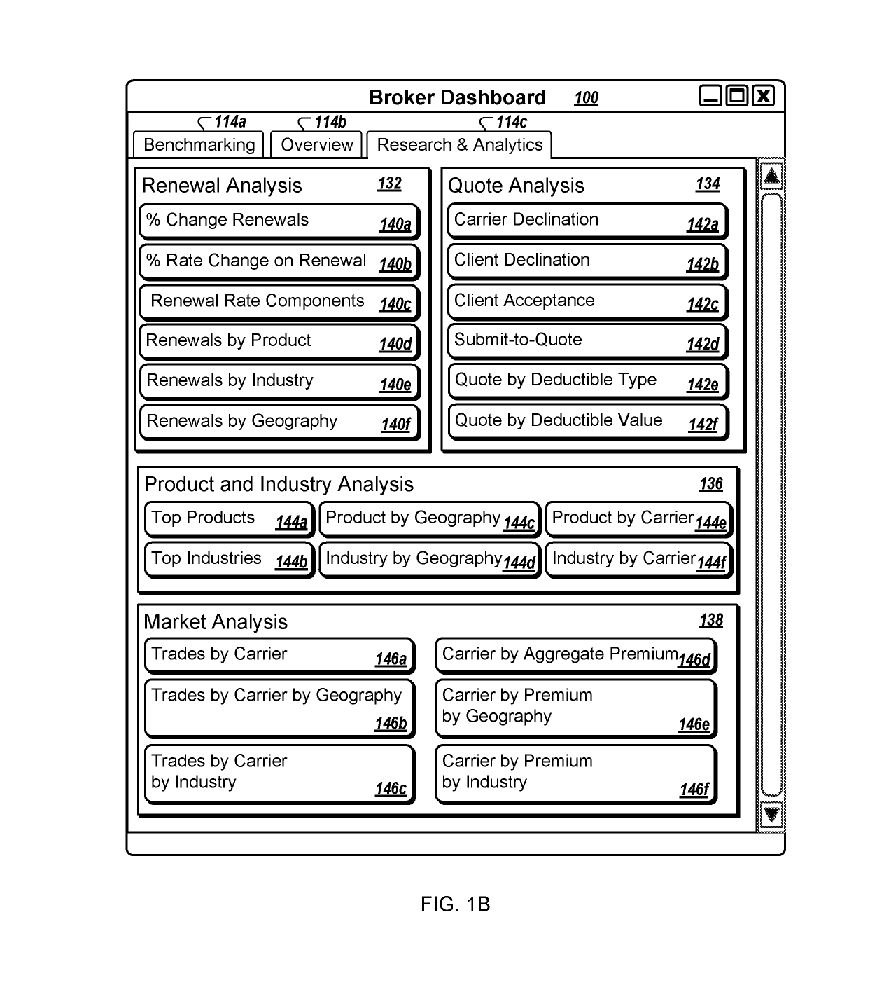

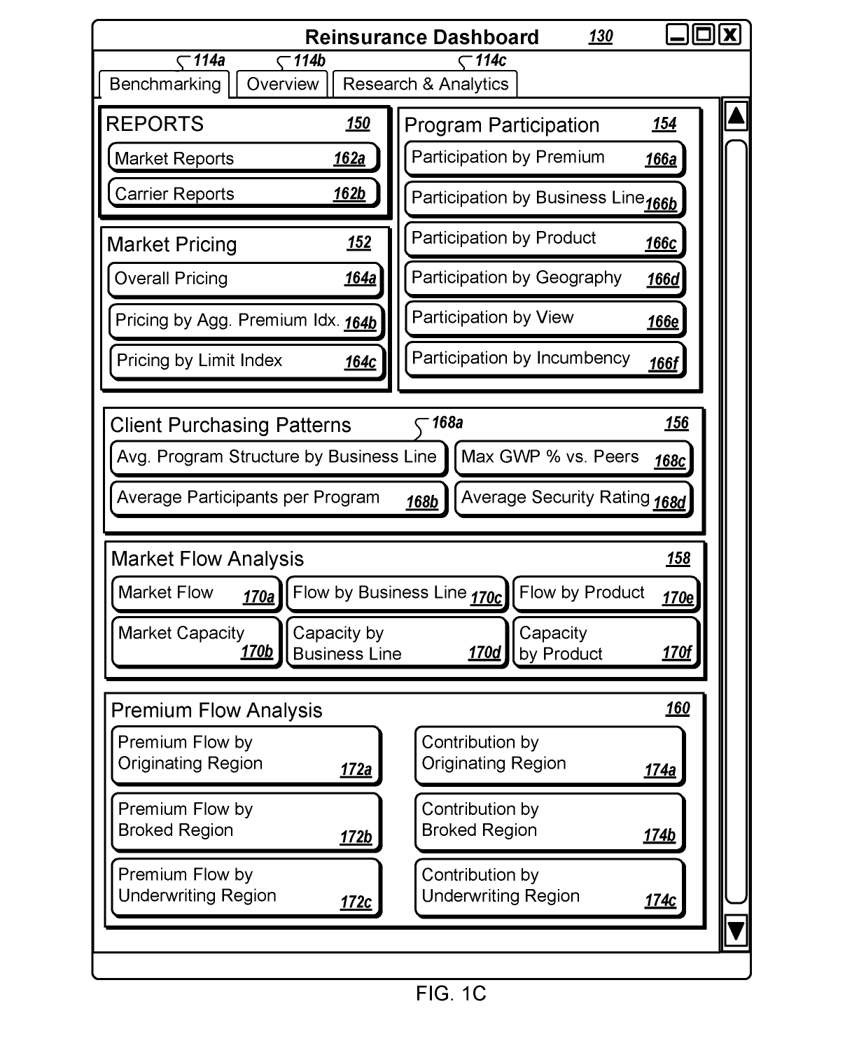

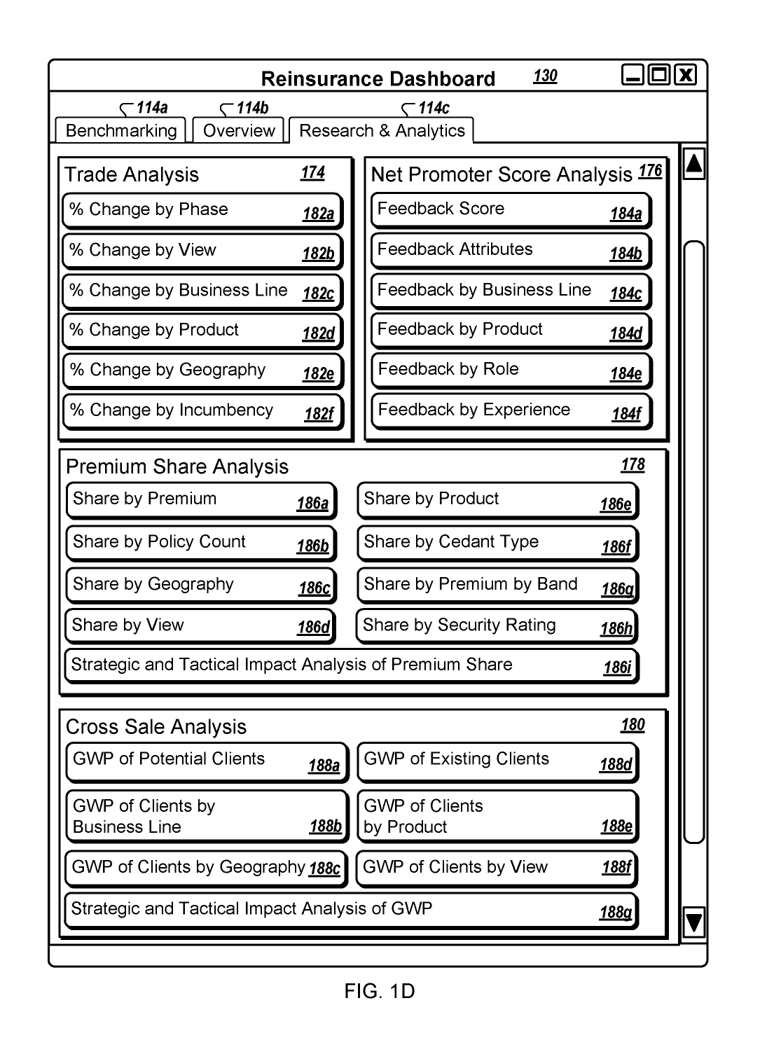

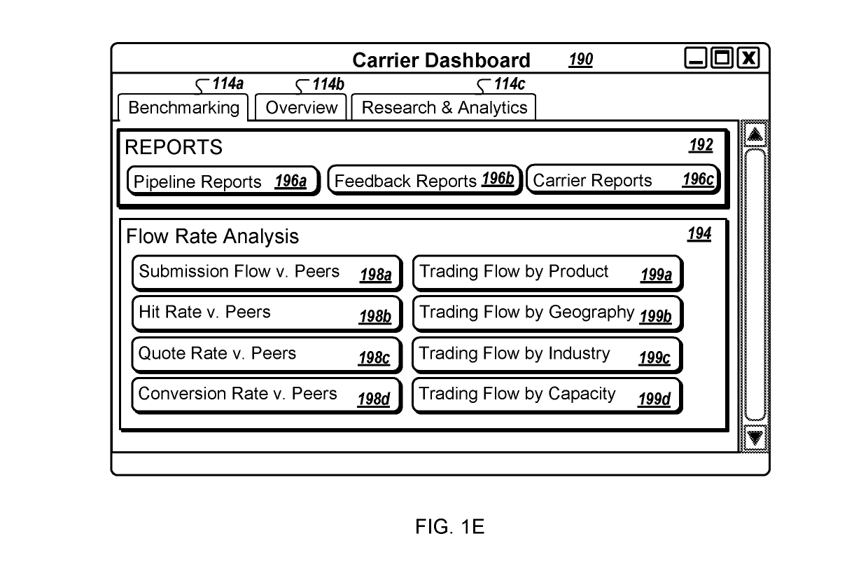

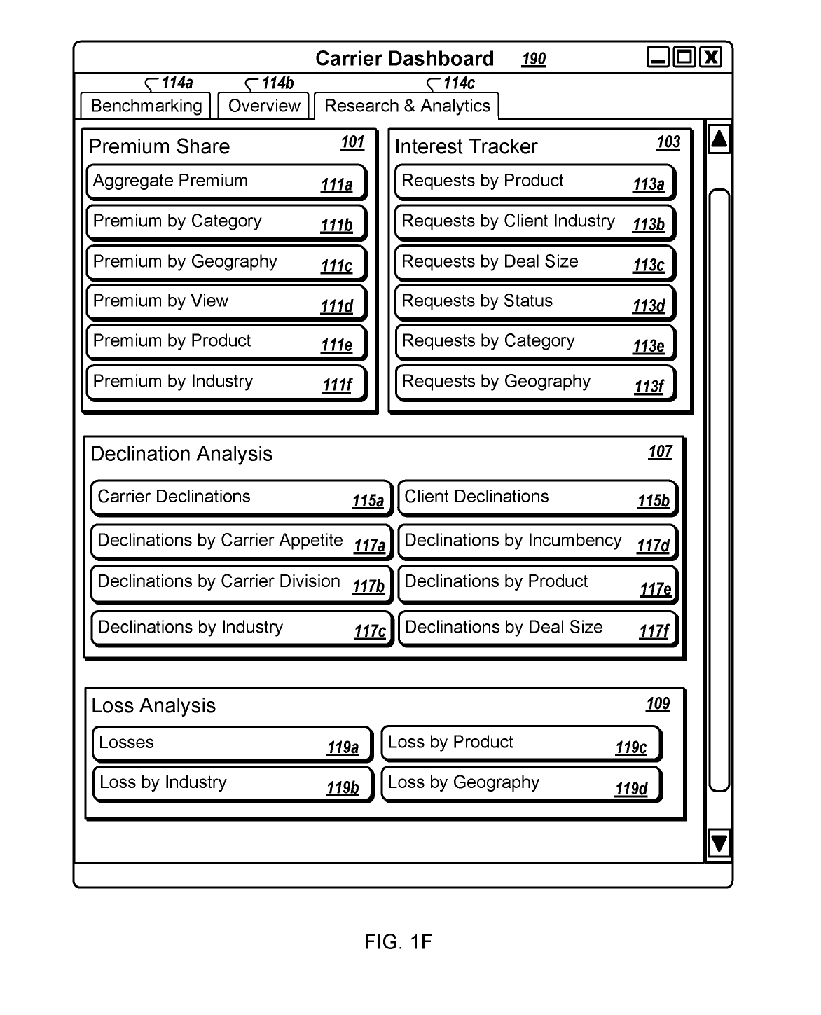

Beginning with the insurance brokers, FIGS. 1A and 1B are screenshots of an example broker dashboard 100 for accessing insurance client and brokerage information via a global risk insight platform and insurance marketplace environment. The dashboard 100 is part of a web site, web portal, personal computer application, or mobile device application configured to allow the broker to interface with the global risk insight platform and insurance marketplace environment.

The dashboard 100 is open to a “benchmarking” tab 114a. Other tabs available to the broker include an “overview” tab 114b and a “research and analytics” tab 114c. The broker may navigate to the additional tabs 114 to access different information. For example, the “overview” tab 114b may present a customized set of widgets presenting quick information important to daily activities of the broker. Example aspects of the “research and analytics” tab 114c are described in relation to FIG. 1B, below.

As shown in FIG. 1A, a “reports” pane 102 presents the broker with two navigation controls 116 for accessing benchmarking reports. A broker can utilize benchmarking reports to understand and confirm limits, compare client exposures and risk placements to the exposures and risk placements of a client's peers, evaluate premium spending within a category (e.g., sector, geography, product, etc.), and challenge rates by reviewing whether a client's rates are in line with peer rates (e.g., overall, per geography, per sector, per product, etc.). The broker may review product benchmarking reports, for example, to gain insights into client sectors, product purchasing patterns, and/or client positions in relation to selected peers. A first navigation control 116a, when selected, presents the broker a list of previously created benchmarking reports. Through the first navigation control 116a, in some examples, the broker can review, download (e.g., to a portable memory device), print, share (e.g., email, fax, etc.), and/or delete an existing report. A second navigation control 116b, when selected, presents the broker with a list of in-progress benchmarking reports, for example created in part on a prior occasion and suspended for further edit. In addition, in some implementations, previously created reports may be edited and modified by selecting the “finalized reports” navigation control 116a.

To create a new report, in some implementations, a user selects client information via an “identify client” pane 104. The “identify client” pane 104 includes three navigation controls 118—a “select existing client” control 118a, an “add prospective client” control 118b, and a “no client” control 118c. Upon activation of the “select existing client” control 118a, for example, the broker may be presented with a drop-down menu, search box, or other selection control for identifying a client that currently has an insurance program with the insurance marketplace environment. The client may be an existing client of the broker, or the client may have an account with the insurance marketplace without having a preexisting relationship with the broker. The “add prospective client” control 118b, upon selection, allows the broker to add a client that does not yet have an account with the insurance marketplace. The broker, for example, may enter a name of the new client. The global risk insight platform may attempt to locate a same or similar client name within the insurance marketplace, upon receipt of the identified prospective client, to avoid duplicates within the global risk insight platform and insurance marketplace environment. If the client does not yet exist within the insurance marketplace environment, the prospective client may be added. Optionally, information regarding the prospective client may be added through the “add prospective client” control 118b. For example, the broker may enter business sector, geographical location, business size, and/or business maturity information to categorize the type of prospective client entered.

If the broker wishes to generate a report that is not associated with a particular client, the broker selects the “no client” control 118c. In this manner, the broker can set up benchmarking reports to follow trends through the identification of key preexisting clients by identifying those clients using a “manage peers” pane 106. In another example, the broker may select the “no client” control 118c to create a basic report style that can later be copied and assigned to one or more prospective and/or existing clients. For example, upon receiving program information, the basic “no client” report may be modified through addition of prospective client information. In another example, the broker may prepare an example report for a prospective client which does not wish to disclose information at this time. This is also useful when the broker has no program information regarding a prospective client.

In some implementations, the broker can add one or more products to the new benchmarking report through a “manage products” pane 108. For example, the broker may select a “product categories” navigation control 122a to navigate information regarding product categories and product types. For example, upon selection of the “product categories” navigation control 122a, the broker dashboard 100 may present a list of product categories, such as, in some examples, automobile, casualty, employee benefits, employers liability, products liability, professional indemnity, and property insurance. If the broker selected a preexisting client through the “select existing client” navigational control 118a, the broker dashboard 100 may promote the products purchased by the selected client within product category selection. For example, the products purchased by the selected client may be rendered in bold, a different color, highlighted, and/or promoted to the beginning of the list to allow the broker ease of selection of relevant products to the selected client. The broker may instead or additionally opt to identify one or more products not yet purchased by the selected client, for example as penetration opportunities.

Furthermore, within each product category, the broker may be provided one or more exposure variables for selection. For example, upon selection of an “exposure” control 122b, the broker may refine selected products by desired exposure(s). Within the category of professional indemnity, exposure variables may include, in some examples, revenue/sales, square footage, total assets, total insured value, and/or number of policy years. The broker may select a number of product/exposure combinations through the “product categories” navigational control 122a and/or the “exposure” navigational control 122b. The global risk insight platform, in some embodiments, limits the maximum number of products or product/exposure combinations available within a single report. In a particular example, the global risk insight platform may limit the broker in selecting more than four, five, or eight products. Larger reports, for example, may become unwieldy or confusing for a client to digest, and multiple reports may be generated on behalf of a single client.

The broker may choose to select a target opportunity for the selected (preexisting or prospective) client through a “target opportunity” control 122d. For example, the broker dashboard 100, upon selection of the “target opportunity” control 122d, may be present the broker with one or more available opportunities for one or more of the selected product/exposure combinations. For example, for any product/exposure combination not already purchased by the selected client, the global risk insight platform may search for available opportunities. Each opportunity presented, for example, may include a premium value, exposure amount, limit, and deductible. If, instead, no available opportunity has been identified for the selected client for a particular product/exposure combination, the broker dashboard 100 may issue an alert to the broker (e.g., pop-up message, flag, warning icon, etc.) regarding a lack of available opportunity.

If the selected client has provided program information, the broker may select a “custom opportunity” navigational control 122d to enter customized opportunity information. For example, upon selection of the “custom opportunity” navigational control 122d, the broker dashboard 100 may present the broker with an interface configured for entry of custom data representing exposure value, premium, limit, deductible type, and deductible value. Although the custom opportunity is entered by the global risk information platform for the purposes of the present report, the custom opportunity, in some embodiments, is not added to the insurance marketplace environment for selection outside of the scope of the present report.

Upon identification of a client using the navigation controls 118 (and, optionally, one or more products via the “manage products” pane 108), the broker can identify peers of the client (or, if no client was identified, a selected group of clients) through the “manage peers” pane 106. By selecting a “view available peers” navigational control 120a, for example, the broker dashboard 100 may present the broker with an interface for selection of peers from a list of existing clients of the insurance marketplace environment. The peers, in some embodiments, may be limited to clients that have purchased the products identified by the broker through the “manage products” pane 108. To aid in selection, the broker dashboard 100 may present selected information regarding each available peer such as, in some examples, a country, premium level, exposure amount, limit, deductible type, industry, and business sector description.

Identification of an existing client as a peer of the identified client (e.g., existing or prospective), in some examples, can include comparing client demographic information. In one example, the peers of an identified client include other clients within a same employment sector. The demographics, in other examples, can include geographic location, size, and/or maturity. By selecting a “view candidate peers” navigational control 120b, in some implementations, the broker dashboard 100 presents the broker with a list of candidate peers, evaluated based upon demographic information corresponding to the selected client. In other implementations, the “view candidate peers” navigational control 120b, upon selection, presents the broker with a list of the one or more peers already selected (e.g., while the broker is continuing to fill in an incomplete report). In further embodiments, the broker may supply an example peer (e.g., a main competitor of a prospective client), and the platform may select a list of candidate peers based upon the demographic information of the example peer. For example, upon identification of a particular fertilizer company, other agricultural and/or industrial chemical organizations of a same size/geography/maturity may be identified. Further, the platform may suggest industries and/or product interests based upon the example peer demographic information. For example, upon identification of a delivery service, the platform may recommend searching for peers based upon organizations that have purchased motor fleet products.

In some implementations, to focus in on the type peers the broker is interested in, the broker may select a “peers by geographic region” navigational control 120d, a “peers by industry” navigational control 120e, and/or a “peers by limit range control” 120f. Additionally, in some implementations, the filters may be used consecutively or concurrently, such as peers by geography and by industry or peers by limit range and by industry. Other possibilities for filtering clients for selection include peers by premium range, peers by exposure range, peers by deductible type, and/or peers by business maturity.

When presenting potential peers on the basis of product/exposure comparison, the platform may highlight the quality of data available for each peer. For example, the broker may wish to obtain data representative of at least the past two years. Any potential peer without available information for the full time period may be deemed ineligible as a candidate peer. Further, although data is available, in some embodiments the platform identifies a concern towards the quality of the data. For example, the data for a particular candidate peer may be deemed questionable due to one or more inconsistencies between data values maintained by the insurance marketplace environment. Inconsistencies may include, in some examples, differences in insurance platform premium value and billing system premium value, an exposure value lower than a threshold level (e.g., 10 for value exposures and 4 for number of exposures), limits less than a threshold level (e.g., 10), and/or premiums less than a threshold level (e.g., 10). In the circumstance of missing data or severe validation errors, the global risk information platform may disable selection of a particular candidate peer (e.g., data cannot be trusted).

In some implementations, the broker selects a “select peer opportunities” navigational control 120c to refine the candidate peers by particular opportunities (e.g., products/exposures). For example, a given candidate peer may have purchased a number of products through the insurance marketplace environment. The broker may refine candidate peers, further, by applying one or more filters. The filter criteria, in some examples, may include geographic region, year(s) of data to review, premium amount (or range), limit amount (or range), exposure amount (or range), industry, and/or Standard Industrial Classification (SIC) code. The global risk information platform, in some embodiments, requires a minimum threshold number of selected peers relevant to each selected opportunity for generation of a report. For example, the dashboard 100 may require that the broker activate at least five peer candidates for a given opportunity opportunities. Additionally, the dashboard 100 may limit the broker to a threshold maximum number of opportunities, such as twenty opportunities.

In some implementations, upon selection of peer opportunities, the broker dashboard 100 provides the broker the opportunity to select one or more peer comparison charts for presentation of peer comparison benchmarking statistics. Within a “manage charts” pane 110, the broker is presented with graphical display options, including a number of types of scatter plots 124 and bar graphs 126, each presenting different statistical information.

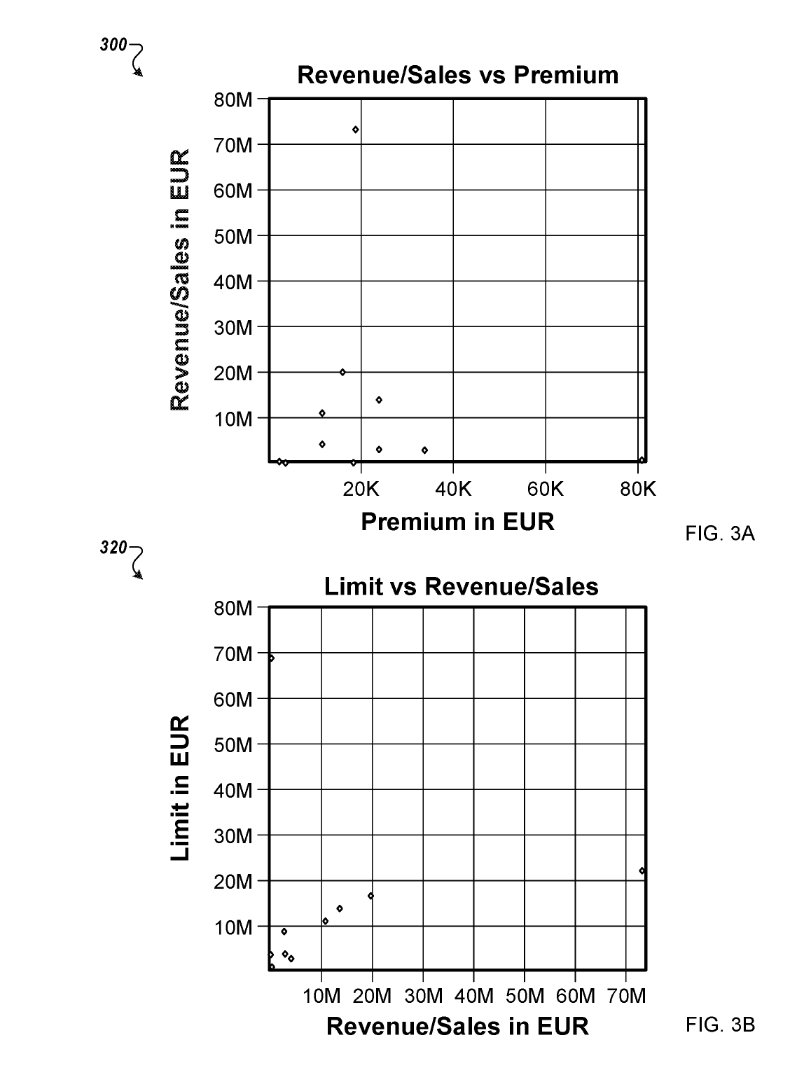

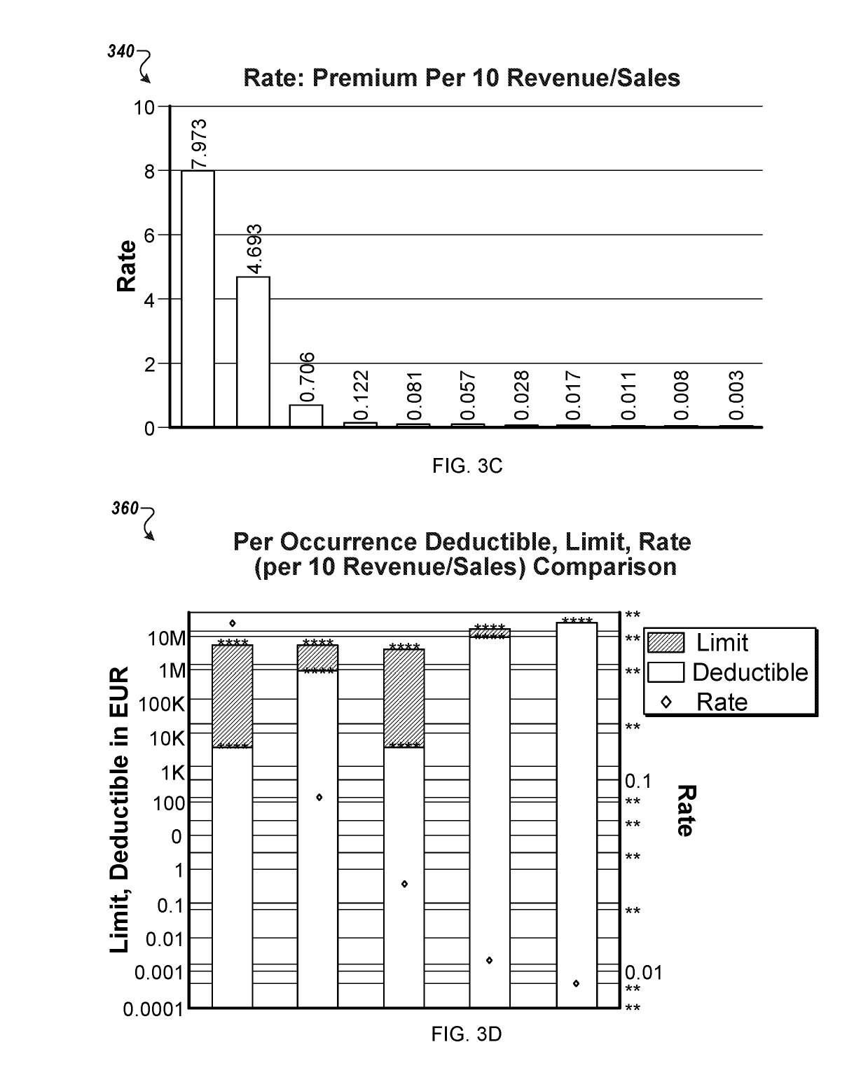

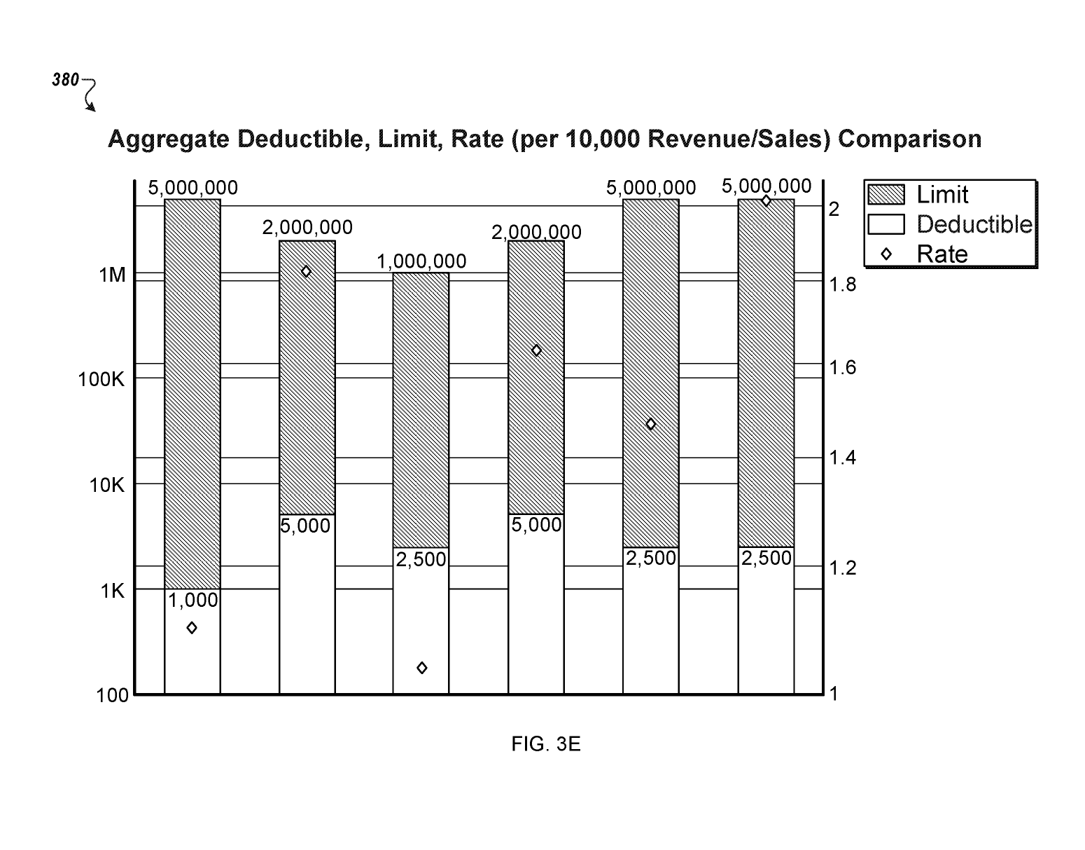

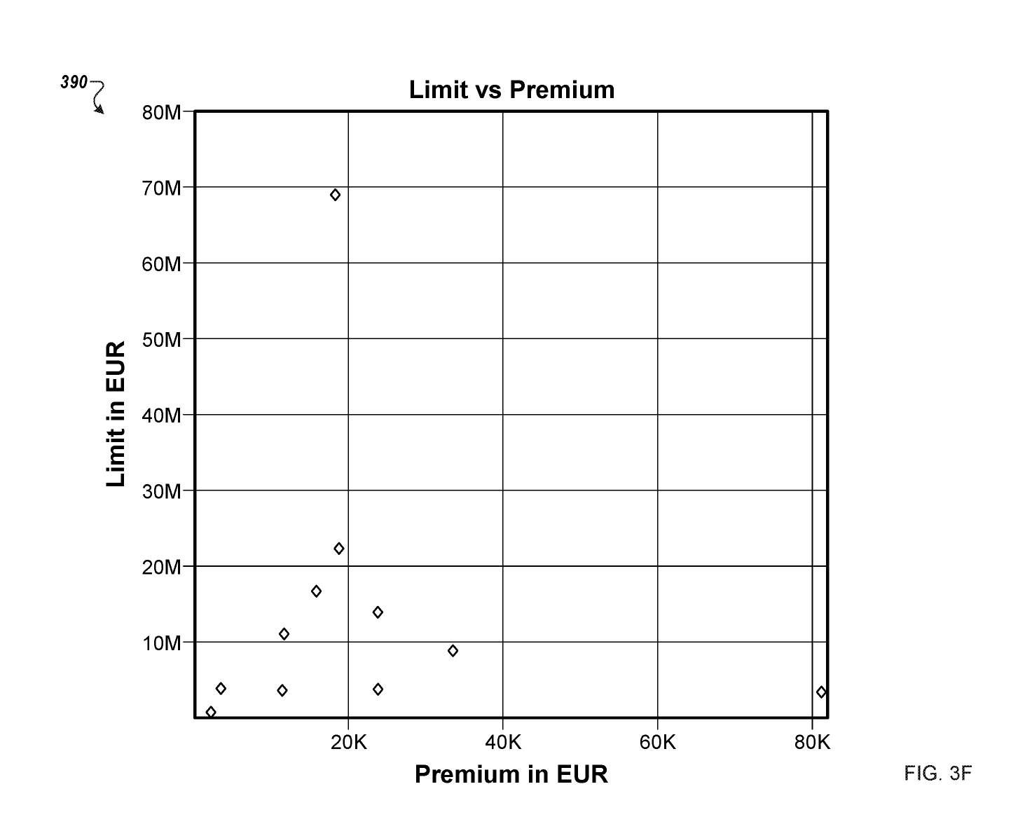

As illustrated, the scatter plots options 124 include an “exposure vs. premium” plot type control 124a, a “limit vs. exposure” plot type control 124b and a “limit vs. premium” plot type control 124c. Turning to FIG. 3A, an example plot 300 illustrates a scatter distribution of exposure versus premium (e.g., as made available by the “exposure vs. premium” plot type control 124a). Each data point, for example, may correspond to a particular peer. Further, if the broker opted to include data from more than one year, in some embodiments, each year of peer data may be illustrated separately (e.g., a 2011 data point and a 2012 data point). If an existing client was identified, a data point representing the client is included within the scatter plot 300. In this manner, the client may compare its data metric to peer distribution of the same metric. The peers, as noted earlier, are rendered anonymously to protect individual data representations. Similar in rendering to the example plot 300, an example plot 320 of FIG. 3B illustrates a scatter distribution of limit versus exposure (e.g., as made available by the “limit vs. exposure” plot type control 124b), and an example plot 390 of FIG. 3F illustrates a scatter distribution of limit versus premium (e.g., as made available by the “limit vs. premium” plot type control 124c).

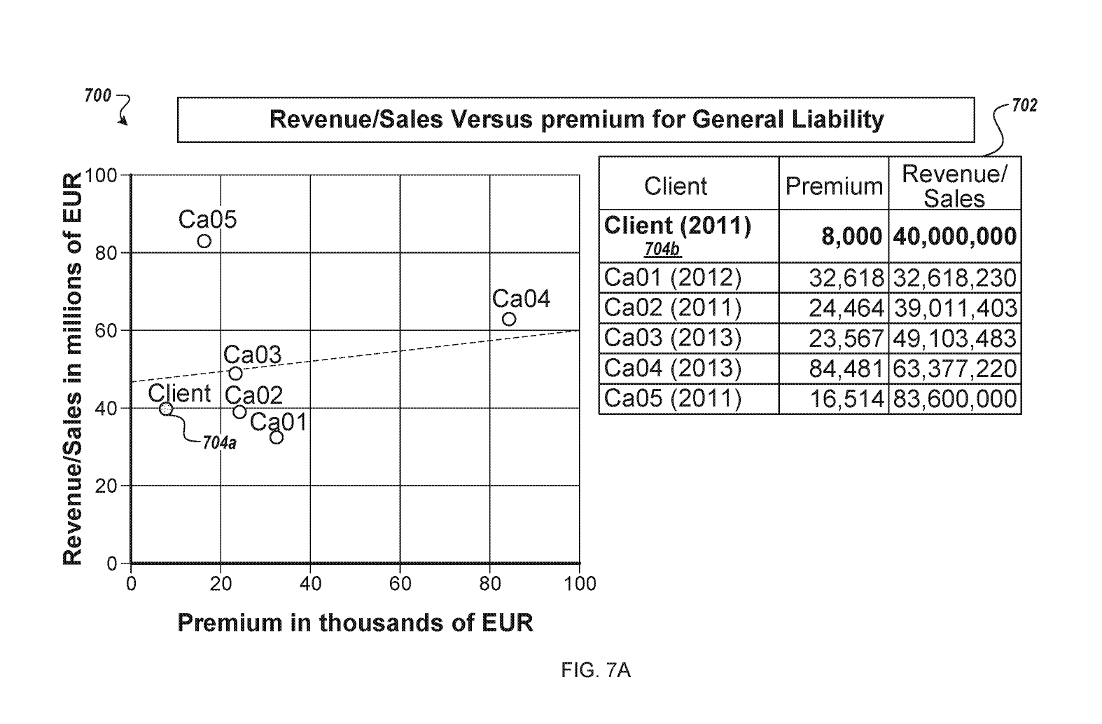

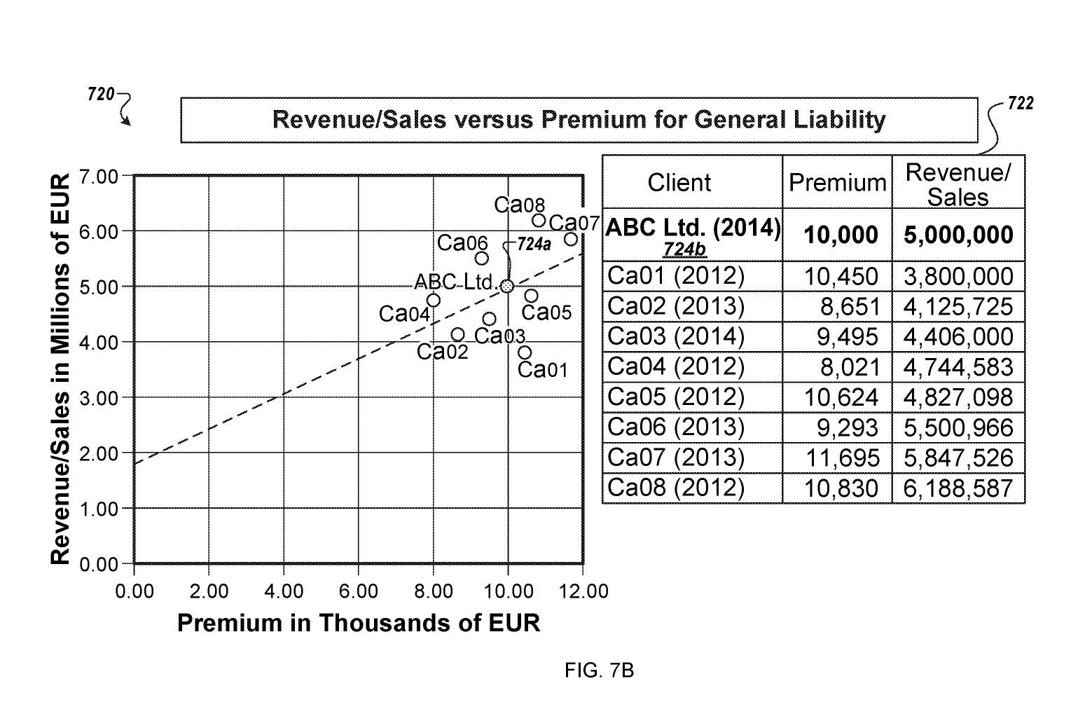

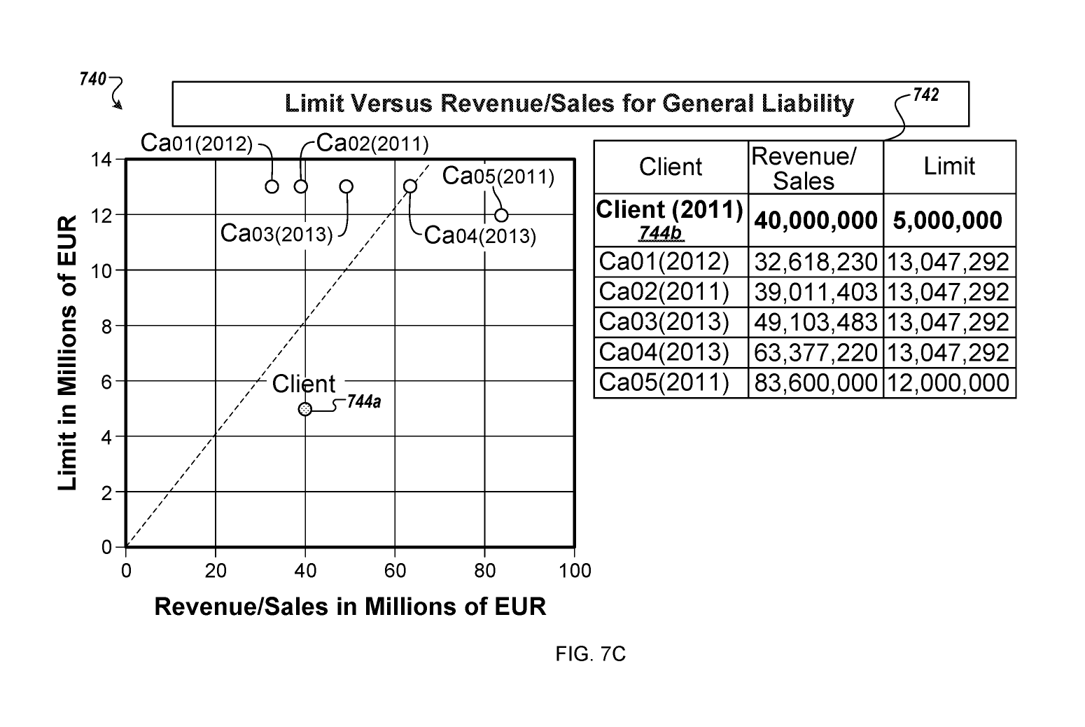

When reviewing scatter plots, the more linear the peer data appears in the plot, the stronger the relationship between the two elements. As illustrated in FIGS. 3A and 3F, the selected peers do not represent a strong relationship trend between the elements, while the peers in FIG. 3B do represent a strong relationship trend between the limit and revenue/sales elements. [As noted above, to protect statistical data representing individual clients, the clients are not identified within the plots 300 and 320. In the circumstance of a preexisting selected client, however, the plot representing the selected client may be identified using a unique identifier (e.g., shape, color, and/or label). In some embodiments, the scatter plots 300, 320, and 390 illustrate “summary” or “preview” plots. For example, in a computer-based hyperlinked report, selection of one of the scatter plots 300, 320, or 390 may present the broker with a more detailed version of the selected plot 300, 320, or 390 similar to, for example, the graph 720 of FIG. 7B. In another example, during report creation, the user interface may present thumbnail or preview plots to the broker upon the broker having entered a threshold number (e.g., five) of peer opportunities.

Returning to FIG. 1A, as illustrated, the bar graphs 126 include a “rate per exposure” graph type control 126a, an “aggregate deductible, limit and rate” graph type control 126b, and a “per occurrence deductible, limit, and rate” graph type control 126c. Example bar graphs are illustrated in FIGS. 3C through 3E. As noted above, to protect statistical data representing individual clients, the clients are not identified within the graphs 340, 360, and 380. In the circumstance of a preexisting selected client, however, the bar representing the selected client may be identified using a unique identifier (e.g., shape, color, and/or label).

Turning to FIG. 3C, an example graph 340 illustrates a graphic comparison of rate per exposure (e.g., as made available by the “rate per exposure” graph type control 126a). An example graph 360 of FIG. 3D illustrates a graphic comparison of per occurrence deductible, limit and rate (e.g., as made available by the “per occurrence deductible, limit, and rate” graph type control 126c). The graph 360 reflects a comparison of five different peers sharing a particular deductible type. Rate information is represented by scatter plot markers applied upon each bar, while each bar represents both a deductible (lower portion) as well as a limit (upper portion). Turning to FIG. 3E, an example bar graph 380 illustrates a graphic comparison of aggregate deductible, limit and rate (e.g., as made available by the “aggregate deductible, limit, and rate” graph type control 126b). The graph 380 reflects a comparison of six different clients sharing a particular deductible type. Rate information is represented by scatter plot markers applied upon each bar, while each bar represents both a deductible (lower portion) as well as a limit (upper portion). As with the scatter plots of FIGS. 3A, 3B, and 3F, the bar graphs of FIGS. 3C through 3E may represent thumbnail or preview graphs, available to the broker to preview report information during the report preparation process. The graphs presented within the report may include a higher level of detail than the information presented within the bar graphs of FIGS. 3C through 3E.

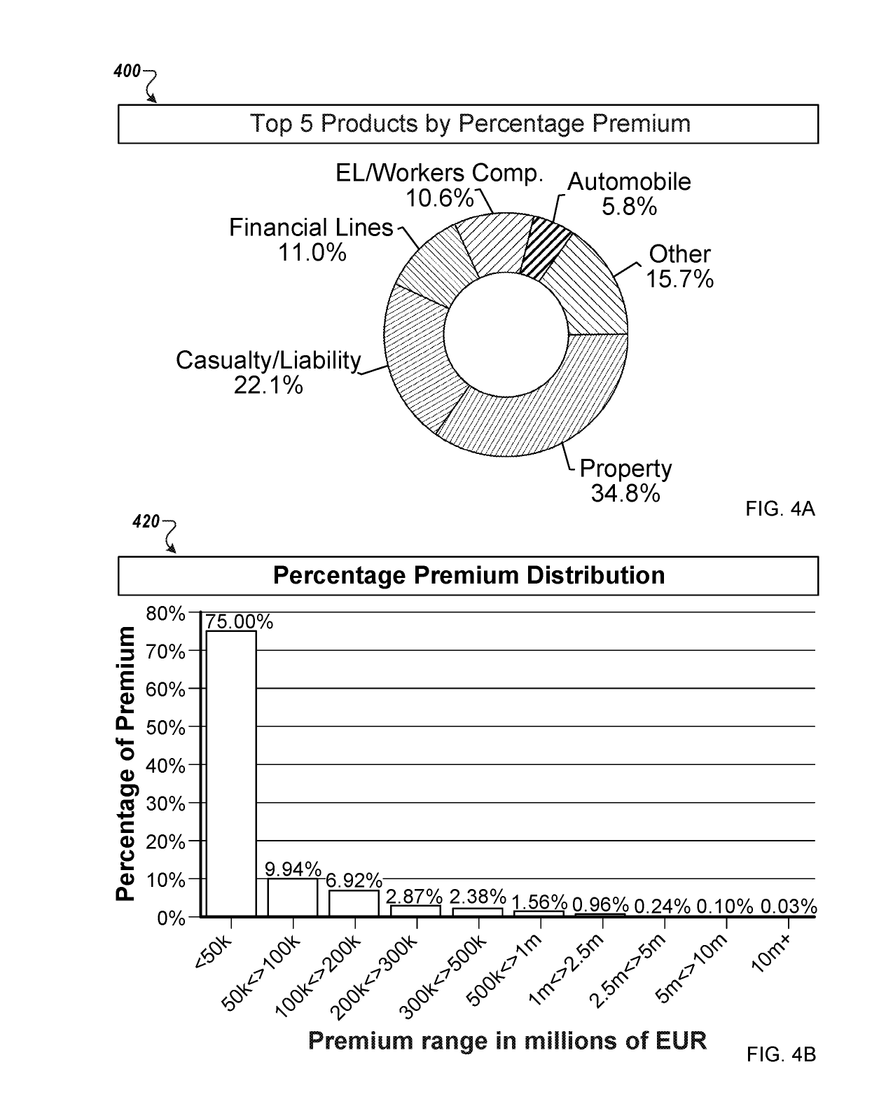

Returning to FIG. 1A, in preparing the finalized report, a “report preview” pane 112 includes a number of controls 128 that allow the broker to select presentation options and to preview the report information. A “sector overview” navigational control 128a, upon selection, presents the broker with an interface for adding industries into a sector overview section of the report. The sector overview section provides the broker with average client statistics representing insurance activity of one or more particular geographies and industries within the insurance marketplace environment. For example, the sector overview section may present statistical information regarding client insurance portfolio composition and client premium spending. To initialize the sector overview portion of the benchmarking report, the broker may be prompted to select at least one geographical region and at least one industry. In a particular example, the broker may select a global geographical region and the health care services industry. Responsive to these selections, the global risk insight platform may generate graphical displays for presenting sector-based analysis of client statistical information. Example graphical displays are provided in FIGS. 4A and 4B.

Turning to FIG. 4A, a doughnut graph 400 illustrates average percentages of premium by product within a selected industry. The graph segments include the main products of financial lines, casualty/liability, property, automobile, and employers liability, as well as a remaining wedge designated “other.” The “other” segment, for example, may represent products that are not commonplace throughout the selected industry and/or represent a minimal portion of overall premium budget within the selected industry. The broker may review the doughnut graph 400, for example, to identify products that the selected client (e.g., prospective or preexisting) may be interested in purchasing based upon products purchased by other clients within the same industry.

FIG. 4B illustrates a bar graph 420 representing premium distribution among clients of the insurance marketplace environment for the selected industry. The bar graph 420 breaks down insurance premiums into ranges, with bars representing the frequency of clients purchasing at a particular premium level. The broker may review the bar graph 420 to identify the size of clients represented in the selected industry. As illustrated in the bar graph 420, the insurance marketplace environment includes a range of clients, from very small to very large, within the selected industry.

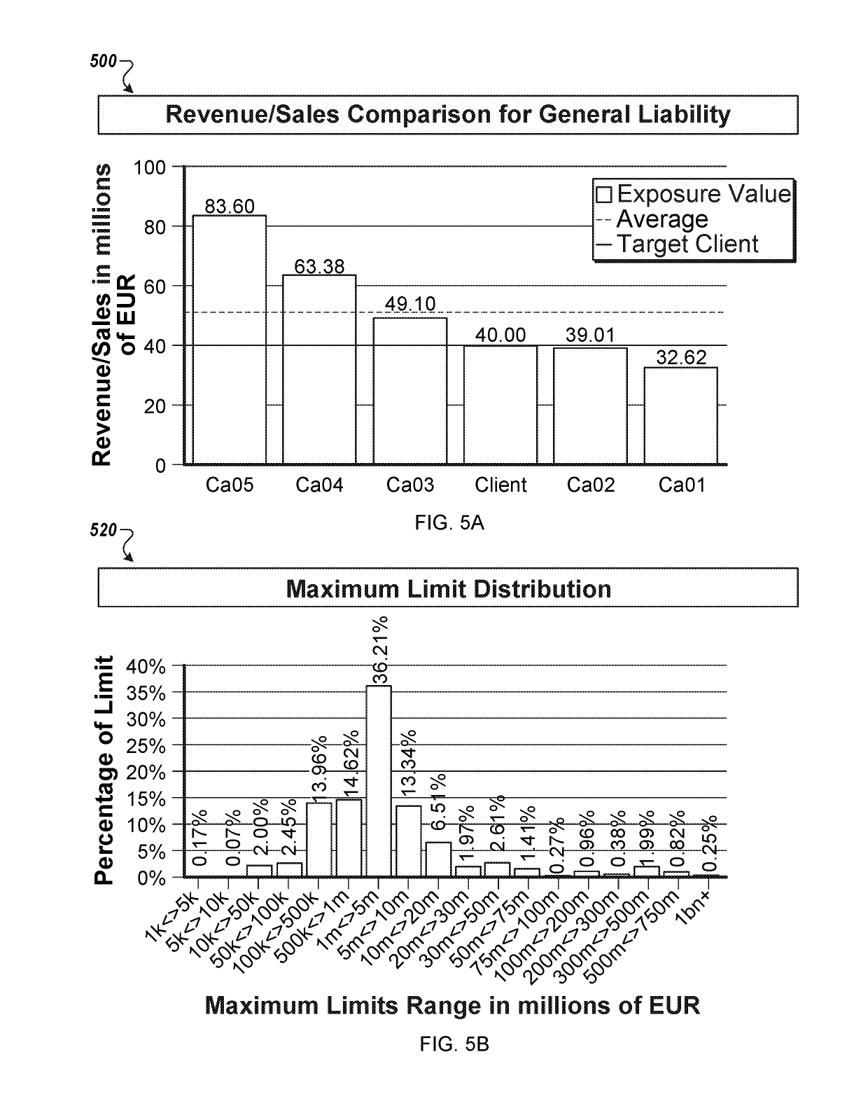

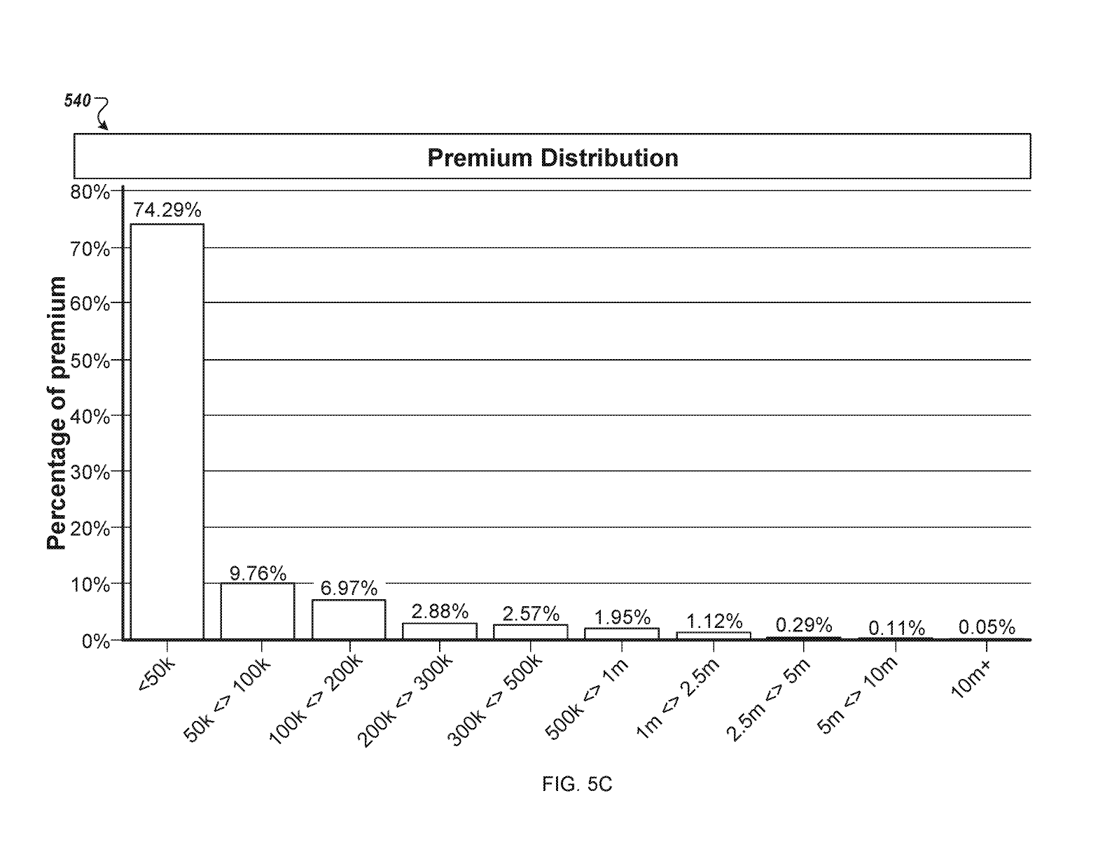

Returning to FIG. 1A, a “product category overview” navigational control 128b within the “report preview” pane 112, upon selection, presents the broker with a statistical analysis of information regarding exposures, limits, and premium of clients of the insurance marketplace environment for each product category selected via the “product categories” navigational control 122a of the “manage products” pane 108. FIGS. 5A through 5C illustrate example graphical displays of statistical product category information. Turning to FIG. 5A, a bar graph 500 illustrates an exposure distribution for clients that purchased a selected product (e.g., general liability). The bar graph 500 breaks down total insured value into ranges, with bars representing the frequency of exposures of the selected product at a particular value level. Turning to FIG. 5B, a bar graph 520 illustrates a limit distribution for clients that purchased a selected product. The bar graph 520 breaks down limits into ranges, with bars representing the frequency of clients at a particular limit range. Turning to FIG. 5C, a bar graph 540 illustrates a premium distribution for clients that purchased a selected product. The bar graph 540 breaks down premium into ranges, with bars representing the frequency of premium purchase at a given premium level range. A broker may review the bar graphs 500, 520, and 540 to determine a profile for peers within the industry of the selected client, purchasing products in the selected category.

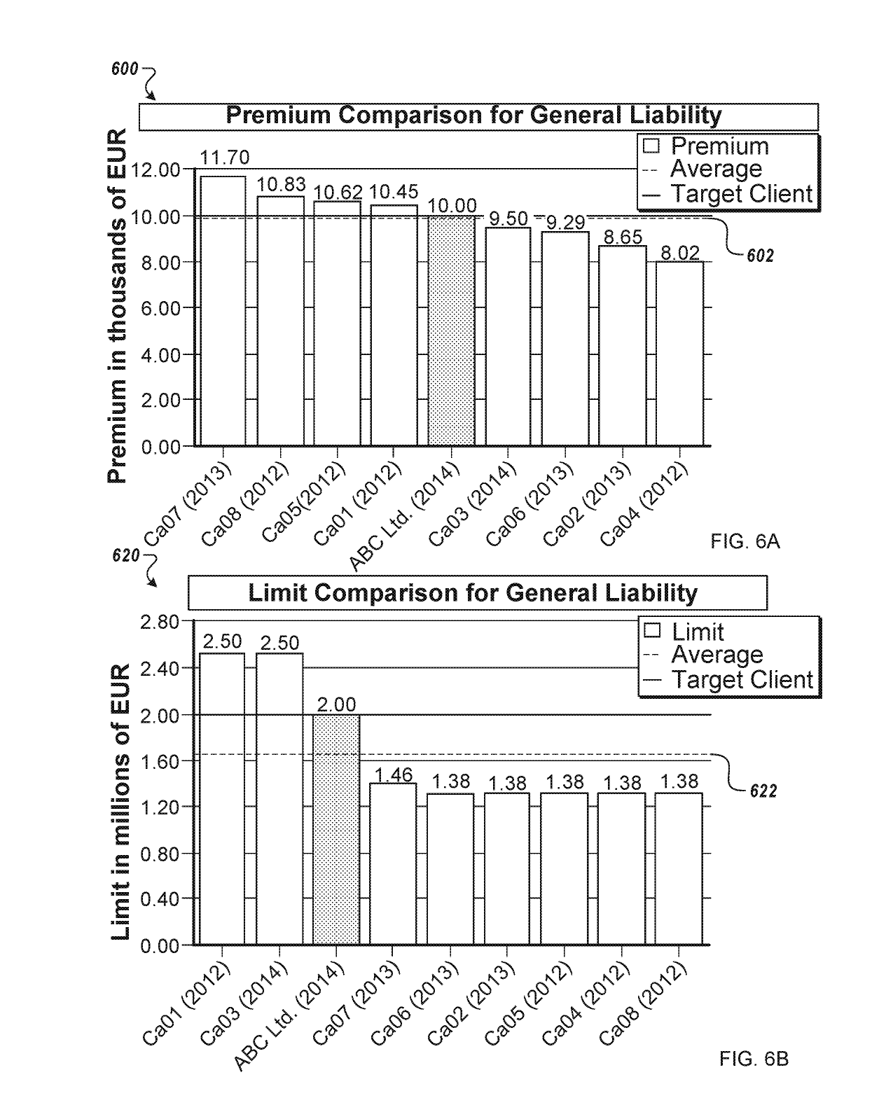

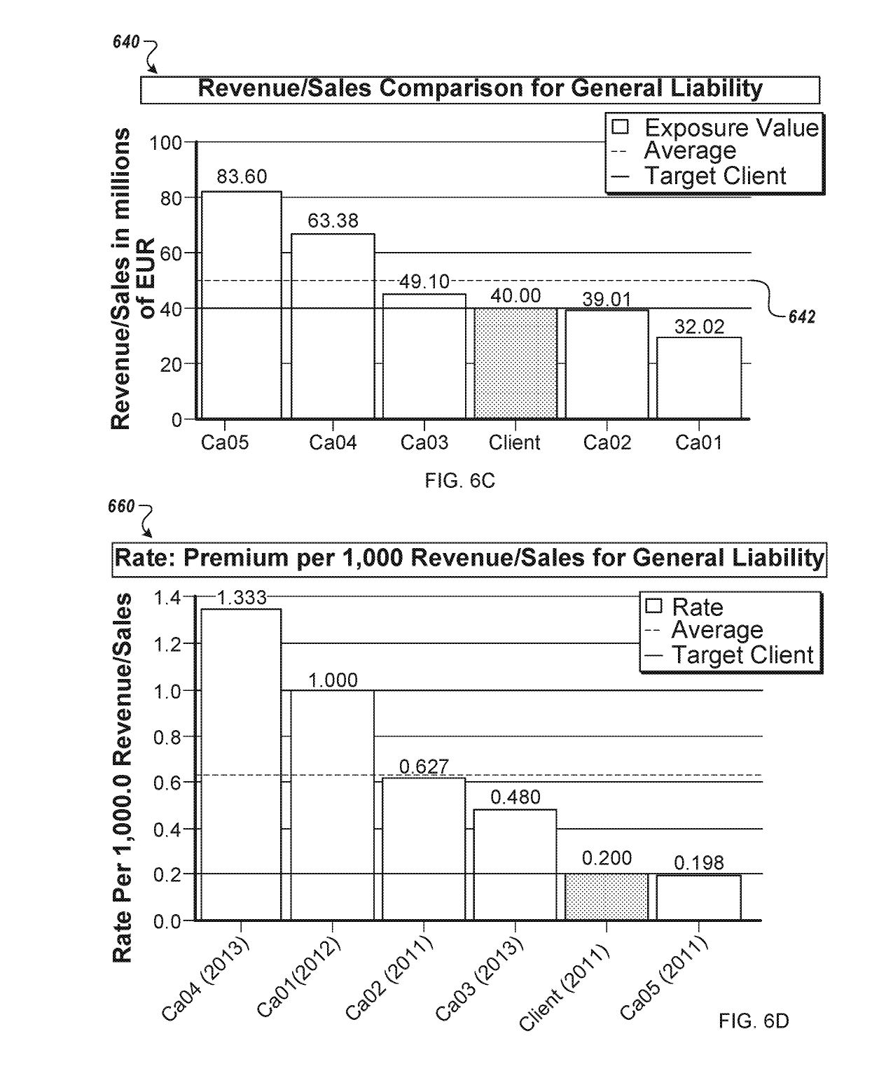

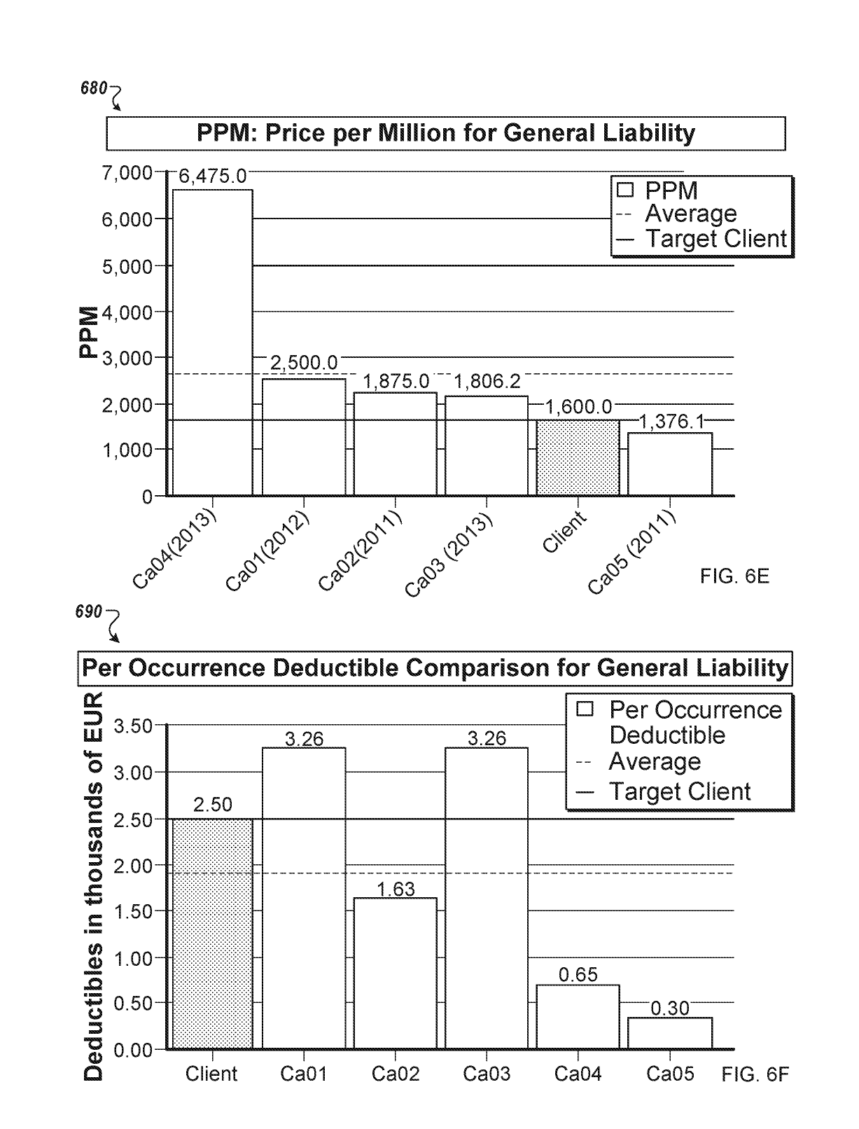

Return to FIG. 1A, a “peer product comparison” navigational control 128c within the “report preview” pane 112, upon selection, presents the broker with a statistical analysis of information regarding comparisons between the selected client and the selected peer group relative to premium, exposure, and limit values. The broker may review information through the “peer product comparison” navigational control 128c to determine relative alignment of the selected client with the peer group. Example graphical displays for peer product comparison are illustrated in FIGS. 6A through 6C and FIGS. 7A through 7C.

Turning to FIGS. 6A through 6C, a series of bar graphs illustrate a peer group analysis including average value for each of premium, limit, and exposure. FIG. 6A, for example, illustrates an example bar graph 600 of premium values for each client in the peer group for the particular product. A line 602 illustrates an average premium value. As noted above, to protect the identity of statistics pertaining to a particular client, the clients are labeled Ca01 through Ca08. The selected client, if existing and having purchased this particular product, may be represented in a manner that draws attention to the selected client, such as, in some examples, through highlighting, using a different color or outline, and/or labeling the bar representing the selected client with the client's name. As illustrated, client “ABC Ltd.” is illustrated in a darker shade as the surrounding peer bars. Similarly FIG. 6B illustrates an example bar graph 620 of limit values for each client in the peer group for the particular product. A line 622 identifies the average limit value. Finally, FIG. 6C illustrates an example bar graph 640 of total insured values for each client in the peer group for the particular product. A line 642 identifies the average insured value. Other graphical analysis may include a rates graph 660 of FIG. 6D illustrating premium per revenue/sales for a selected product (general liability), a price per million of limit purchased graph 680 of FIG. 6E illustrating the ratio of each peer's premium compared to each one million value of limit, a per occurrence deductible graph 690 of FIG. 6F, and/or an aggregate deductible, limit, and rate graph specific to the selected product (similar to the bar graph 380 of FIG. 3E).

FIGS. 7A through 7C illustrate example scatter plots demonstrating product metric comparison to a selected peer group in a benchmarking report. Turning to FIG. 7A, a scatter plot 700 illustrates a distribution of limit versus premium for the selected peer group and the selected product. Each peer within the peer group, Ca01 through Ca05, is individually labeled within the scatter plot 700. The selected client, if existing and having purchased this particular product, may be represented in a manner that draws attention to the selected client, such as, in some examples, through highlighting, encircling, labeling with an icon such as an arrow, and/or labeling the client within a key 702 with the client name 704. The key 702 also includes a premium value and exposure value for each peer client Ca01 through Ca05. As illustrated in the scatter plot 700, the premium generally increases as the limit increases. If the selected client is outlying from the linear trend demonstrated by the scatter plot 700, the broker may suggest that the client discuss a remarketing decision. Similar to the scatter plot 700, FIG. 7B is an example scatter plot 720 representing limit value versus premium value for each of the peer clients Ca01 through Ca08, where a key 722 references both the premium value and the limit value for each peer client Ca01 through Ca05 as well as client ABC Ltd. 724. Furthermore, FIG. 7C is an example scatter plot 740 representing limit value versus exposure for each of the peer clients Ca01 through Ca05, where a key 742 references both the total insured value and the limit value for each peer client Ca01 through Ca05 as well as client 744. The scatter plot 740, for example, is illustrated for exposure variables that are “value” exposures rather than “number of” exposures.

Returning to FIG. 1A, upon configuring the report information to satisfaction, the broker may select a “full report” navigational control 128d to review complete information presented within the benchmarking report. Upon selection of the “full report” navigational control 128d, for example, the broker dashboard 100 may present the broker with a user interface for removing or reordering report pages (e.g., placement of the sector overview prior to the peer product comparison, etc.). Further, the user interface may include controls allowing the broker to select a currency for presentation of monetary values and/or select a geographic region for targeting the report. The broker, at this time, may choose to name and save the report as a finalized report or as a work-in-progress report (if the broker identifies more work to accomplish in preparing the report information).

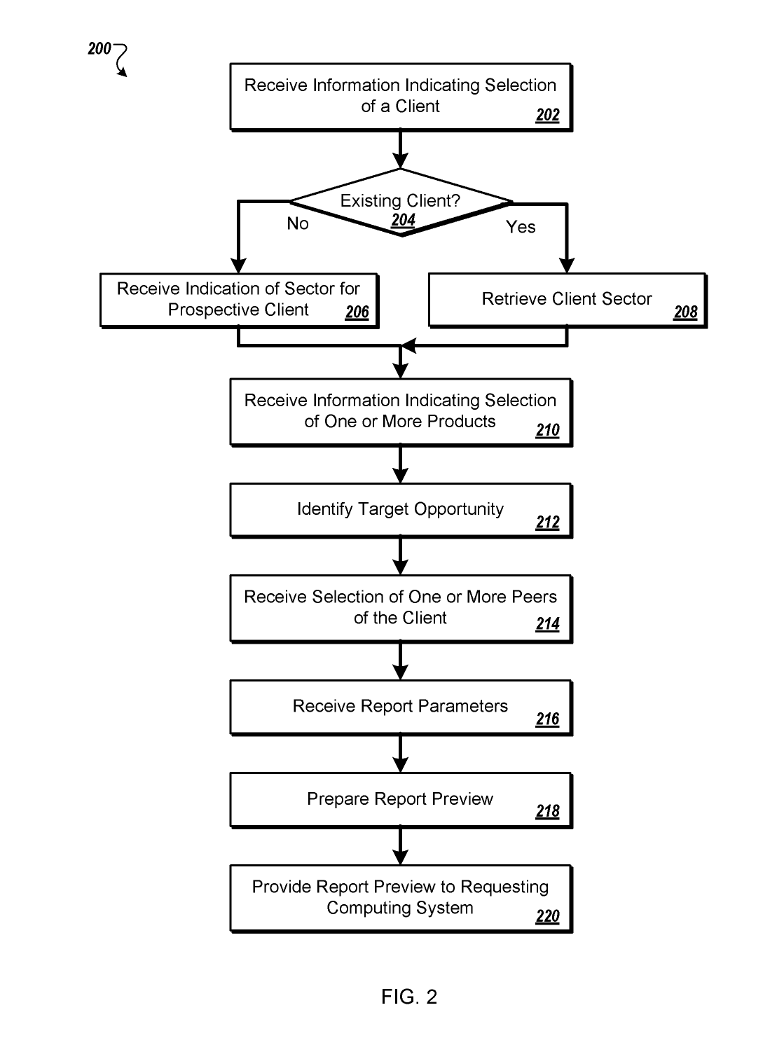

FIG. 2 illustrates a process flow diagram of an example method 200 for preparing a benchmarking report presenting statistical information pertinent to an insurance client identified by an insurance broker. The method 200, for example, includes steps a broker may perform via the broker dashboard interface 100 of FIG. 1A.

In some implementations, the method 200 begins with receiving information indicating selection of a client (202). Information may be provided by a user to a global risk insight platform of an insurance marketplace environment through a software application interface. For example, as discussed in relation to FIG. 1A, a broker may enter client information via one of the navigational controls 118a within the “identify client” pane 104 of the broker dashboard 100.

If the client is an existing client (204), in some implementations, a client industry sector is retrieved (208). For example, if a client was selected via the “select existing client” navigational control 118a, as described in FIG. 1A, the global risk insight platform may retrieve industry sector information associated with the identified client as well as, in some embodiments, additional demographic information (e.g., geographic region, maturity, etc.).

If, instead, the client is a prospective client (204), an indication of the prospective client's industry sector may be received (206). For example, prospective client information, including a client name and client industry sector, may be entered by a broker using the “add prospective client” navigational control 118b of FIG. 1A.

In some implementations, information is received indicating selection of one or more insurance products (210). The product information, for example, may include one or more product categories and/or product exposures selected from a menu system. For example, a broker may select product categories via the “product categories” navigational control 122a of the broker dashboard 100 of FIG. 1A and product exposures via the “exposure” navigational control 122b. The product information, in some examples, may include exposure value, premium, limit, deductible type, and/or deductible value.

In some implementations, a target opportunity is identified (212). Using the information indicating selection of one or more products, for example, the global risk insight platform may match one or more target opportunities to the indicated client. The target opportunities, in this example, may be presented to the user for selection. For example, target opportunities may be reviewed and selected by a broker through the “target opportunity” navigational control 122d of the broker dashboard 100 of FIG. 1A. In another example, a user may enter a custom opportunity involving a specified product and exposure. For example, a broker may enter a custom opportunity via the “custom opportunity” navigational control 122c of the broker dashboard 100 of FIG. 1A.

In some implementations, selection of one or more peers of the indicated client is received (214). The global risk insight platform may present a user with options regarding peers of the indicated client. For example, using the “view available peers” navigational control 120a of the broker dashboard 100 of FIG. 1A, a broker may browse clients of an insurance marketplace environment for peer clients of the indicated client. Further, the global risk insight platform may propose one or more peer clients, for example based upon demographic information associated with the indicated client and/or filtering clients for those clients that have purchased the one or more products indicated by the user. For example, by selecting the “view candidate peers” navigational control 120b, a broker may access a list of candidates proposed by the global risk insight platform. Further, a user may browse a list of filtered clients by applying filters to a client database, such as, in some examples, industry, geographic region, and limit range filters. In a particular example, the navigational controls 120d through 120f provide filtering options via the broker dashboard 100 of FIG. 1A.

In some implementations, report parameters are received (216). For example, a user may identify, from options presented within a user interface, a number of statistical analysis features, such as bar graphs, scatter plots, and pie graphs, representing information pertinent to the indicated client. In a particular example, a broker may interact with the navigational controls 124 and 126 within the “manage charts” pane 110 of the broker dashboard 100 of FIG. 1A, as well as the “sector overview” navigational control 128a, “product category overview” navigational control 128b, and/or “peer product comparison” navigational control 128c to select benchmarking report options.

In some implementations, a preview report is prepared (218). Based upon the information provided to the global risk insight platform, report preview information may be generated for display upon a user interface. For example, a broker may select the “full report” navigational control 128d of the broker dashboard 100 of FIG. 1A to trigger preparation of a report preview.

In some implementations, the report preview is provided to the requesting computing system (220). The report preview may be presented within the user interface that the user interacted with to provide the various information during the preceding steps of the method 200. In other examples, the report preview may be downloaded to a memory region within the requesting computing system or transmitted to the user via email. Furthermore, the report preview may be maintained (e.g., stored) by the global risk insight platform for later access.

Although illustrated in a particular order, in other implementations, one or more steps may be in a different order. For example, selection of one or more peers may be received (214) prior to indication of selection of one or more products (210). Furthermore, one or more steps, in other implementations, may be removed or added. For example, in some implementations, rather than identifying a target opportunity, the information regarding the products and peers may be combined to prepare a report more general to a target and industry. Other modifications are possible without deviating from the scope of the method 200.

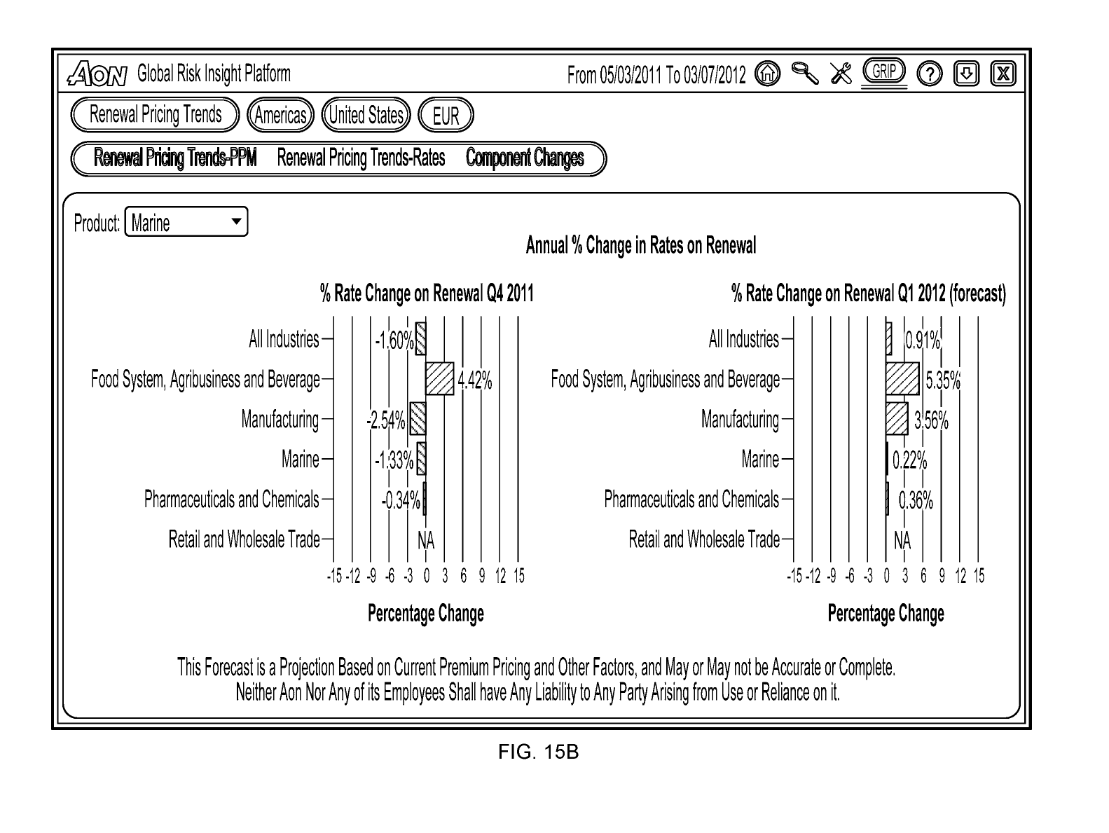

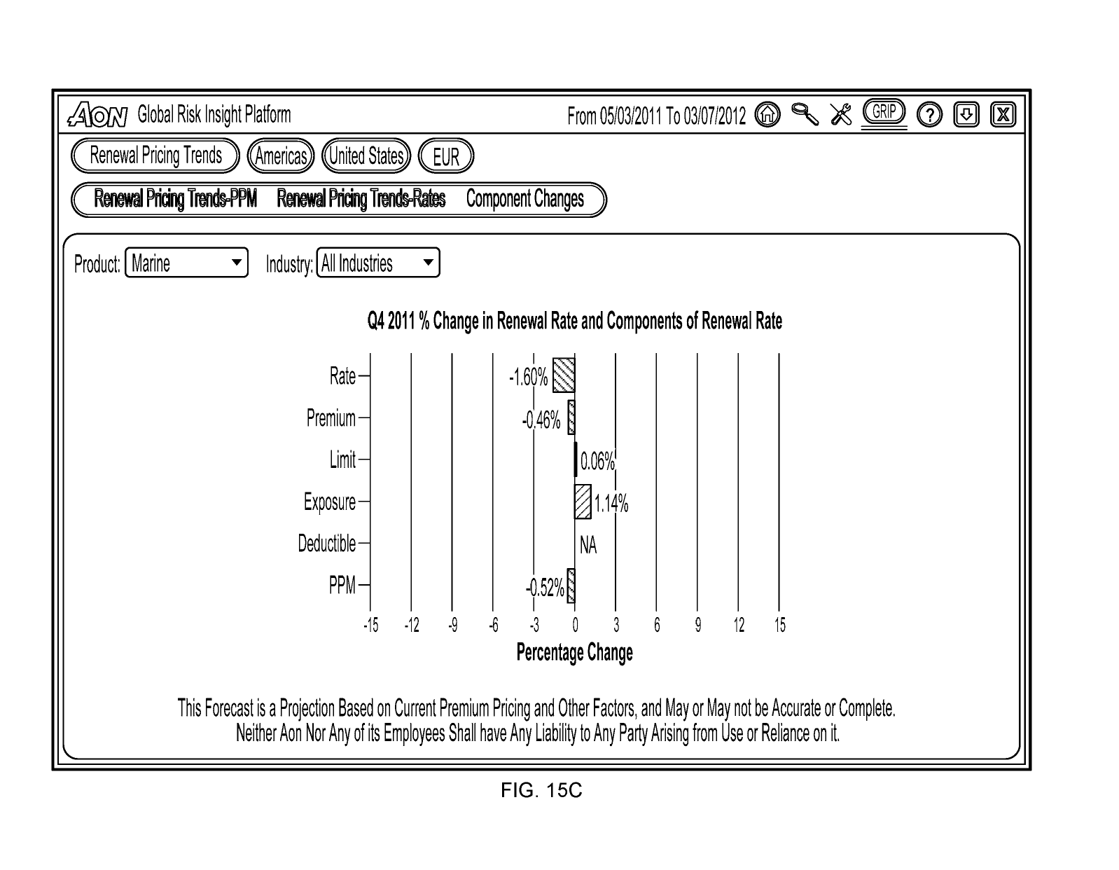

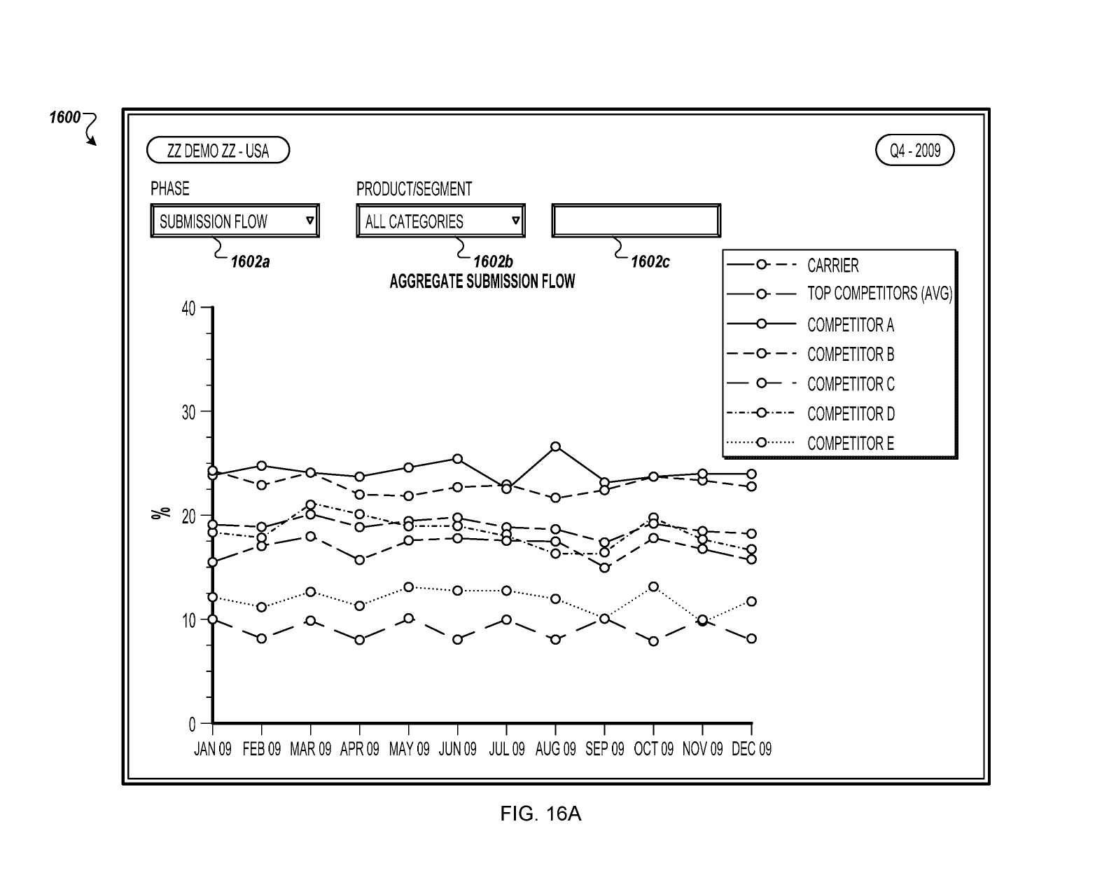

As shown in FIG. 1B, the dashboard 100 is open to the “research & analytics” tab 114c. In a “renewal analysis” pane 132, the broker is provided with a series of navigational controls 140 to access information regarding insurance renewals. Upon selection of a “percentage change renewals” control 140a, the broker may be provided with a graphical analysis of percentage change in insurance renewals over a period of time. The period of time, in some embodiments, includes a forecast into future events, such that the global risk insight platform estimates projected renewal pricing trends based upon a historical data analysis. An example screenshot of a graphical display of projected pricing trends is presented in FIG. 15A, described in more detail below. Upon selection of a “percentage rate change on renewal” control 140b, the broker dashboard 100 may present the broker with a graphical analysis of percentage rate change on renewal over a period of time. The period of time, in some embodiments, includes a forecast into future events, such that the global risk insight platform estimates projected renewal rate change trends based upon a historical data analysis. An example screenshot of a graphical display of projected rate change trends is presented in FIG. 15C, described in more detail below. Upon selection of a “percentage renewal rate components” control 140c, the broker dashboard 100 may present the broker with a graphical analysis of individual sector components (e.g., industries such as manufacturing, marine, pharmaceuticals and chemicals, etc.) of renewal rates over a period of time. The period of time, in some embodiments, includes a forecast into future events, such that the global risk insight platform estimates projected renewal rate change trends based upon a historical data analysis. An example screenshot of a graphical display of projected component rate change trends is presented in FIG. 15B, described in more detail below. Furthermore, as illustrated in FIGS. 15A and 15C, the percentage change in renewals and percentage rate change on renewal analysis may be filtered by product (as made available by a “renewals by product” control 140d), industry (as made available by a “renewals by industry” control 140e), and geography (as made available by a “renewals by geography” control 1400. Combinations of filters are possible. For example, the broker may use the “renewal analysis” pane 132 of the broker dashboard 100 to gain access to statistical analysis of percentage change in renewals by geography and by product, or to gain access to statistical analysis of percentage rate change on renewal by industry and by geography. Other filtering combinations are possible.

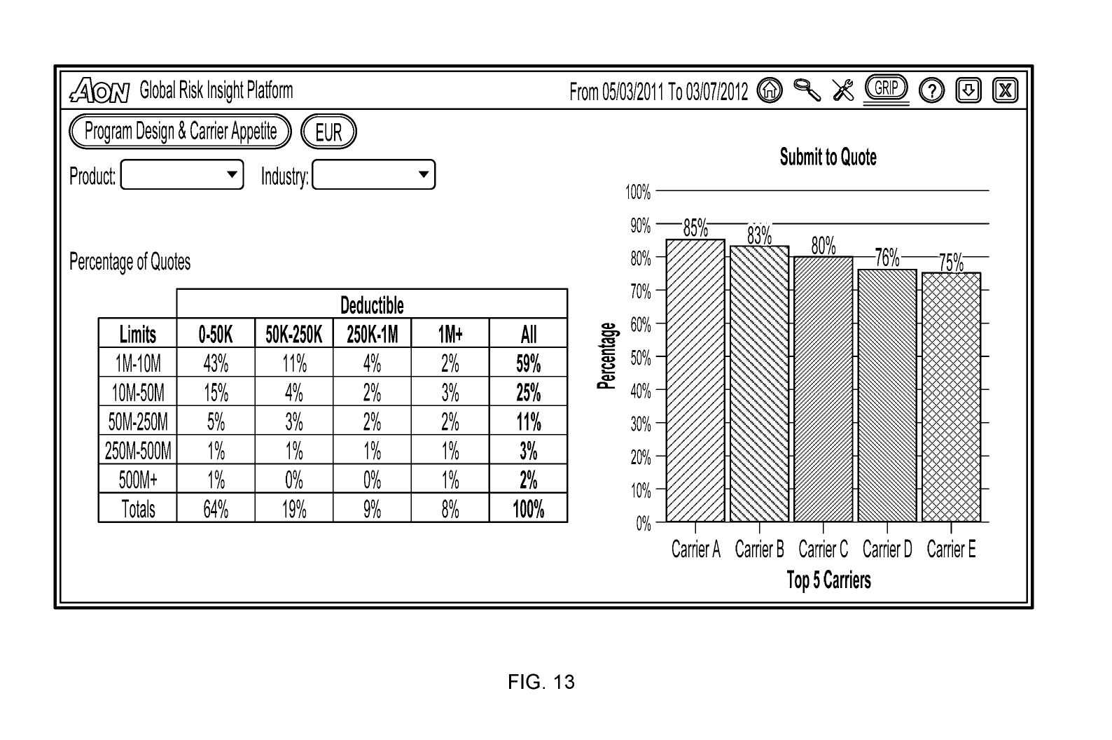

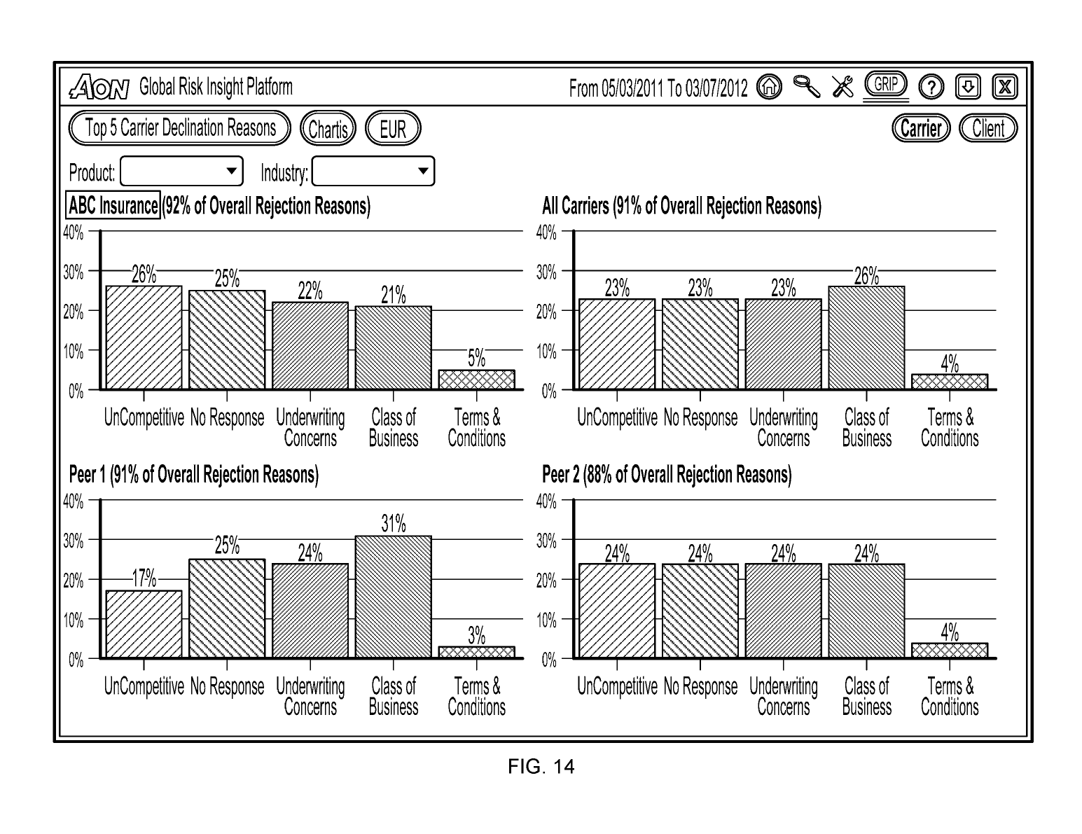

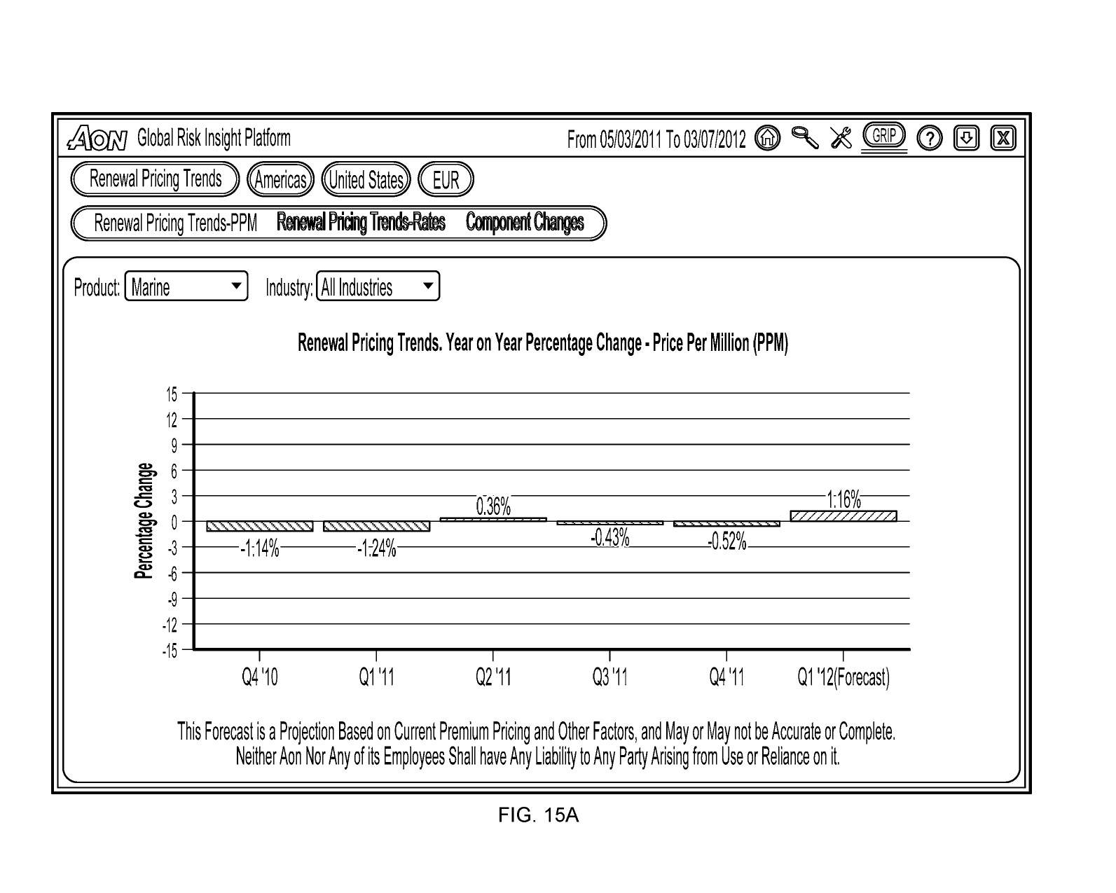

A “quote analysis” pane 134 presents the broker with options for reviewing statistics related to the outcomes of quotes, captured along the timeline from request to bind. For example, a “carrier declination” control 142a, upon selection, may cause the broker dashboard to present a graphical analysis of carrier declination reasons to the broker. An example graphical user interface for reviewing carrier declination reasons is illustrated in FIG. 14, described in more detail below. Conversely, detailed analysis of client declination reasons and client acceptance reasons are available to the broker using a “client declination” control 142b and a “client acceptance” control 142c. Selection of a “submit-to-quote” control 142d presents the user with an analysis of percentage submissions quoted by each of a number of carriers. For example, as illustrated in FIG. 13 (described in greater detail below), percentage submission-to-quote is presented for each of the top five carriers. The top five carriers, in some examples, may be identified as the top five performing carriers within the insurance marketplace, the five carriers determined to be most similar to the present carrier, and/or the top five performing carriers for the type metrics presently presented, etc.). A “quote by deductible type” control 142e, upon selection, allows the broker to review percentages of quotes submitted based upon deductible type. Similarly, a “quote by deductible value” control 142f, upon selection, allows the broker to review percentages of quotes submitted based upon deductible ranges, as illustrated in FIG. 13.

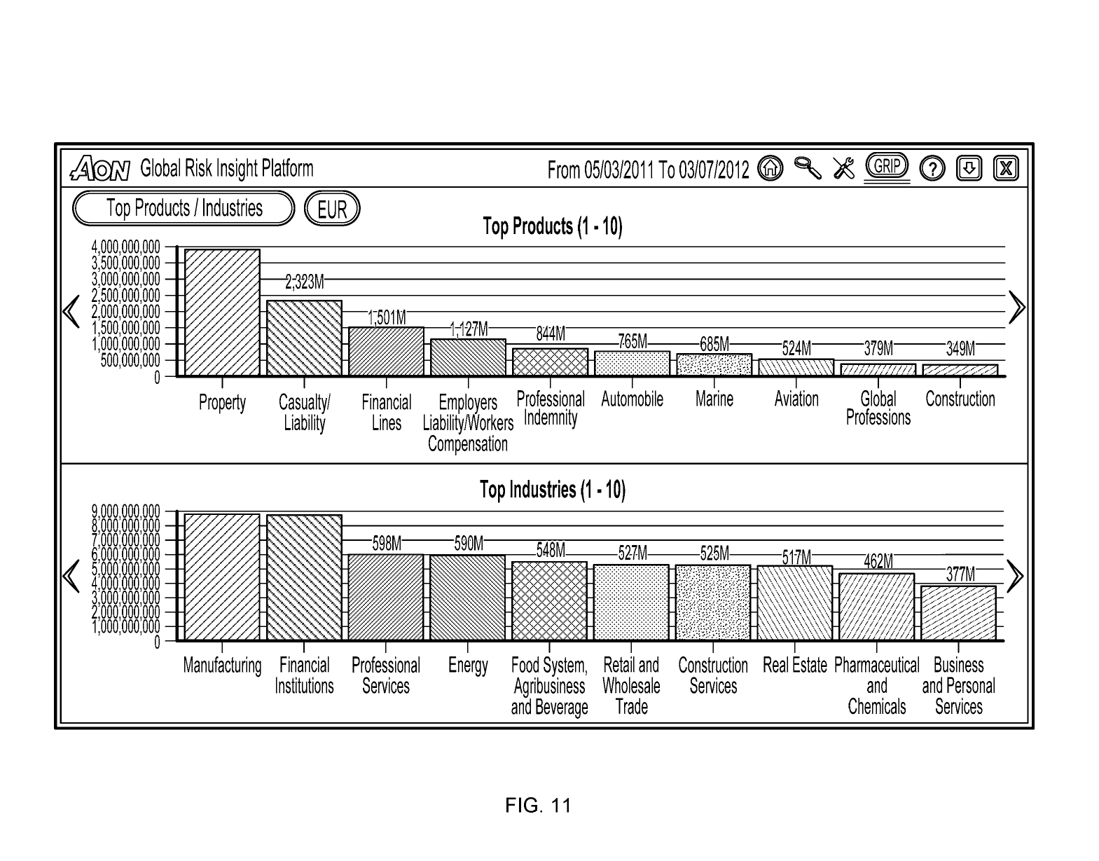

Turning to a “product and industry analysis” pane 136, a series of navigational controls 144 provide a broker with access to statistics regarding products offered via the insurance marketplace environment and insurance purchasing trends across industry sectors. Upon selection of a “top products” control 144a, the broker dashboard 100 presents the broker with a graphical display of top products by aggregate premiums. An example graphical display of top products is illustrated in FIG. 11, described in further detail below. Similarly, selection of a “top industries” control causes presentation of a graphical display of the top industries by aggregate premiums (illustrated in FIG. 11). Furthermore, the information, as illustrated in FIG. 11, may be filtered by geography (e.g., using a “product by geography” control 144c) and/or by industry (e.g., using an “industry by geography” control 144d). Further, the analysis may be broken down to illustrate top carriers for each of top products (e.g., using a “product by carrier” control 144e) and top industries (e.g., using an “industry by carrier” control 144f).

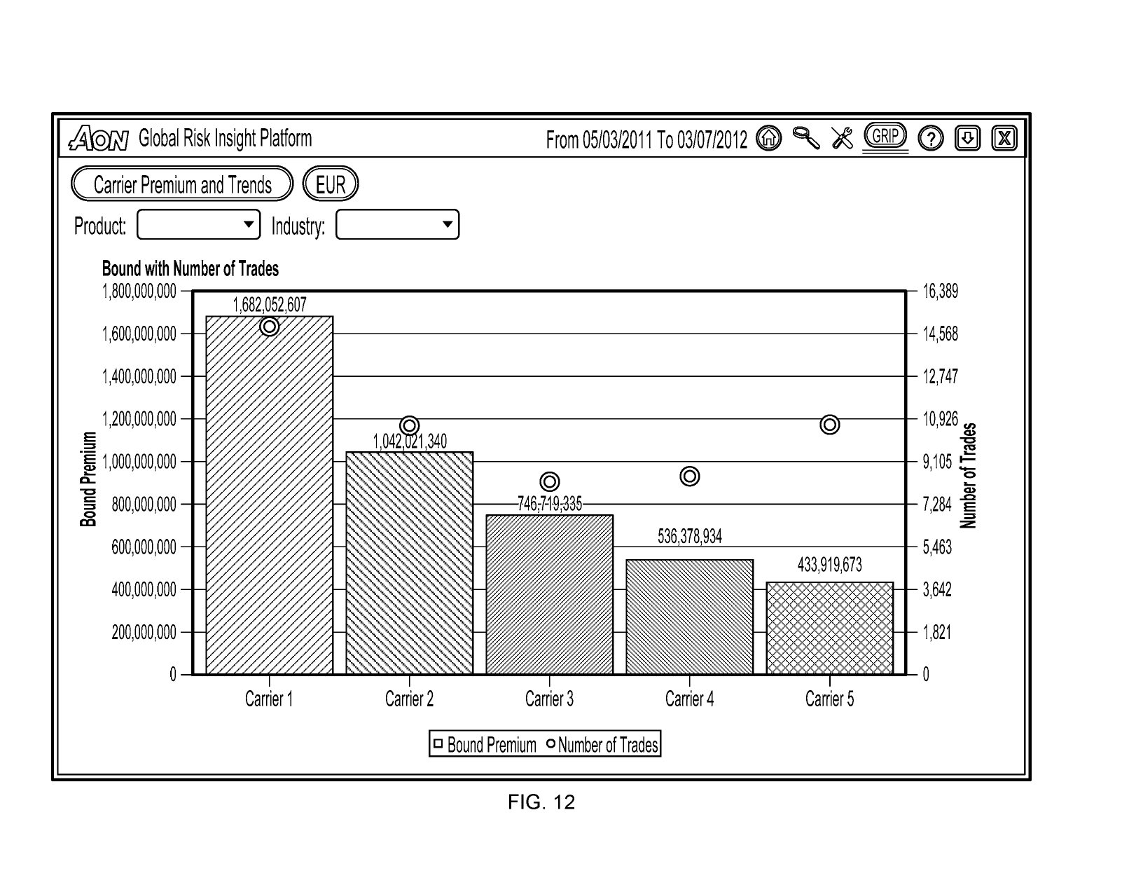

A “market analysis” pane 138 includes a series of navigational controls 146 for accessing analysis of trade volume and aggregate premiums across carriers participating in the insurance marketplace environment. A “trades by carrier” control 146a, upon selection, presents a broker with aggregate numbers of trades by carrier over a given period of time. The information may additionally include identification of a bound premium associated with the aggregate trades, accessible for example via a “carrier by aggregate premium” control 146d. As illustrated in FIG. 12, for example, a bar graph illustrates both aggregate trades and bound premium. The bound trades statistics and aggregate premium statistics may further be filtered by geography (using a “trades by carrier by geography” control 146b and/or “carrier by premium by geography” control 146e) and/or by industry (using a “trades by carrier by industry” control 146c and/or a “carrier by premium by industry” control 146f). Additional filtering options and combinations are possible, such as carrier by premium and by geography.

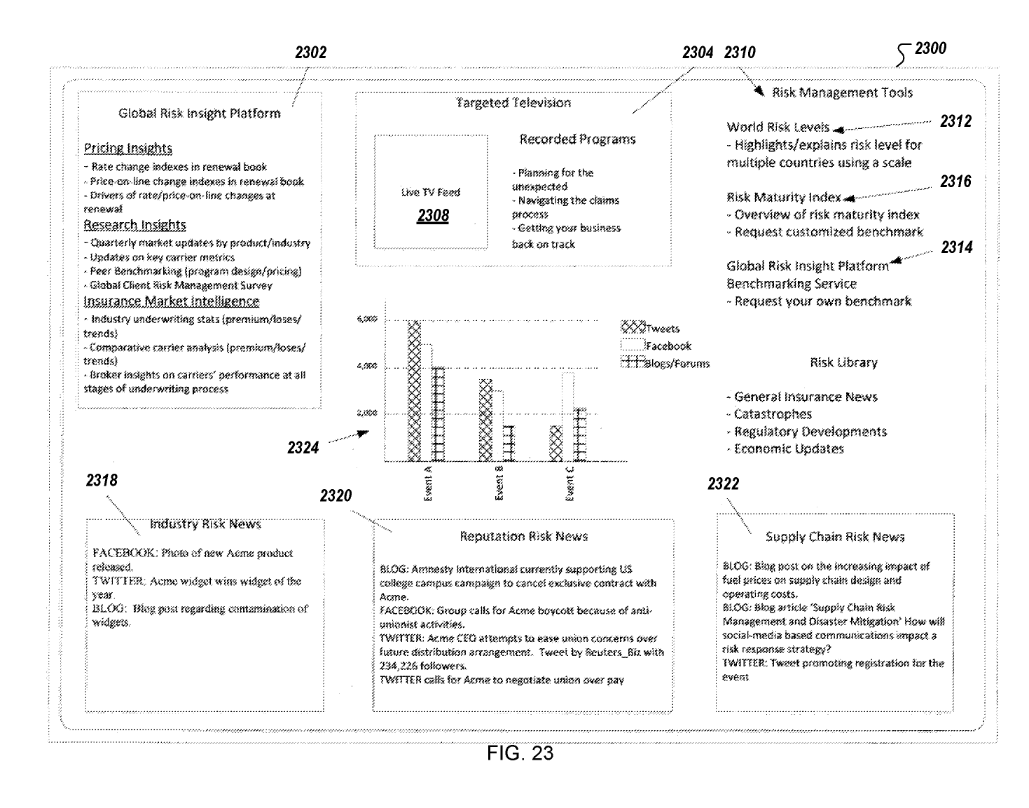

Reinsurance carriers may also access the global risk insight platform via a dashboard interface to review and analyze data relevant to reinsurance carriers. FIGS. 1C and 1D illustrate reinsurance carrier dashboard user interfaces for reviewing and analyzing reinsurance transaction information. Turning to FIG. 1C, a dashboard 130 is part of a web site, web portal, personal computer application, or mobile device application configured to allow a reinsurance broker to interface with the global risk insight platform and insurance marketplace environment. The dashboard 130 includes the same tabs 114 as illustrated in FIGS. 1A and 1B in relation to broker dashboard interfaces, but each of the tabs 114 now present information relevant to reinsurance brokers. However, similar information presented in relation to insurance brokers may be relevant to reinsurance brokers and vice-versa. For example, the reinsurance dashboard 130, in other embodiments, may include the “product and industry analysis” pane 136 of FIG. 1B and/or the “quote analysis” pane 134 of FIG. 1B. In some implementations, selection of the “overview” tab 114b presents the user with an information overview display similar to the screenshot of FIG. 23, presenting a summary analysis of risk data (described in greater detail below). As shown in FIG. 1C, the “benchmarking” tab 114a is active.

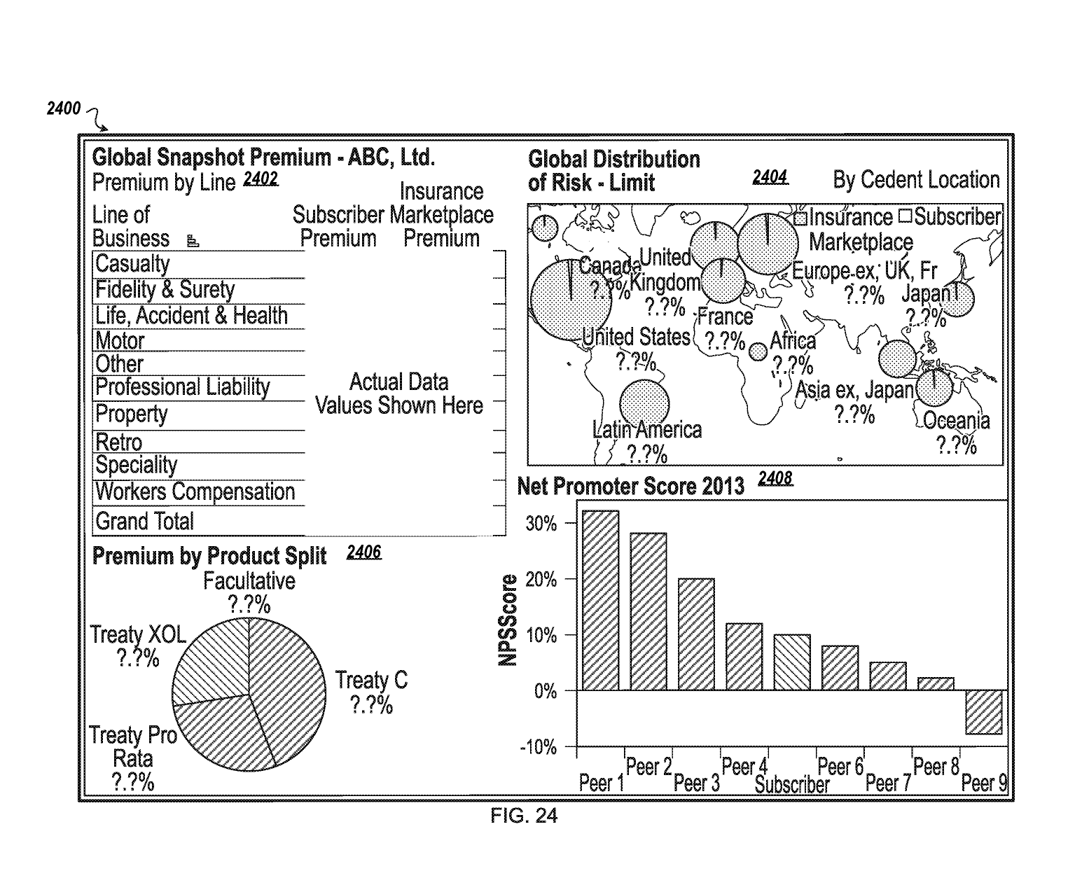

Beginning with a “reports” pane 150, a “market reports” navigational control 162a, upon selection, may present the reinsurer with a report-style review of present market statistics, for example combining information accessible through one or more of a “market pricing” pane 152, a “program participation” pane 154, a “market flow analysis” pane 158, and a “premium flow analysis pane” 160. Additionally, in some embodiments, a market report may include information accessible through the research and analytics tab 114c, as described below in relation to FIG. 1D. In one example, the “market reports” control 162a, upon selection, may generate a synopsis of market analytics similar to a screenshot 2400 of FIG. 24 (described in further detail below). The “reports” pane 150 also includes a “carrier reports” control 162b, selectable to access a report-style review of analytical information pertaining to insurance carriers. For example, the carrier reports may include information accessible through a “client purchasing patterns” pane 156 and/or a carrier dashboard 190, described below in relation to FIGS. 1E and 1F. Report preparation, in a general sense, may be similar in method to the steps described in relation to method 200 as described in FIG. 2.

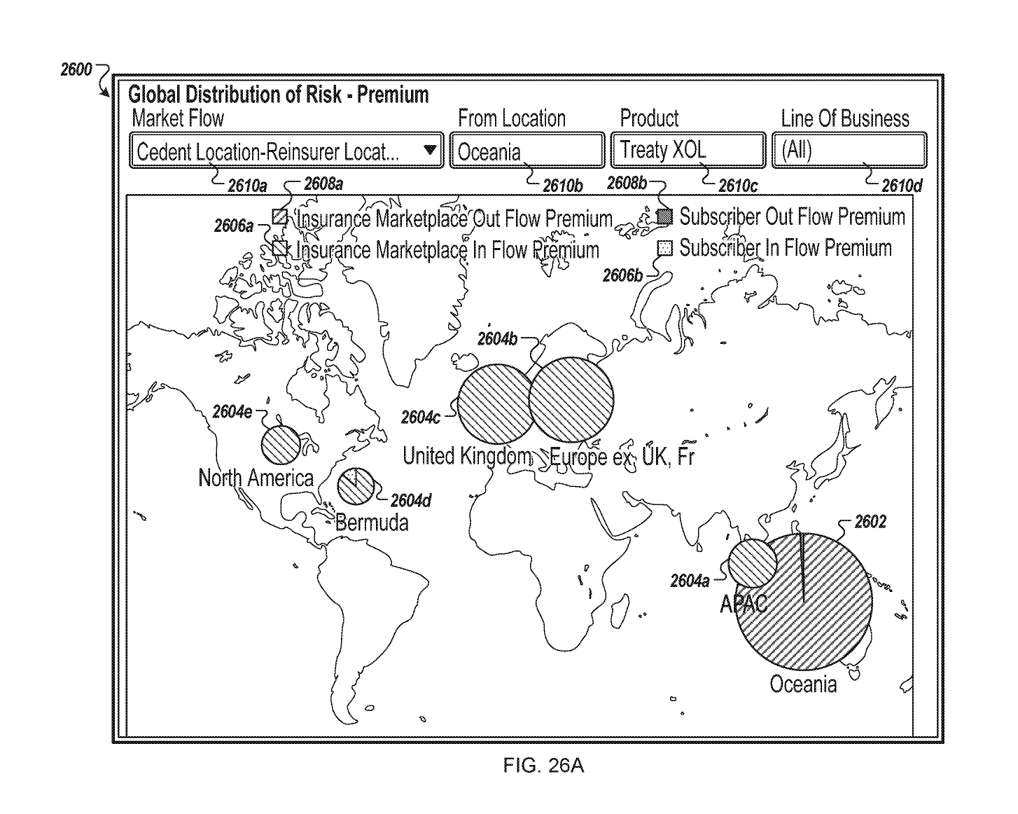

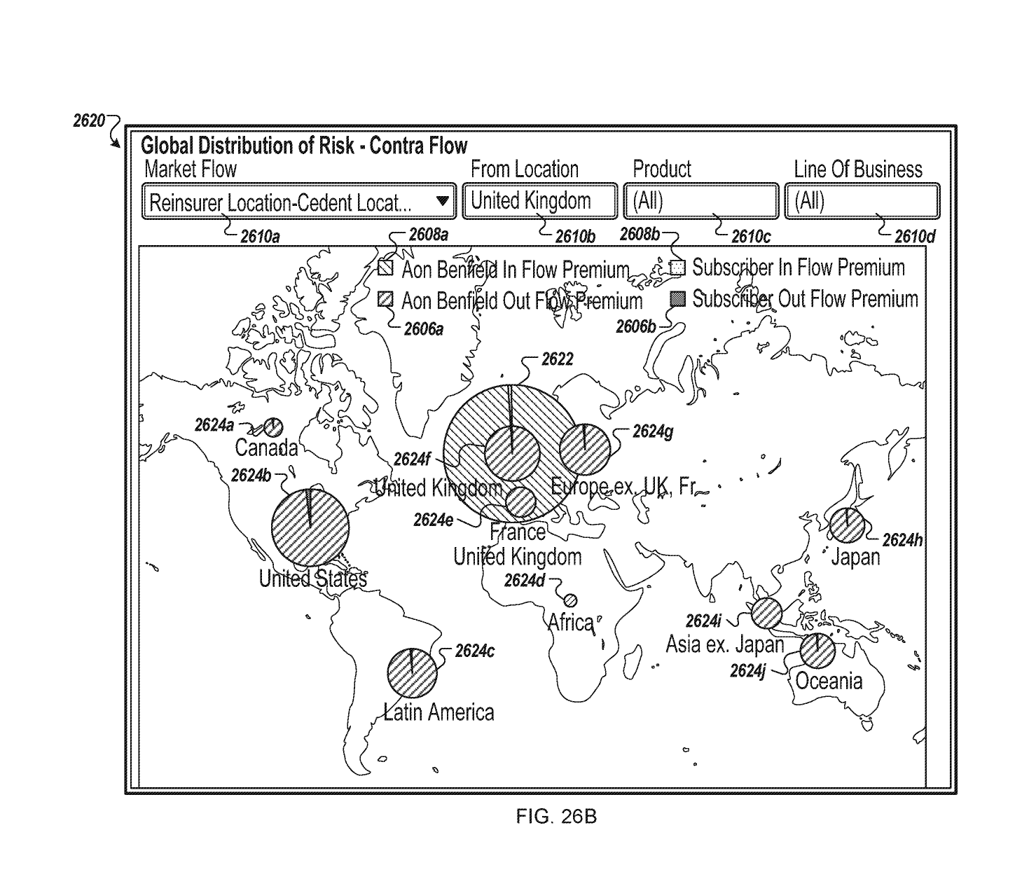

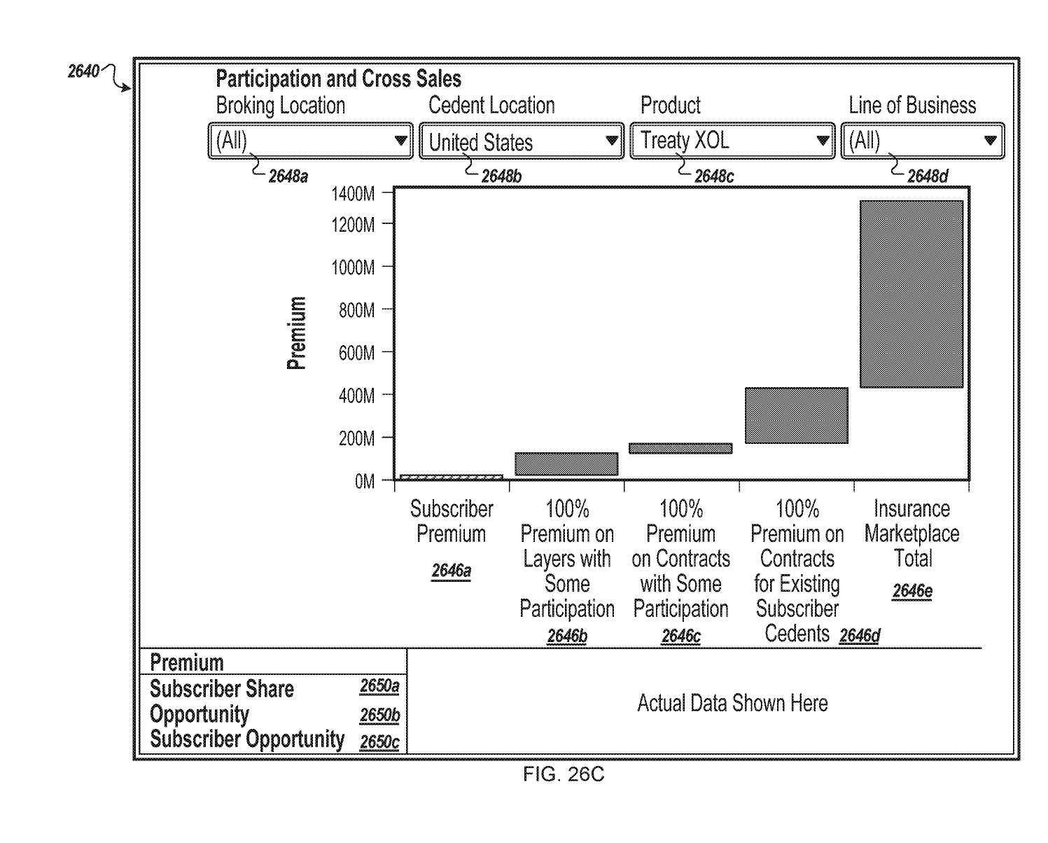

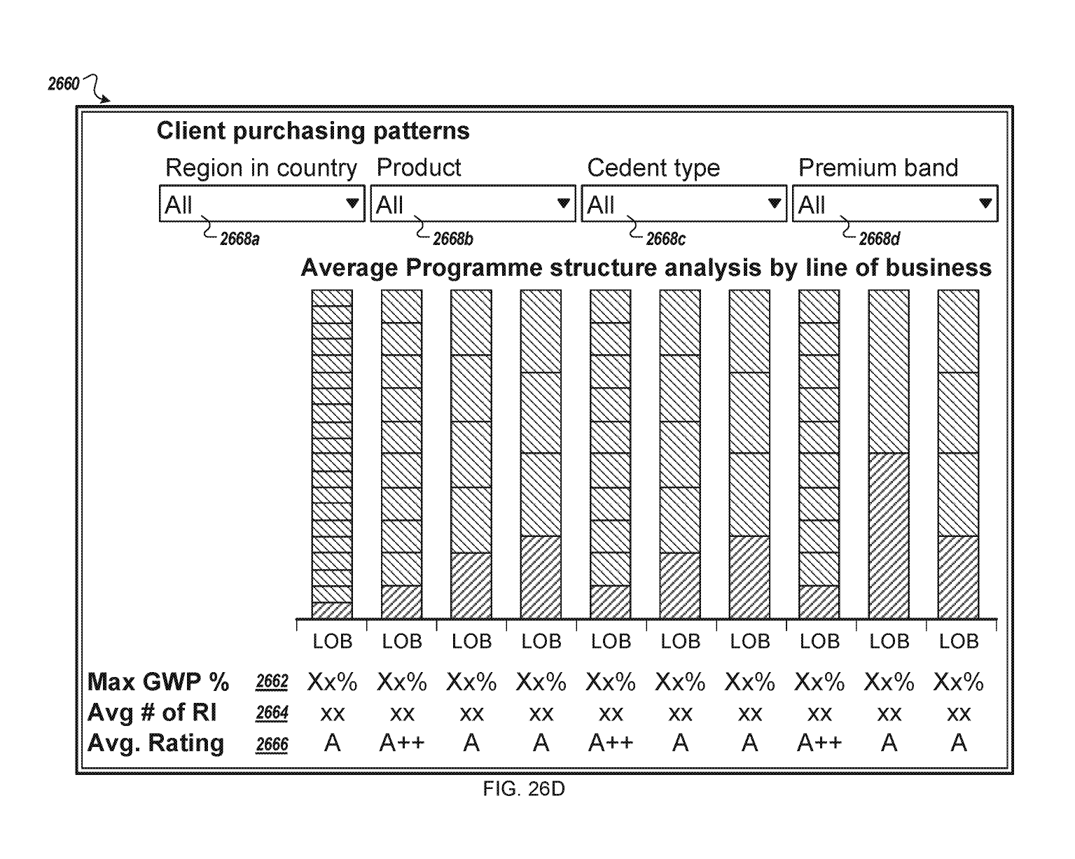

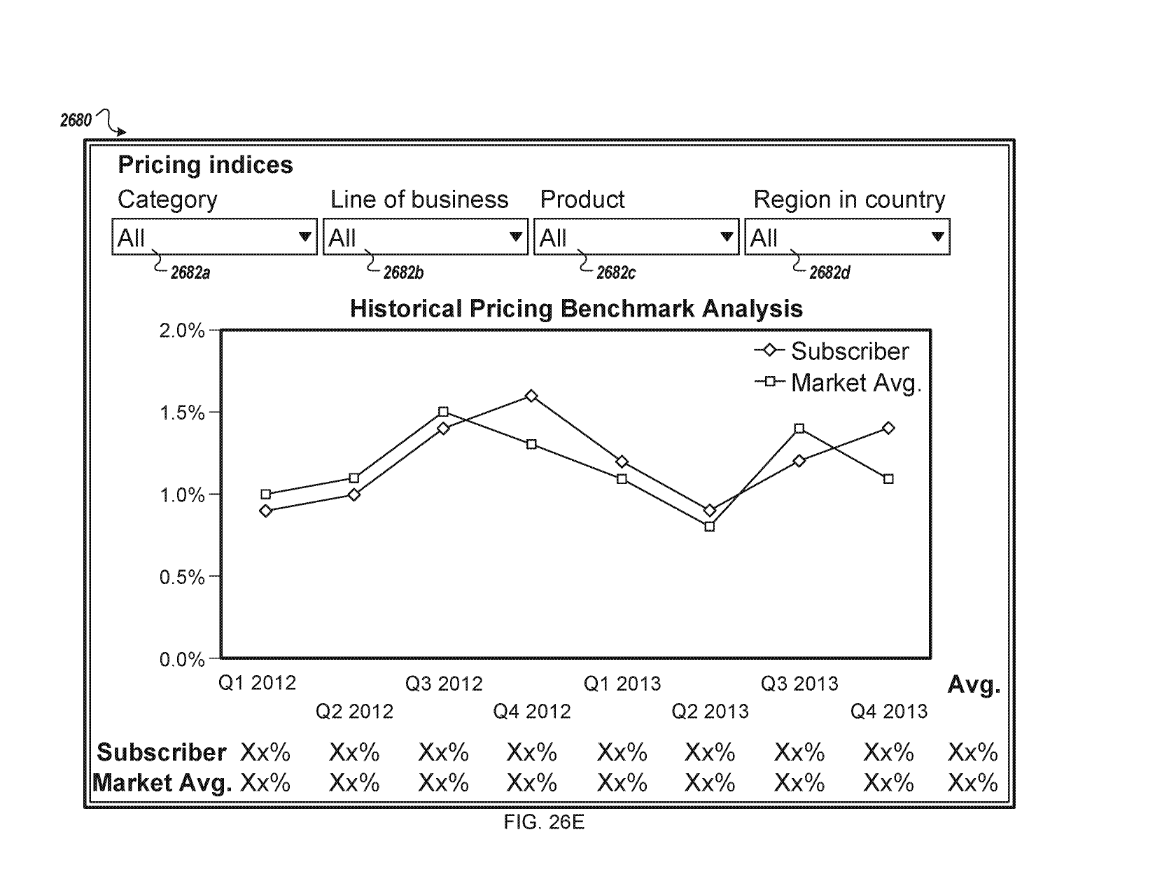

Turning to the “market pricing” pane 152, upon selection of an “overall pricing” navigational control 164a by the reinsurer, the reinsurance dashboard 130 presents the reinsurer with an analysis of pricing indices over a period of time. For example, as illustrated in FIG. 26E, a screenshot 2680 illustrates a comparison of the reinsurer's historic pricing to market averages quarter-by-quarter over two years. The line graph provides the reinsurer with insight into the reinsurer's performance relative to overall market pricing. As illustrated, a series of drop-down menus 2682, upon selection, may be used to filter the information by category (menu 2682a), line of business (menu 2682b), product (menu 2682c, e.g., quota share, excess of loss, etc.), and/or geographic region (menu 2682d). In other embodiments (not illustrated) the period of time and/or the time increments may be manipulated to refine or enlarge the scope of analysis. In some examples, the reinsurer may be provided the opportunity to review a month-by-month analysis over a period of six months or an annual analysis over the period of ten years. Furthermore, returning to FIG. 1C, rather than overall pricing analytics, the reinsurer may opt to focus on a particular pricing category, such as pricing by aggregate premium index (using a “pricing by aggregate premium index” control 164b) and pricing by limit index (using a “pricing by limit index” control 164c).

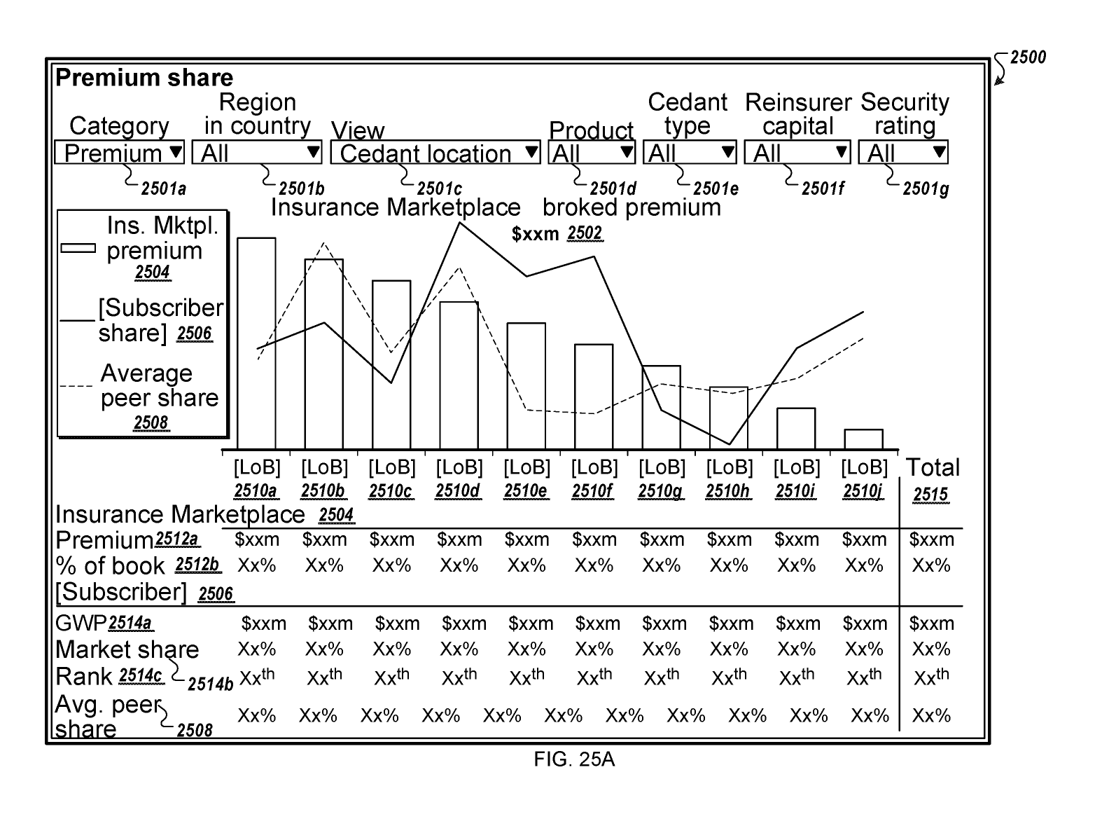

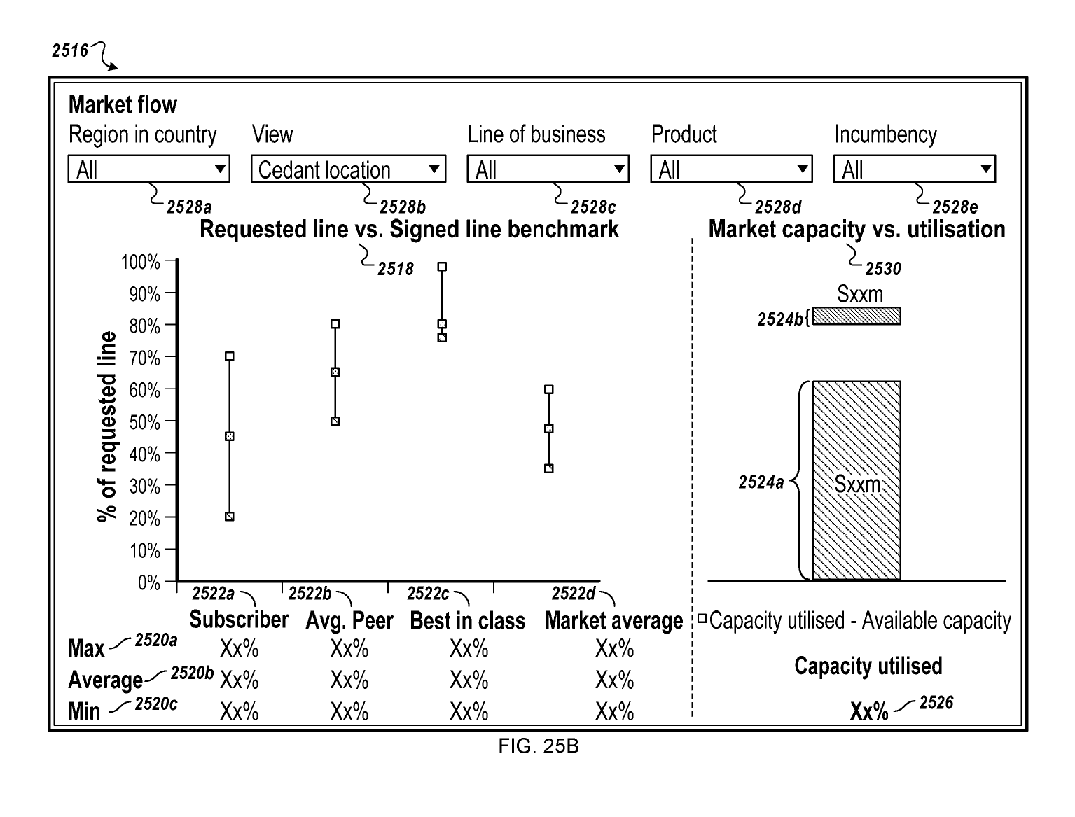

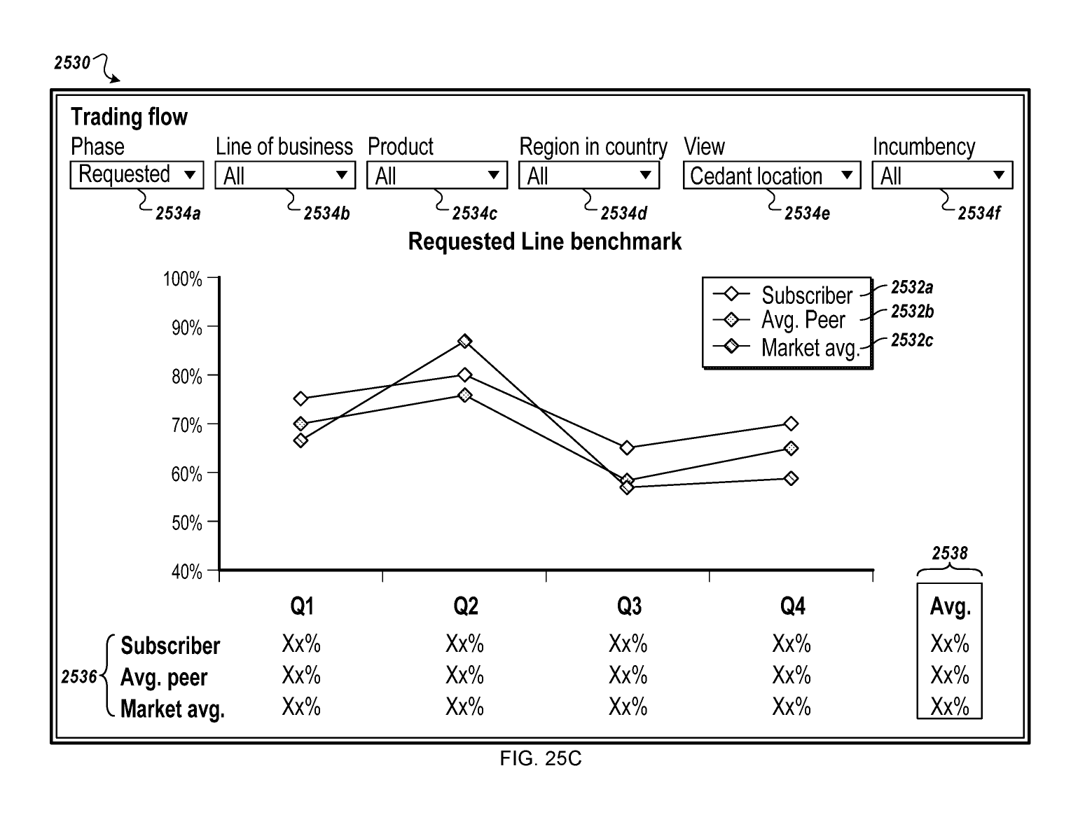

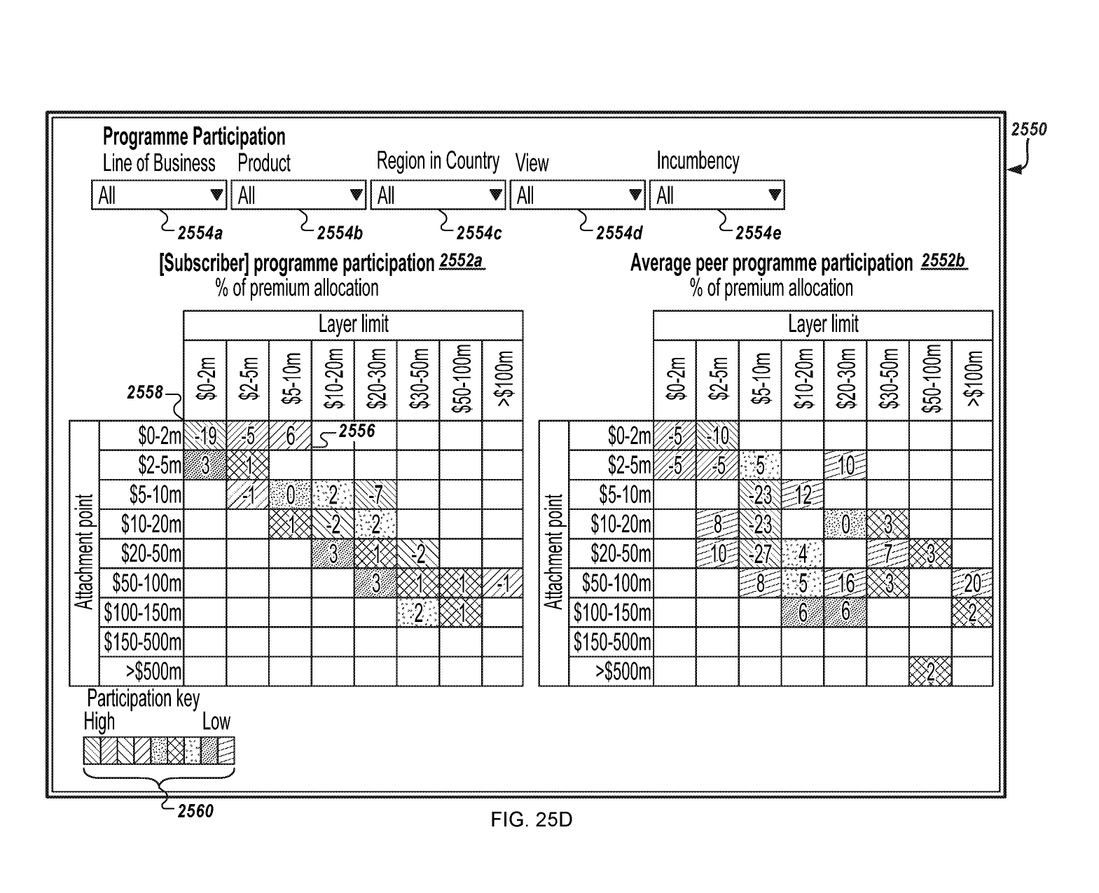

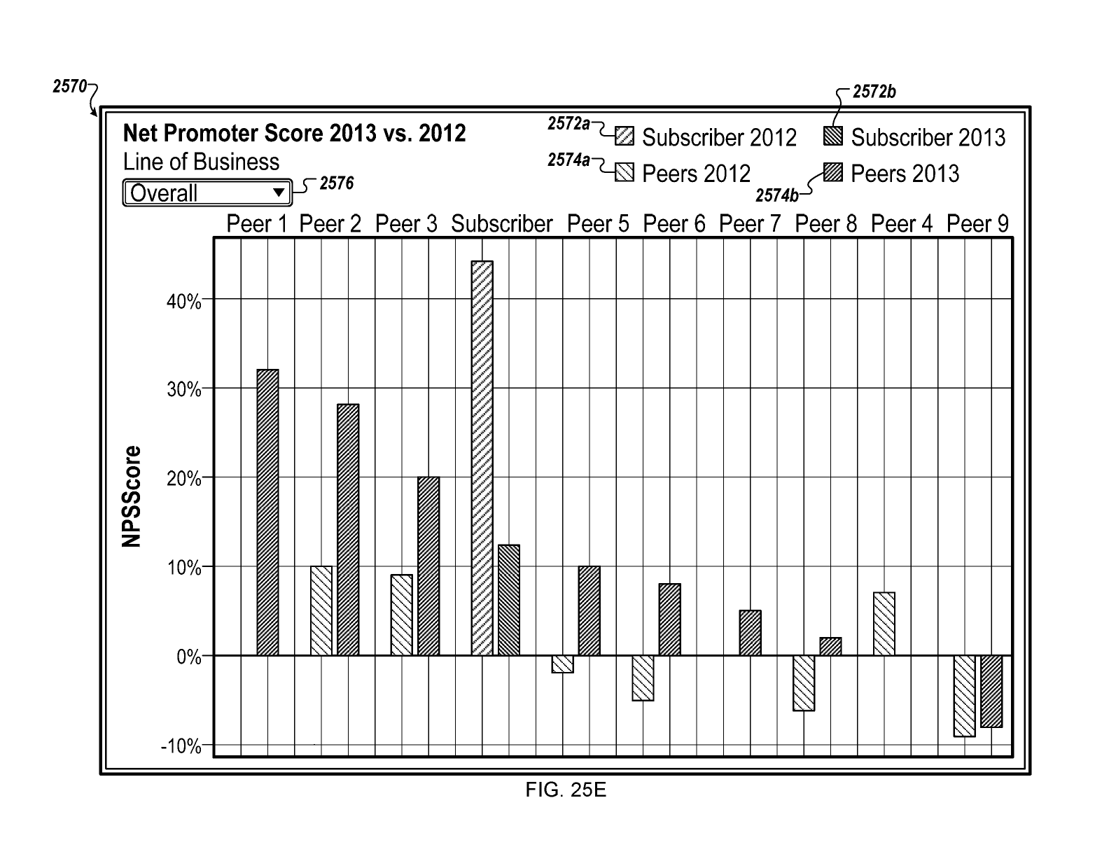

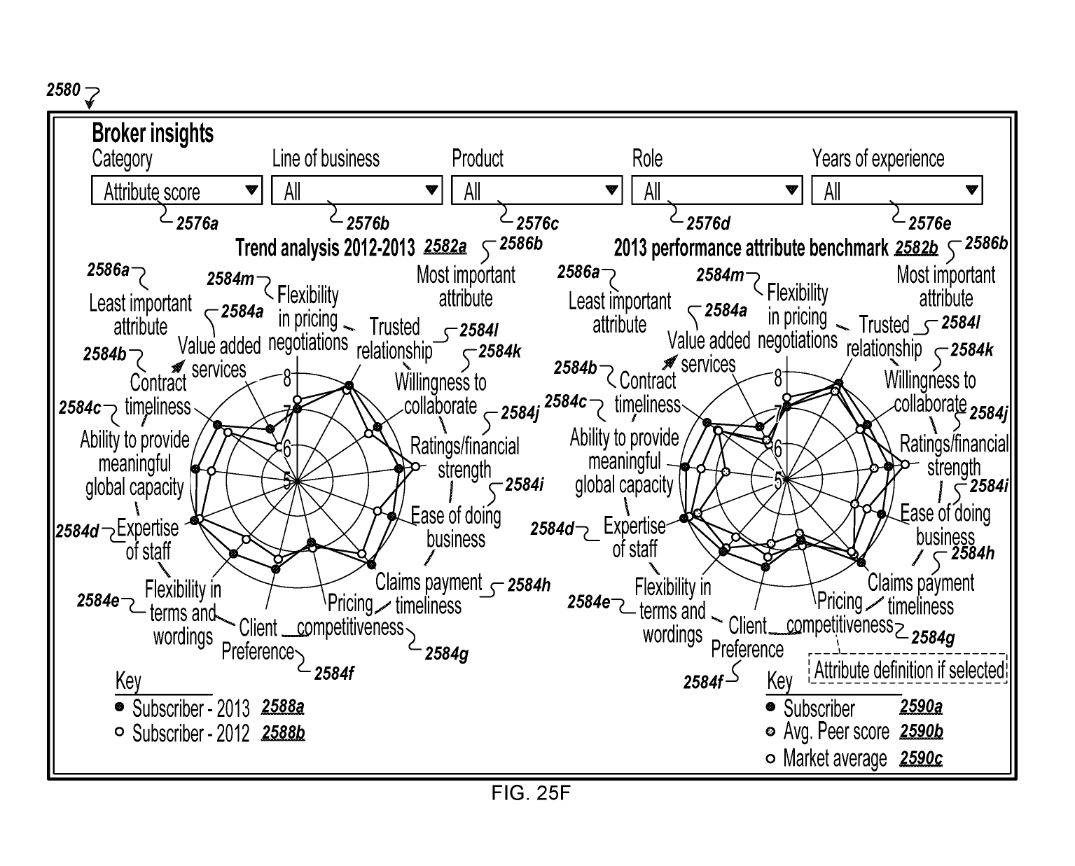

In the “program participation” pane 154, a series of navigational controls 166 provide the reinsurer with access to information pertaining to allocation of the reinsurer's premium by attachment point and layer limit. For example, by activating a “participation by premium” navigational control 166a, a reinsurer may be directed to an information display similar to an example screenshot 2550 of FIG. 25D. Turning to FIG. 25D, two side-by-side charts 2552 illustrate a comparison between the reinsurer's percentage of premium allocation per attachment point and layer limit and the average reinsurer peer percentage of premium allocation per attachment point and layer limit. The participation charts 2552 may furthermore be color-coded to draw attention to high participation combinations as well as low participation combinations. For example, the reinsurer demonstrates low participation 2556 for a five to ten million dollar layer limit with a zero to two million dollar attachment point and high participation 2558 for a zero to two million dollar layer limit with a zero to two million dollar attachment point, as referenced by a participation key 2560. In some embodiments, the information presented within the screenshot 2550 is directed towards a particular country. A series of drop-down menus 2554 provide the reinsurer with the opportunity to filter the information by one or more of a “line of business” menu 2554a (e.g., similar to a “participation by business line” navigational control 166b of FIG. 1C), a “product” menu 2554b (e.g., similar to a “participation by product” navigational control 166c of FIG. 1C), a “region in country” menu 2554c (e.g., similar to a “participation by geography” navigational control 166d of FIG. 1C), a “view” menu 2554d (e.g., similar to a “participation by view” navigational control 166d of FIG. 1C), and an “incumbency” menu 2554e providing the options, for example, of existing business and new business (e.g., similar to a “participation by incumbency” navigational control 166f of FIG. 1C). An incumbent, for example, may refer to a reinsurer with any share greater than zero on a program, contract, or layer.

Returning to FIG. 1C, the “client purchasing patterns” pane 156 includes a number of navigational controls 168 for reviewing buying behaviors of cedents across lines of business. The information accessible via the navigational controls 168, for example, may be similar to a graphical analysis provided in a screenshot 2660 of FIG. 26D. Turning to FIG. 26D, a bar graph illustrates, for each of ten lines of business, average program structure data per line of business (e.g., accessible via an “average program structure by business line” control 168a of FIG. 1C). For example, the bar graph includes the following data: a maximum gross written premium percentage 2662 (e.g., accessible via a “max GWP % vs. peers” control 168c of FIG. 1C), an average number of participants per program 2664 (e.g., accessible via an “average participants per program” control 168b of FIG. 1C), and an average security rating 2666 (e.g., accessible via an “average security rating” control 168d of FIG. 1C). In some embodiments, the information presented within the screenshot 2660 is directed towards a particular country. Additionally, a series of drop-down menus 2668 are available to the reinsurer to filter the information presented within the bar graph. For example, a “region in country” menu 2668a, when selected, filters the information by geographical region, a “product” menu 2668b, when selected, filters the information by product type, a “cedent type” menu 2668c, when selected, filters the information by cedent type, and a “premium band” menu 2668d, when selected, filters the information by range of premium values. Filters may be applied individually or together to refine information presented by the bar graph. In other embodiments (not illustrated), the reinsurance dashboard 130 may include filtering options within the “client purchasing patterns” pane 156 of FIG. 1C.

As shown in FIG. 1C, the “market flow analysis” pane 158 includes navigational controls 170 directed towards accessing information regarding market flow analytics, such as benchmarking analysis of the reinsurer's requested line versus signed line by line of business as well as market capacity versus capacity utilization by line of business. The navigational controls 170, for example, may provide the reinsurer with access to graphical output such as the display illustrated in a screenshot 2516 of FIG. 25B.

Turning to FIG. 25B, the screenshot 2516 includes a “requested line vs. signed line benchmark” graph 2518 illustrating, for each of a subscriber (reinsurer) 2522a, an average peer 2522b, a best in class peer 2522c, and a market average performance 2522d, data points including maximum 2520a, average 2520b, and minimum 2520c percentages of requested line to signed line. The information illustrated in the graph 2518, for example, may be accessible via a “market flow” control 170a of FIG. 1C. Using a “line of business” menu 2528c, the graph 2518 may be filtered by a selected line of business, similar for example to using a “flow by business line” control 170c of FIG. 1C. Similarly, using a “product” menu 2528d, the graph 2518 may be filtered by a selected product type, similar for example to using a “flow by product” control 170e of FIG. 1C.

Next to the graph 1518, a “market capacity vs. utilization” bar graph 2530 illustrates a comparison of market capacity 2524a to market capacity utilization 2524b by line of business. Further, beneath the bar graph, a percentage capacity utilization 2526 is displayed. Information similar to the information provided by the bar graph 2530, for example, may be accessible via a “market capacity” control 170b of FIG. 1C. In some embodiments, the information presented within by the bar graph 2530 is directed towards a particular country. Using a “line of business” menu 2528c, the graph 2530 may be filtered by a selected line of business, similar for example to using a “capacity by business line” control 170d of FIG. 1C. Similarly, using a “product” menu 2528d, the graph 2530 may be filtered by a selected product type, similar for example to using a “capacity by product” control 170f of FIG. 1C. Additional filters applicable to the graphs 2518 and 2530 (not illustrated within the “market flow analysis” pane 158 of FIG. 1C) include a “region in country” menu 2528a for filtering by geographic region, a “view” menu 2528b for filtering by cedent location, and an “incumbency” menu 2528e for filtering by incumbency. Rather than or in addition to filtering by cedent location, in other embodiments, information may be filtered by type of cedent (e.g., local, regional, or global; small, medium, or large; etc.). In other implementations, controls for filtering by geography, view, and/or incumbency are included in the dashboard 130. Further, in other embodiments, information may be filtered to identify where the subscriber is “leading” the market as opposed to where the subscriber is “following” the market. In yet another example, information may be filtered by type of market.

Returning to FIG. 1C, the “premium flow analysis” pane 160 presents the reinsurer with navigational controls 172 configured to provide access to analytics demonstrating the flow of premium between a geographic location where business originated to a geographic region the business is placed from or a geographic region the business is underwritten from. Additionally, navigational controls 174 are configured to provide access to analytics demonstrating the contribution of premium on a geographic location basis, presenting information regarding business origination location, broked location, and/or underwriting location. In some examples, screenshot 2600 of FIG. 26A and screenshot 2620 of FIG. 26B illustrate map-based premium flow displays for presenting premium flow analytics to a reinsurer.

Turning to FIG. 26A, the screenshot 2600 illustrates a map demonstrating premium flow from an originating region 2602 (Oceana) to reinsurance hubs 2604 (Asia Pacific 2604a, Europe 2604b, United Kingdom 2604c, Bermuda 2604d, North America 2604e, and Other 2604f). Location 2602 includes a pie graph illustrating insurance marketplace outflow premium 2606b as well as subscriber premium outflow contribution 2606a. Each location 2604 is represented with a pie graph illustrating insurance marketplace in flow premium 2608a as well as subscriber in flow premium contribution 2608b. In other embodiments, statistical data may be presented in the screenshot 2600, for example upon selection of one of the pie graphs associated with locations 2602 and/or 2604. In some examples, statistical data can include GWP pool, percentage GWP share by the subscriber (reinsurer), and percentage GWP share by the average peer. The information presented within the screenshot 2600 may be accessed, for example, using a “premium flow by underwriting region” control 172c of FIG. 1C. The reinsurer may choose to filter the information presented within the screenshot 2600 using one or more of a series of drop-down menus 2610. The drop-down menus 2610 include a “market flow” menu 2610a, a “from location” menu 2610b, a “line of business” menu 2610d, and a “product” menu 2610c. Using the “market flow” menu 2610a, for example, the subscriber may choose to switch from underwriting location to originating location or broked location, for example as accessible by a “premium flow by broked region” control 172b of FIG. 1C or a “premium flow by originating region” control 172c of FIG. 1C.

Referring to FIG. 26B, a screenshot 2620 illustrates a map demonstrating premium contra flow into reinsurer location United Kingdom 2622 from cedent locations 2624 (e.g., for example as accessible by a “contribution by underwriting region” control 174c. Location 2622 includes a pie graph illustrating insurance marketplace inflow premium 2608a as well as subscriber premium inflow contribution 2608b. Each location 2624 is represented with a pie graph illustrating insurance marketplace out flow premium 2606a as well as subscriber out flow premium contribution 2606b. In other embodiments, statistical data may be presented in the screenshot 2620, for example upon selection of one of the pie graphs associated with locations 2622 and/or 2624. As with the screenshot 2600, the drop-down menus 2610 provide the subscriber with filtering opportunities. For example, the subscriber may choose to switch from cedent location to originating location or broked location, for example as accessible by a “contribution by broked region” control 174b of FIG. 1C or a “contribution by originating region” control 174c of FIG. 1C.

Upon selection of the research & analytics tab 114c of FIG. 1C, the reinsurer is presented with a dashboard view presented in FIG. 1D. Turning to FIG. 1D, a “trade analysis” pane 174 includes navigational controls 182 selectable to access trading flow performance analytics of a reinsurer's requested line and signed line. The trading flow performance analytics may be presented on a per-business line basis, and changes in trading flow may be tracked across a period of time, such as quarterly, annually, bi-annually, etc. The trading flow performance of the reinsurer may be compared to performance of a peer group and/or overall market averages. In a particular example, turning to FIG. 25C, a screenshot 2530 presents a trading flow analysis comparing requested line performance of a reinsurer 2532a to a peer group 2532b as well as to market averages 2532c over a period of four quarters. The screenshot 2530, for example, may be presented to the reinsurer upon selection of a “percentage change by phase” control 182a of FIG. 1D. Phase, for example, may refer to requested line and/or signed line. In some embodiments, the information presented within the screenshot 2660 is directed towards a particular country. The selection of the requested phase in the screenshot 2530 is represented by a selection made in a “phase” drop-down menu 2534a. The data presented in the screenshot 2530 is further filtered through a “view” drop-down menu 2534e, presenting trading flow data from the viewpoint of cedent location (e.g., versus broked location or underwriter location). Selection of view, for example, may be made using a “percentage change by view” control 182b of FIG. 1D. The reinsurer is presented with additional filtering options via a “line of business” drop-down menu 2534b (e.g., correlating to a “percentage change by business line” control 182c of FIG. 1D), a “product” drop-down menu 2534c (e.g., correlating to a “percentage change by product” control 182d of FIG. 1D), a “region in country” drop-down menu 2534d (e.g., correlating to a “percentage change by product” control 182d of FIG. 1D), and an “incumbency” drop-down menu 2324f (e.g., correlating to a “percentage change by incumbency” control 182f of FIG. 1D). A table 2536 presents percentage values for each of the subscriber 2532a statistic, average peer 2532b statistic, and market average 2532c statistic for each quarter of the presented period of time, as well as average values 2538 for the entire time period for each of the subscriber 2532a, the average peer 2532b, and the market average 2532c.

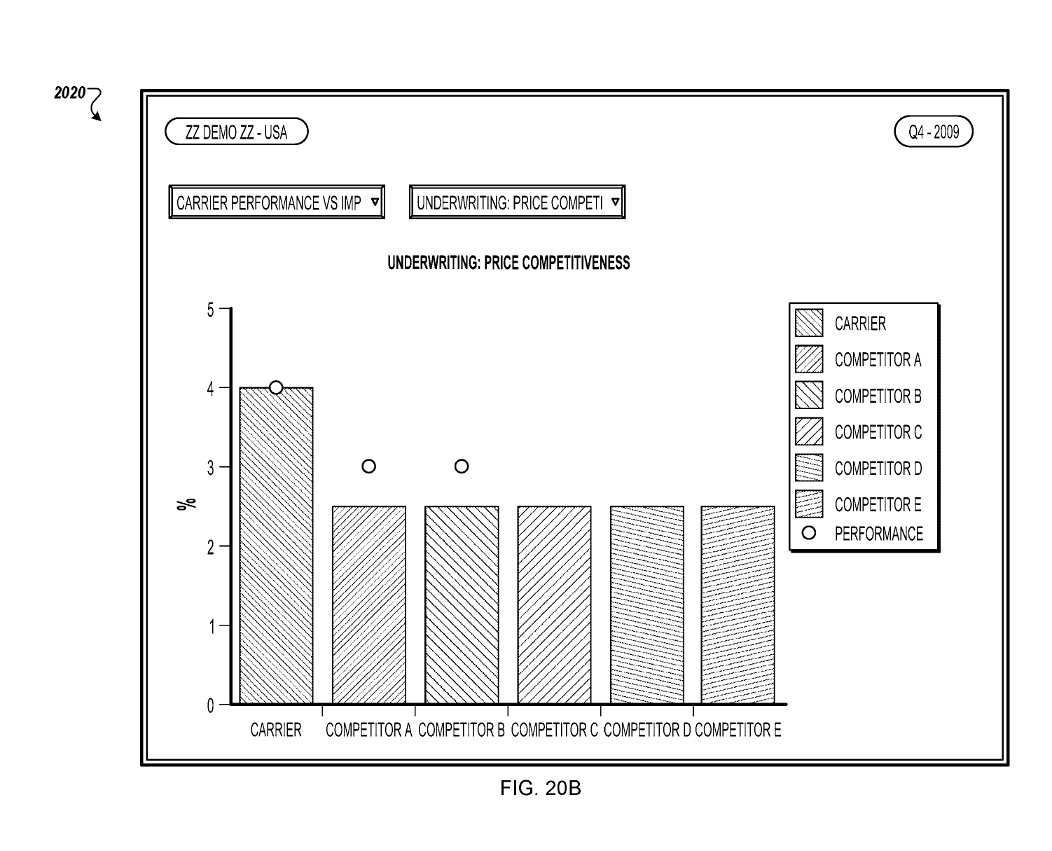

FIG. 1D also includes a “customer feedback analysis” pane 176 with navigational controls 184 configured to present the reinsurer with information regarding customer feedback collected, for example, via the insurance marketplace environment. The customer feedback, as illustrated in a screenshot 2570 of FIG. 25E, may be combined to determine an overall feedback score such as a Net Promoter® Score (NPS) by Satmetrix Systems, Inc. of San Mateo, Calif. Additionally, as illustrated in a screenshot 2580 of FIG. 25F, the reinsurer may be provided access to analysis of individual attributes contributing to an overall customer feedback score. Collection and calculation of customer feedback metrics are described in greater detail below in relation to FIG. 20A.

Upon selection of a “feedback score” control 184a, the reinsurer may be presented with the screenshot 2570, illustrating a bar graph that compares a subscriber 2572 customer feedback score with averages for a selection of eight anonymized peers 2572 collected over a same period of time (e.g., calendar years 2012 and 2013 as illustrated in the screenshot 2570). Broker commentary may be presented (e.g., beneath the graph, as a pop-up upon selection of the subscriber 2572a data, etc.) presenting individual feedback provided by one or more brokers that have done business with the reinsurer. The data presented in the screenshot 2570 can be filtered through a series of drop-down menus 2576. For example, a “line of business” menu 2576 may map to a “feedback by business line” control 184c of FIG. 1D, while a “product” menu (not illustrated) maps to a “feedback by product” control 184d of FIG. 1D, a “role” menu (not illustrated) (e.g., broker, claims, client management, etc.) maps to a “feedback by role” control 184e of FIG. 1D, and a “years of experience” menu 2576e (not illustrated) maps to a “feedback by experience” control 184f of FIG. 1D. A “category” menu 2576a, currently set to NPS, may be switched to “attribute score”, thereby causing presentation of the screenshot 2580 of FIG. 25F. Similarly, selection of a “feedback attributes” control 184b of FIG. 1D may cause presentation of the screenshot 2580 of FIG. 25F.

Turning to FIG. 25F, the screenshot 2580 includes a set of radar charts 2582 illustrating comparisons of values of a set of attributes 2584, arranged from a least important attribute 2586a to a most important attribute 2586b. The importance of each attribute 2584, for example, may be determined by a ranking made by the customers during the feedback process. Alternatively, the importance of each attribute 2584 may be selected by the reinsurer, established by a third party (such as the NPS® provider), or determined by the global risk insight platform (e.g., through a survey of select subscribers, analysis of total NPS® score in relation to individual attribute components, etc.). Each attribute 2584 is represented by a brief descriptive label. In some embodiments, full definitions of each attribute 2584 are available to the reinsurer via the screenshot 2580 (not illustrated). For example, attribute definitions may be presented upon selection of one of the attributes 2584 or beneath the radar charts 2582.

In a first radar chart 2582a, subscriber attribute values collected from two separate time periods 2588 (e.g., year 2013 and year 2012) are displayed together to illustrate positive and negative movement in each attribute 2584 between the two consecutive time periods 2588. In a second radar chart 2582b, subscriber 2590a attribute values collected during a most recent time period (e.g., year 2013) are displayed with average peer 2590b attribute values and market average 2590c attribute values collected during the same time period. In review, a reinsurer can quickly identify strengths and weaknesses regarding the various feedback attributes 2584.

As illustrated in FIG. 1D, a premium share analysis pane 178 provides the reinsurer with a set of navigational controls 186 configured to access a detailed breakdown of the reinsurer's competitive position by line of business against peers. The information, for example, may include a presentation similar to a screenshot 2500 of FIG. 25A. For example, upon selection of a “share by premium” control 186a, the reinsurance dashboard 130 may present the reinsurer with a display similar to the screenshot 2500 of FIG. 25A.

Turning to FIG. 25A, the premium share 2504 by line of business 2510 of an insurance marketplace broked premium 2502 is charted in a bar graph. The bar graph is overlaid by two line graphs, the first illustrating a subscriber (reinsurer) share 2506 by line of business, and the second illustrating an average peer share 2508 by line of business. Review of the bar graph allows the reinsurer to track its position within the insurance marketplace relative to the average peer share.

Additionally, beneath the bar graph, a table lists specific statistical values related to premium share for each of the insurance marketplace 2504, the subscriber 2506, and the average peer share 2508 as well as totals 2515 related to each particular value (2512a, 2512b, 2514a, 2514b, and 2508). Statistics 2512 associated with the insurance marketplace include total premium 2512a per line of business 2510 as well as percentage of book 2512b per line of business 2510. Statistics 2514 associated with the subscriber 2506 include GWP 2514a per line of business 2510, market share 2514b per line of business 2510, and rank 2514c per line of business 2510. In some embodiments, the information presented within the screenshot 2500 is directed towards a particular country.

The reinsurer may filter the illustrated statistics using a series of drop-down menus 2501. For example, rather than reviewing an analysis of premium value in dollars, a “category” menu 2501a provides the option of reviewing the statistical analysis on the basis of policy count (e.g., similar to a “share by policy count” control 186b of FIG. 1D). Other filters include a “region in country” menu 2501b (e.g., similar to a “share by geography” control 186c of FIG. 1D), a “view” menu 2501c (e.g., similar to a “share by view” control 186d of FIG. 1D), a “product” menu 2501d (e.g., similar to a “share by product” control 186e of FIG. 1D), and a “cedent type” menu 2501e (e.g., similar to a “share by cedent type” control 186f of FIG. 1D). Additional filters include a “reinsurer capital” menu 2501f providing selection of premium by band (e.g., similar to a “share by premium by band” control 186g of FIG. 1D) and a “security rating” menu 2501g providing selection of premium by rating (e.g., similar to a “share by security rating” control 186h of FIG. 1D).

Returning to FIG. 1D, a “strategic and tactical impact analysis of premium share” control 186i, upon selection, generates an analysis of premium share in comparison to average (baseline) results within the insurance marketplace to identify both a contribution caused by strategic reasons (e.g., the subscriber writes a larger or smaller share of lines with high or low profits) and by tactical reasons (e.g., the subscriber is better or worse at selecting individual cedents). The analysis obtained through the “strategic and tactical impact analysis of premium share” control 186i, for example, allows the subscriber to review performance measures based upon the subscriber's actual business balance. The “strategic and tactical impact analysis of premium share” control 186i works to present performance measures based upon actual business line balance such as, in an analogous situation, a stock portfolio may be reviewed based upon a risk-aligned analysis of the portfolio to determine how well a stock broker is doing in selecting individual stocks within a particular risk segment.

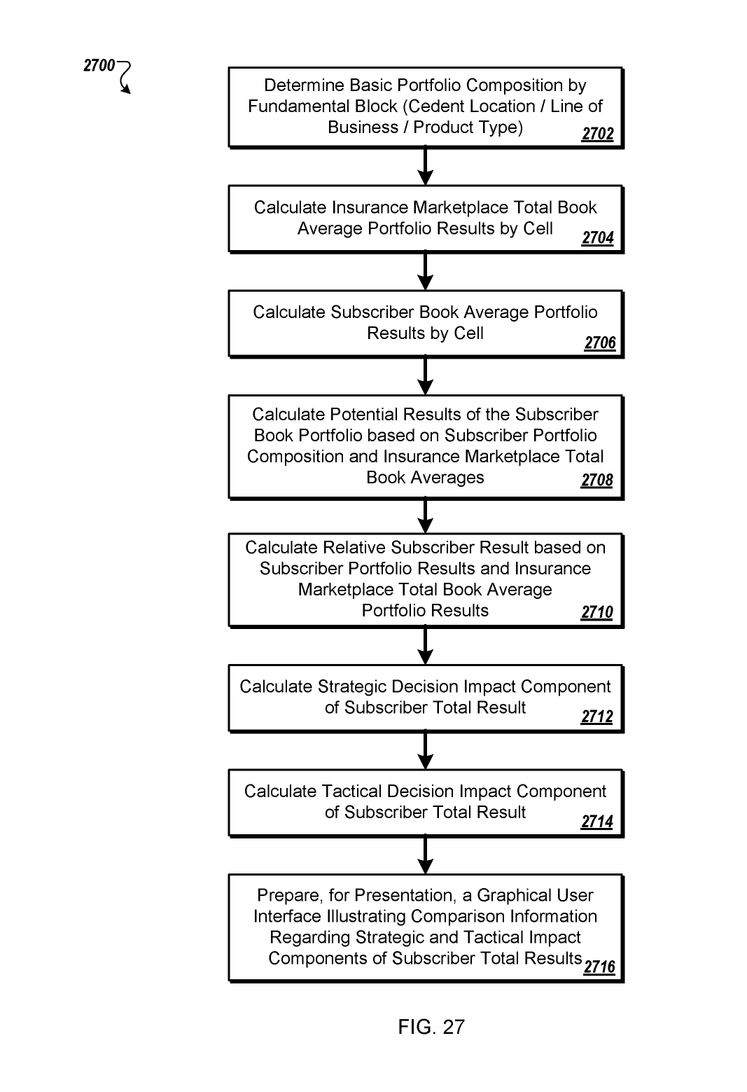

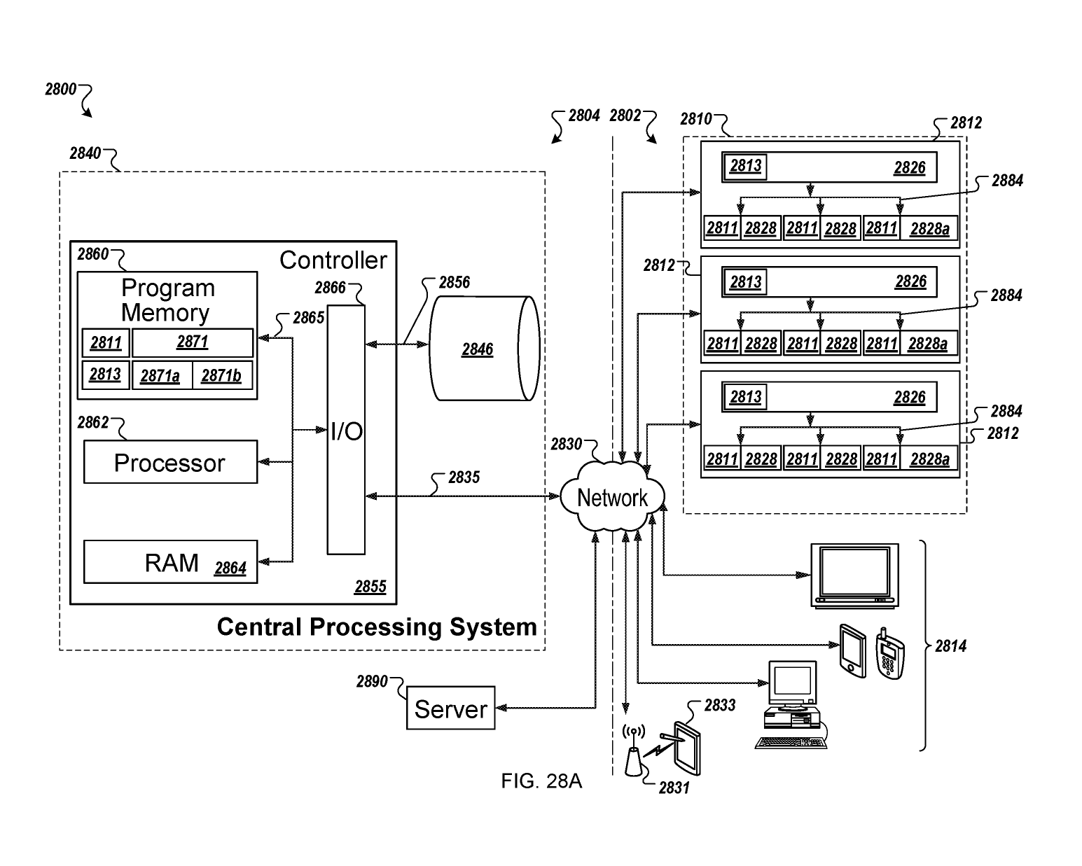

Turning to FIG. 27, a flow chart illustrates an example method 2700 for determining strategic and tactical impact components of a subscriber's performance results, such as premium share metrics, cross sales metrics, trade metrics, and profitability metrics (e.g., based upon loss ratios, ceding commission ratios, brokerage ratios, and/or expense ratios) for a given reinsurance subscriber. The method 2700, for example, may be used to present an analysis of strategic and tactical impacts on performance metrics in response to selection of the “strategic and tactical impact analysis of premium share” control 186i of FIG. 1D and/or a “strategic and tactical impact analysis of GWP” control 188g of FIG. 1D.

In some implementations, the method 2700 begins with determining a basic portfolio composition of a requesting subscriber (2702). The composition, for example, may be composed of fundamental building blocks such as, in some examples, cedent location(s), line(s) of business, and/or product type(s). A software algorithm may analyze the subscriber's book of business to identify a portfolio composition. In another example, a user may be presented with an interactive graphical user interface selection process for identifying portfolio composition. For example, the user may select to filter information to focus on a particular geographic region, business line, product type, or product category.

In some implementations, results for a total book average portfolio of the insurance marketplace are calculated by cell (2704). Each cell, for example, may represent a particular combination of fundamental building blocks (e.g., location “North America,” product, “Treaty Pro Rata,” line of business “professional liability,” or a combination of two or more elements). If the subscriber chose to filter the information, the total book average portfolio results may similarly be filtered to the target viewpoint. The resultant information may be referred to as Marketplace_{Total}. The Marketplace_{Total} data reflects the average composition of the books of business of reinsurance subscribers of the insurance marketplace.

In some implementations, results for a book average portfolio of the subscriber are calculated by cell (2706). Data correlating to the results described above in relation to the total book average portfolio of the insurance marketplace may be calculated pertaining to the portfolio composition of the subscriber. The resultant information may be referred to as Subscriber_{S Results/S Mix}. The information Subscriber_{S Results/S Mix} reflects a composition (mix) of the book of business of the subscriber with metrics reflecting results achieved by the subscriber.

In some implementations, potential results representing the subscriber book portfolio composition and insurance marketplace averages for that composition are calculated (2708). Data corresponding to the insurance marketplace averages are combined in the composition (mix) of the subscriber portfolio to obtain metrics demonstrating potential (marketplace) results, referred to as Subscriber_{M Results/S Mix}. The information Subscriber_{M Results/S Mix} reflects average insurance marketplace performance, taking into account the subscriber's portfolio composition.

In some implementations, a subscriber portfolio result relative to the insurance marketplace portfolio results is calculated (2710). The difference, for example, between insurance marketplace average performance and subscriber portfolio performance may be calculated by subtracting the information Marketplace_{Total} from the information Subscriber_{S Results/S Mix} to obtain a relative result R (e.g., R=Subscriber_{S Results/S Mix}−Marketplace_{Total}).

In some implementations, a strategic decision impact component of the subscriber's achieved results is calculated (2712). The strategic impact component, for example, may be determined by calculating the difference of the insurance marketplace average based upon insurance marketplace average portfolio information and the insurance marketplace average calculated using the particular portfolio composition of the subscriber. In a particular example, the strategic decision component S is calculated as follows: S=Subscriber_{M Results/S Mix}−Marketplace_{Total}. This value represents the relative performance of the subscriber's portfolio balance to the performance of the insurance marketplace as a whole, based entirely on performance averages of the insurance marketplace. In reviewing this information, the subscriber may review the impact of the subscriber's basic portfolio composition decisions on performance without focusing on particular performance based upon the subscriber's particular book of business.

In some implementations, a tactical decision impact component of the subscriber's achieved results is calculated (2714). The tactical decision component, for example, may be determine by calculating the difference of the subscriber's result metrics and insurance marketplace averages based upon the portfolio balance of the subscriber. In a particular example, the tactical decision component T is calculated as follows: T=Subscriber_{S Results/S Mix}−Subscriber_{M Results/S Mix}. The subscriber may review the tactical decision component to determine how well line underwriters are performing in selecting individual cedents for building the subscriber's book of business.

In some implementations, a graphical user interface illustrating comparison information regarding strategic and tactical impact components of subscriber total results is prepared for presentation upon a subscriber computing device (2716). The graphical user interface, for example, may illustrate, using graphs, charts, tables, and/or other visual representations, relative performance aspects of the subscriber's portfolio based upon a decomposition of performance into strategic and tactical components. Further, the graphical user interface may include detailed information corresponding to performance analysis based upon separate portfolio components (fundamental blocks) of the overall portfolio composition. The user may be provided an opportunity, for example, to filter information to focus upon one or more components of the overall portfolio.

Although described in relation to a reinsurance subscriber, in other implementations, an insurance subscriber or carrier subscriber may review decomposition of strategic and tactical components of various performance metrics based upon the impact of the fundamental building blocks of the subscriber's book of business. Further, in some implementations, a subscriber may be provided the opportunity to historically analyze a potential portfolio composition, for example by selecting a balance of fundamental building blocks to define a portfolio composition. In analyzing historic performance, in some embodiments, the subscriber is presented with timeframe options (e.g., past year, past three years, past five years, etc.). The timeframe options may differ by type of subscriber. For example, monthly changes are more appropriate to insurers than to reinsurers.

Referring to FIG. 1D, a “cross sale analysis” pane 180 presents navigational controls 188 configured to provide the reinsurer with access to analysis of the reinsurer's penetration of the entire book of business. The information provided via the navigational controls 188 may help the reinsurer to identify the potential for additional premium within its risk appetite (e.g., line of business and/or product) by providing data regarding potential new clients as well as data regarding existing clients. Further, a “strategic and tactical impact analysis of GWP” control 188g, when selected, may present the reinsurer with a decomposition of cross sale results based upon strategic decision components and tactical impact components, as discussed above in relation to FIG. 27. The data, for example, may be presented in a similar manner to a screenshot 2640 of FIG. 26C.

Turning to FIG. 26C, a bar graph presents information regarding subscriber (reinsurer) GWP 2650a and cross sale GWP opportunity 2650b (e.g., such as the GWP of the reinsurer's existing clients accessible via a “GWP of existing clients” control 188d of FIG. 1D and GWP of potential new clients accessible via a “GWP of potential clients” control 188a of FIG. 1D). In a first bar of the bar graph, a subscriber premium 2646a represents actual premium for the subscriber (e.g., total premium for all broking locations 2648a, all cedent locations 2648b, all products 2648c, and all lines of business 2648d). The data regarding opportunity is broken down, within the bar graph, by 100% premium by category, where the categories include premium on the layers with subscriber participation 2646b, premium on the contracts with subscriber participation 2646c (e.g., contracts having one or more layers), and premium on clients with subscriber participation 2646d (e.g., clients having one or more contracts). Additionally, an insurance marketplace total premium 2646e is presented in comparison.

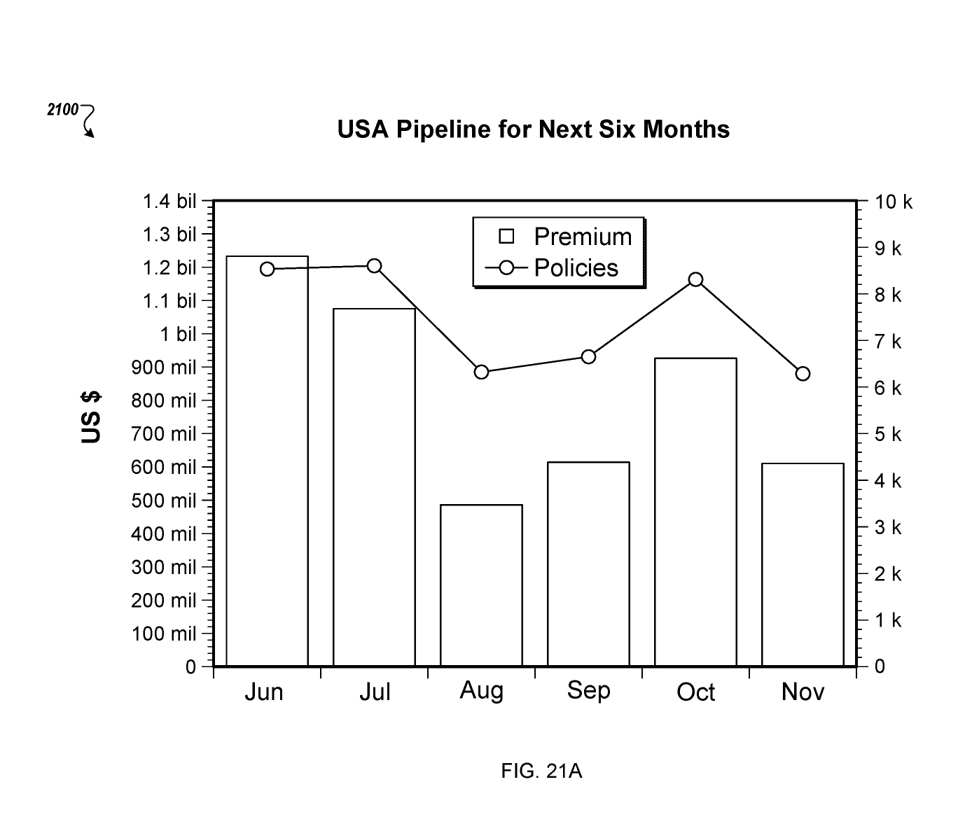

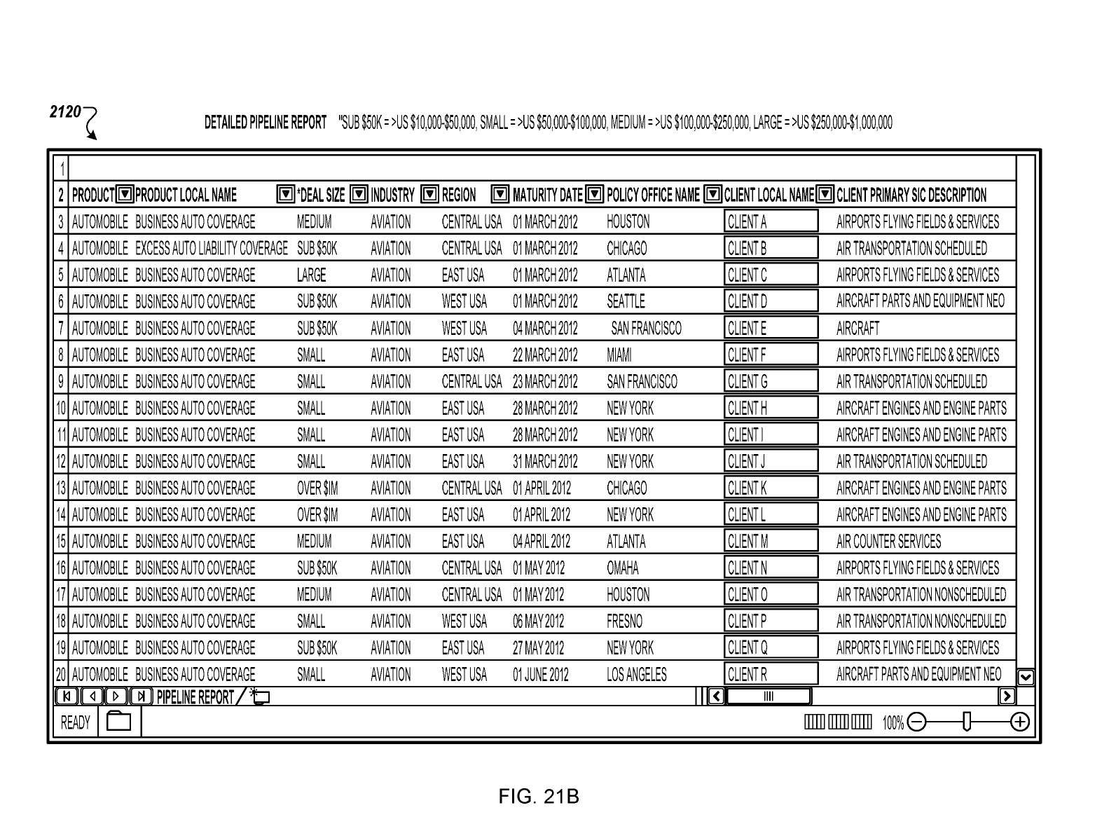

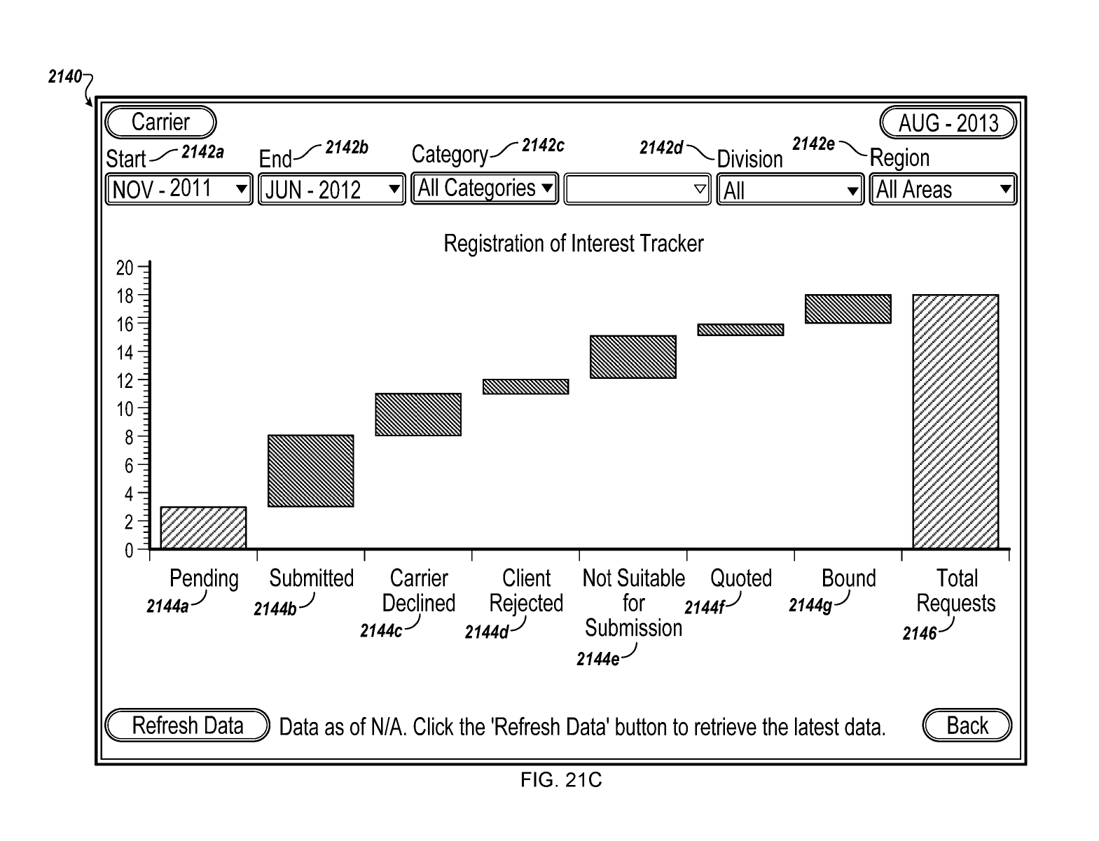

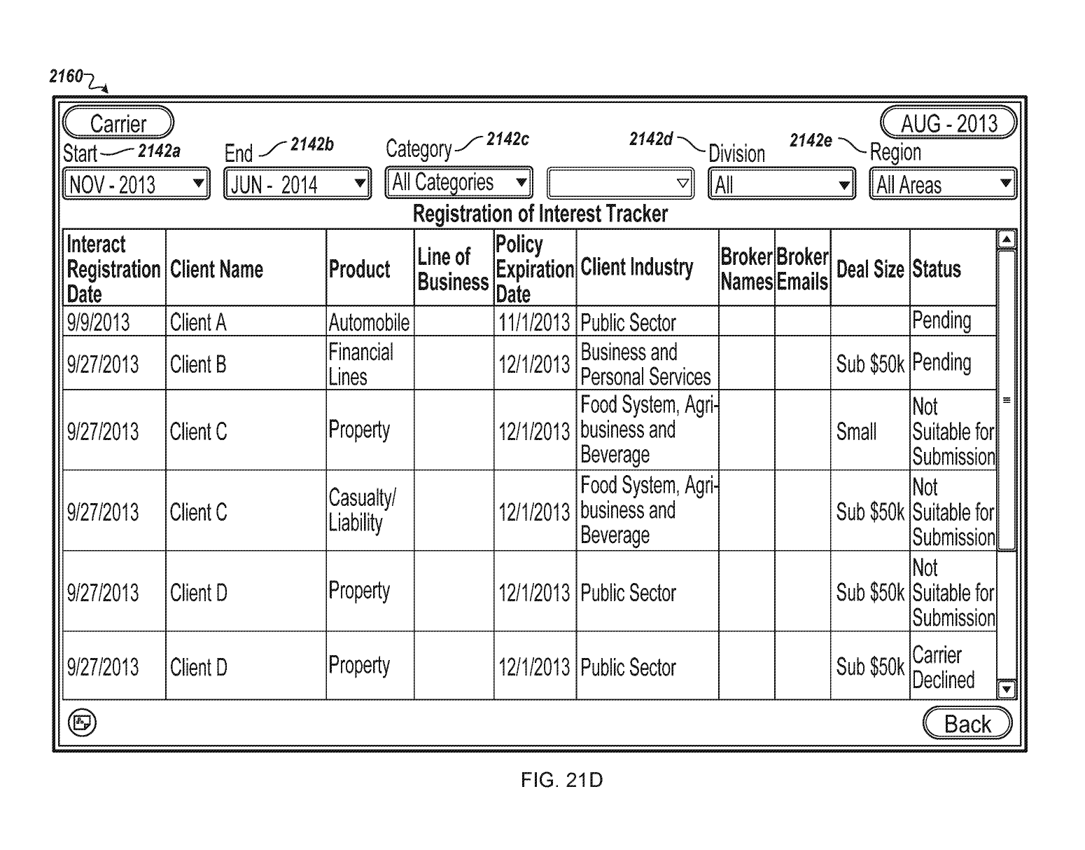

In some implementations, upon selection of a particular bar 2646 of the bar graph of screenshot 2640, the subscriber can drill down into specific account information, for example to identify particular opportunities. A similar concept, for example, has been described in relation to pipeline opportunities of FIGS. 21A through 21D, below.

In some examples, when identifying opportunities, potential new clients may be subscribers of the insurance marketplace and environment, clients external to the insurance marketplace and environment, and/or potential clients identified by the reinsurer. Potential clients, in some examples, may be identified by the insurance marketplace and environment based upon the potential clients' line of business and/or products relevant to the potential clients. Using the graph presented in the screenshot 2640, a subscribing reinsurer can understand opportunities on contracts and clients representing existing relationships that are defined at different levels (e.g., by broking location, cedent location, etc.).

The reinsurer may analyze potential clients by line of business using a line of business drop-down menu 2648d (e.g., accessible via a “GWP of clients by line of business” control 188b of FIG. 1D). Additionally or alternatively, the reinsurer may be able to identify potential for additional premium falling within its risk appetite by analyzing potential clients by product through a product drop-down menu 2648c (accessible via a “GWP of clients by product” control 188e of FIG. 1D). In some embodiments, the information presented within the screenshot 2640 is directed towards a particular country. The data provided within the screenshot 2640 may be filtered by geography using a “broking location” drop-down menu 2648a, a “cedent location” drop-down menu 2648b, or a “GWP of clients by geography” control 188c of FIG. 1D. The data provided within the screenshot 2640 may also be filtered by view using a “view” drop-down menu (not illustrated) or a “GWP of clients by view” control 188f of FIG. 1D.

FIG. 24 illustrates the example screenshot 2400 presenting high level summary information regarding competitive performance of a reinsurer within a global market. The screenshot 2400 includes a “premium by line” section 2402, a “global distribution of risk” section 2404, and “Premium by Product Split” section 2406, and a “net promoter score summary” section 2408. The information displayed in each of the sections 2402, 2404, 2406, and 2408 may optionally be filtered, in some examples, by line of business, geographic region, and/or product (not illustrated).

In the “premium by line” section 2402, statistical information regarding annual premiums for particular lines of business are shown for both the present subscriber (Acme Reinsurance Co.) and for the insurance marketplace as a whole. In other embodiments, peer comparisons may be illustrated within the “premium by line” section 2402. The peers, in some examples, may be limited to reinsurers that, for example, are active in the presented lines of business. The peers may be limited to other reinsurers participating within the insurance marketplace environment. Conversely, at least a portion of the peers may include reinsurers active outside the insurance marketplace environment. When identifying a subscribing reinsurer as a peer of the present reinsurer, in some examples, the insurance marketplace environment may compare reinsurer demographic and/or business information to identify comparable reinsurers. For example, peer reinsurers may include the closest 20 reinsurers to a GWP of the present reinsurer, reinsurers active in similar geographic locations as the present reinsurer, and/or reinsurers active in similar lines of business as the present reinsurer. In other embodiments, peers may be individually identified by subscriber Acme Reinsurance Co., for example through a search and/or selection graphical user interface.

Turning to the “global distribution of risk” section 2404, premium distribution is broken down by cedent location, identifying, for each geographic location presented on a map illustration, the insurance marketplace GWP as well as the reinsurer's (subscriber) percentage share. The shares are noted both in numerical format and in pie chart format. In other embodiments, the “global distribution of risk” section 2404 may further illustrate the average peer competitor's percentage share.

The “premium by product split” section 2406 presents a graphical illustration of relative product share by subscriber “Acme Reinsurance Co.”. As illustrated, catastrophe holds the greatest share, and facultative the smallest share, with excess of loss (27OL) and pro rata holding similar shares (totaling approximately 10% each). In other implementations, the percentages and/or total premiums associated with each product segment may also/alternatively be illustrated.

The “net promoter score summary” section 2408 presents a comparison between reinsurer NPS data, average peer NPS data for eight peers of Acme Reinsurance Co., and a market average NPS for the insurance marketplace. Further detail regarding NPS statistics is provided in relation to FIG. 25E.

FIGS. 1E and 1F illustrate an insurance carrier dashboard user interface 190 for reviewing and analyzing insurance transaction information. The dashboard 190 is part of a web site, web portal, personal computer application, or mobile device application configured to allow the broker to interface with the global risk insight platform and insurance marketplace environment. The dashboard 190 includes the same tabs 114 as illustrated in FIGS. 1A and 1B in relation to broker dashboard interfaces, but each of the tabs 114 now present information relevant to insurance carriers. As shown in FIG. 1E, the “benchmarking” tab 114a of the dashboard 190 is active.

Turning to FIG. 1E, a “reports” pane 192 includes a series of navigational controls 196 configured, upon selection, to provide a carrier with report-style information. The reports, in some embodiments, are customizable by the user, such that individual metrics, geographical regions, products, and other business aspects important to the particular carrier are highlighted. Report preparation, in a general sense, may be similar in method to the steps described in relation to method 200 as described in relation to FIG. 2.

A “pipeline reports” control 196a, upon selection, may present the insurance carrier with a report-style review of transaction opportunities for the insurance carrier as forecast over an upcoming period of time (e.g., over an upcoming quarter, six months, etc.). Generally, a pipeline opportunity represents one or more of an expiring policy that may be up for renewal, a new policy interest, and/or an opportunity for early renewal or restructuring of a policy that is not otherwise expiring in the near future. The pipeline opportunities may be filtered by insurance product, insurance industry, and/or geographical region. The pipeline opportunities may also be filtered by carrier appetite, incumbency, and/or cross sale opportunities. In one example, the “pipeline reports” control 162a, upon selection, may cause the presentation of display aspects similar to those illustrated in FIGS. 21A through 21D (described in further detail below). In the event of an interactive report style (e.g., rendered online or through a computer-based interface linking different display features), aspects of the pipeline report may be accessible within other aspects of the pipeline reports. For example, a carrier may be provided the opportunity to “drill down” into more detailed analysis of pipeline opportunities, for example down to a detailed report 2120 illustrated in FIG. 21B. Further, in some embodiments, a pipeline report provides the carrier with an indication of interest in opportunities registered by brokers. In this manner, the carrier may be alerted to opportunities in which brokers have an active interest. The interest tracking feature is described in greater detail below in relation to FIGS. 21C and 21D.

The “reports” pane 192 also includes a “feedback reports” control 196b, selectable to access a report-style review of customer feedback data collected, for example, via the insurance marketplace environment. The report may present feedback metrics related to the present carrier in comparison to feedback metrics related to peer competitors. Example report components are illustrated in FIGS. 20A and 20B, described in greater detail below. The customer feedback, as illustrated in a screenshot 2000 of FIG. 20A, may be combined to determine an overall feedback score such as a Net Promoter® Score (NPS). Feedback metrics may also be calculated for each stage of the lifecycle of the broking process, such as underwriting, post-placement, claims and overall relationship attributes. FIG. 20B illustrates a screenshot 2020 including a bar graph style comparison between performance of the present carrier during the underwriting stage of the broking process and performance of select peer competitors during the underwriting stage. Additionally, as illustrated in a screenshot 2580 of FIG. 25F in relation to reinsurance feedback, in some embodiments the carrier may be provided access to analysis of individual attributes contributing to an overall customer feedback score.

A “carrier reports” control 196c of the “reports” pane 192, when selected, may present the carrier with a report-style review of present market and/or benchmarking analytics, for example combining information accessible through one or more of a “flow rate analysis” pane 194, a “premium share” pane 101 of FIG. 1F, an “interest tracker” pane 103 of FIG. 1F, a “declination analysis” pane 107, and a “loss analysis” pane 109 of FIG. 1F.

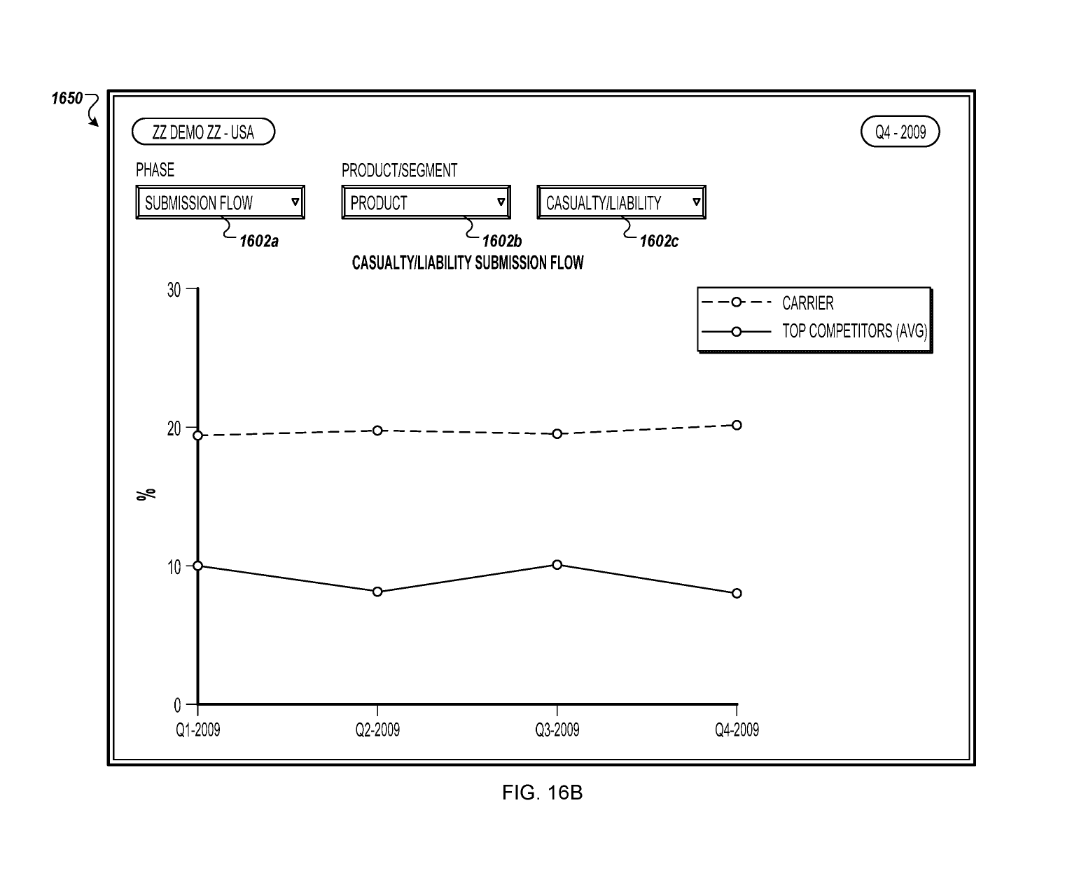

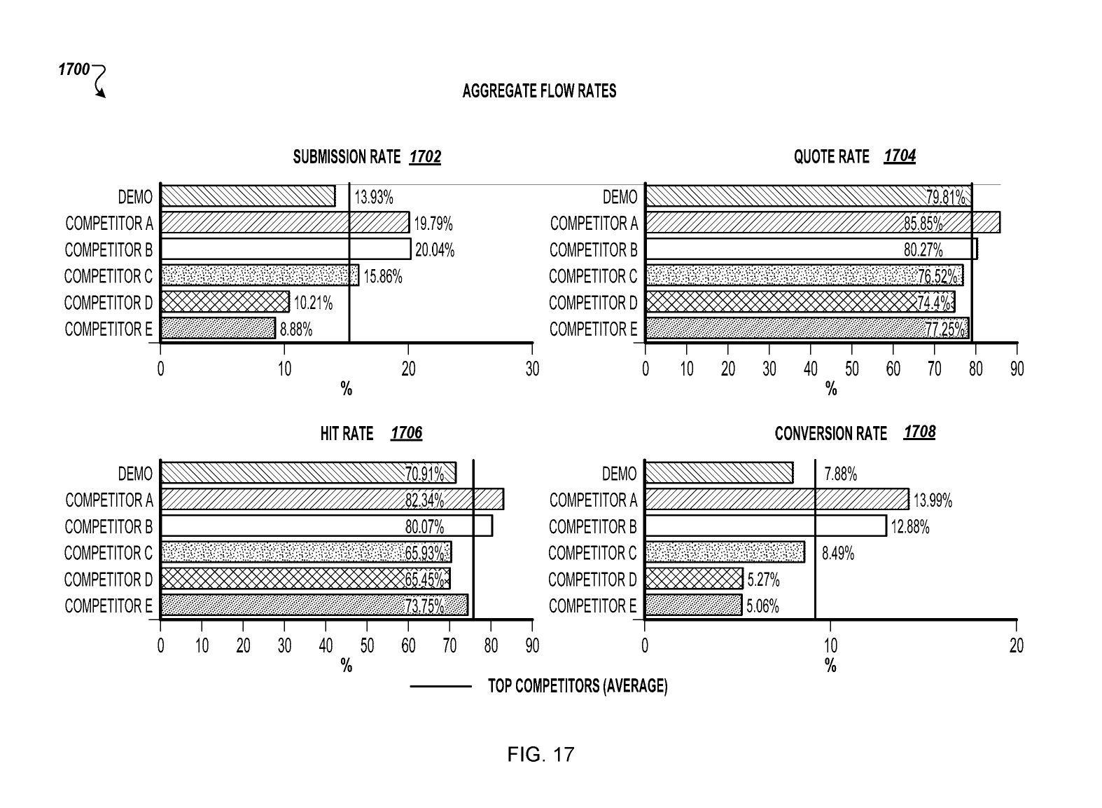

Turning to the flow rate analysis pane 194, a set of navigational controls 198 provides access to a set of analytics referred to as “flow trading,” including submission flow, hit rate, quote rate, and conversion rate. The set of analytics, for example, are illustrated in FIG. 17, described in further detail below. The “flow trading” benchmarking analytics are compared to peer competitors to review performance of the carrier within the marketplace. Furthermore, a set of filtering navigational controls 199 are available to the carrier to filter the “flow trading” analytics by product (using a “flow trading by product” control 199a), geography (using a “flow trading by geography” control 199b), industry (using a “flow trading by industry” control 199c), and/or capacity (using a “flow trading by capacity” control 199d). Other possible filtering options include carrier appetite, incumbency, and carrier division, as discussed below in relation to FIG. 16A.

Upon selection by the carrier, a “submission flow v. peers” control 198a may cause presentation of a screenshot 1600 of FIG. 16A in the carrier dashboard 190. Within the screenshot 1600, submission flow metrics of the carrier are compared to submission flow metrics of the average of top peers as well as the metrics of five individual peers (labeled A through E). In some embodiments, the period of time presented in the screenshot 1600 is user configurable. A “phase” drop-down menu 1602 is available to switch to different trade flowing analytics, similar to use of a “hit rate v. peers” control 1998b, a “quote rate v. peers” control 198c, and a “conversion rate v. peers” control 198d of FIG. 1E. Furthermore, upon selection of a product using a “product/segment” drop-down menu 1602b (or selection of the “flow trading by product” control 199a), a screenshot 1650 of FIG. 16B may be presented to the carrier.

Rather than displaying the “flow trading” metrics individually, in some implementations, aggregate flow rates may be presented within a same display. Turning to FIG. 17, a “submission rate” bar graph 1702, a “quote rate” bar graph 1704, a “hit rate” bar graph 1706, and a “conversion rate” bar graph 1708 are presented within a single screenshot 1700.

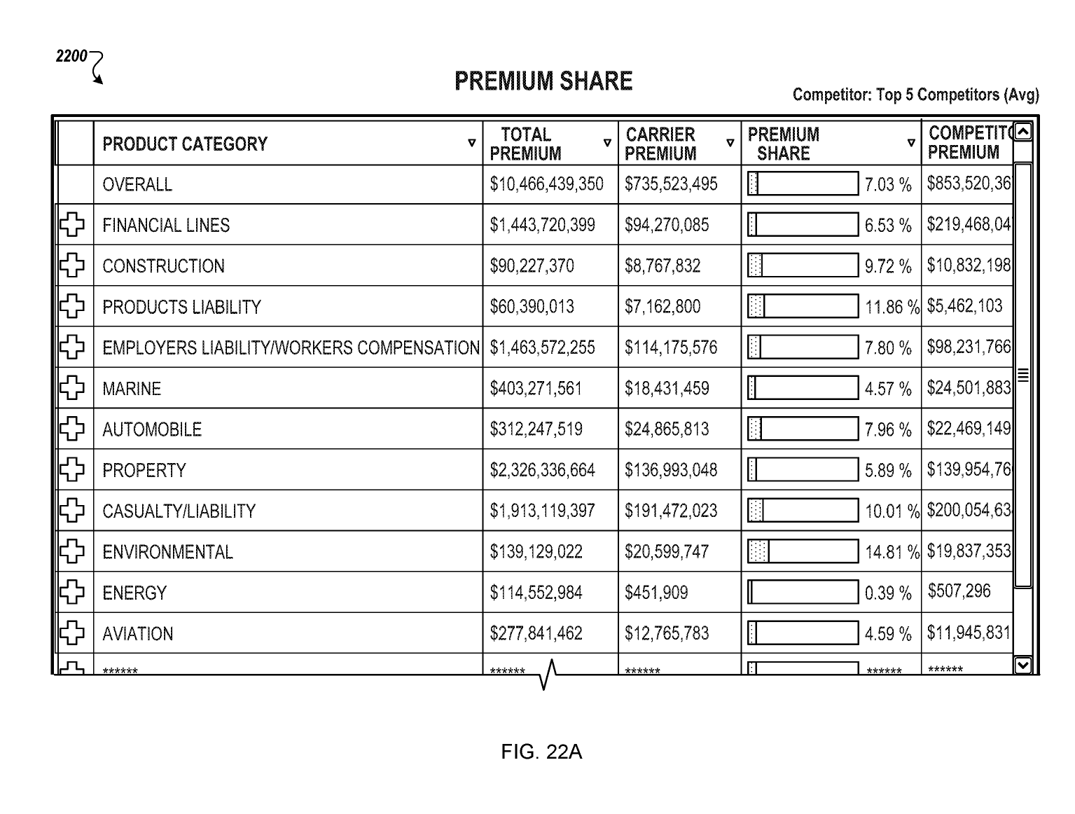

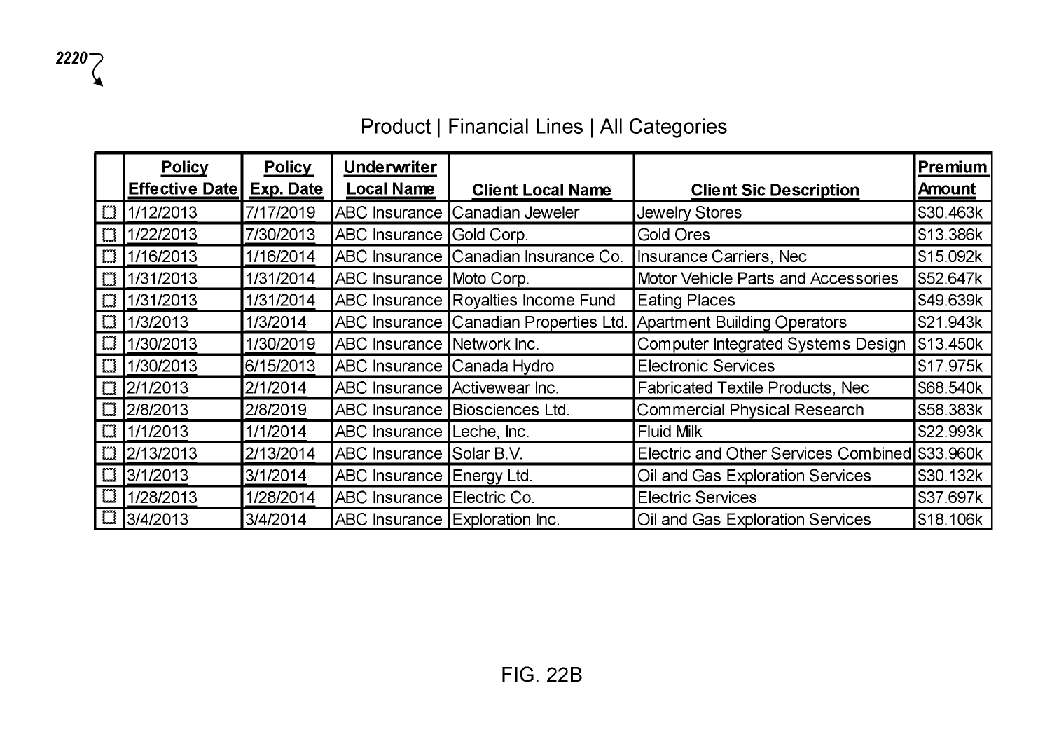

Turning to FIG. 1F, the “research and analytics” tab 114c of the carrier dashboard 190 presents the carrier with the “premium share” pane 101 including navigational controls 111 configured, upon selection, to present analytics regarding premium share. The premium share analytics provide the insurance carrier a general overview of its place in the overall market and the concentration of its business by segment. An example premium share display is presented in a screenshot 2200 of FIG. 22A, described in greater detail below. The screenshot 2200, for example, may be presented to the carrier upon selection of an “aggregate premium” control 111a. Further, the premium share analytics may be filtered by one or more of category (using a “premium by category” control 111b), geographical region (using a “premium by geography” control 111c), view (using a “premium by view” control 111d), product (using a “premium by product” control 111e), and/or industry (using a “premium by industry” control 111e).

To receive greater insight into historic trends of premium share metrics, for example based upon trends within particular clients or particular underwriters, in some embodiments, a row of the screenshot 2200 may be selected to cause presentation of a detailed premium share analysis, for example as illustrated in a screenshot 2220 of FIG. 22B. Turning to FIG. 22B, detailed premium share analysis includes information such as a policy effective date, policy expiration date, underwriter name, client name, client description, and aggregate premium amount.

Portions of aggregate premium data, either at the more abstract level presented in FIG. 22A or on a refined level as presented in FIG. 22B, may be shared with other subscribers of the insurance marketplace environment (e.g., to contribute to peer metrics of competitors). Sharing, in some embodiments, is enabled through an anonymizing feature of the global risk insight platform, such that other subscribers cannot recognize data points as belonging to a particular subscriber. Access to greater levels of data granularity and/or greater refinement of peer comparison metrics, in some embodiments, may be based upon subscriber level. For example, a particular subscriber may pay an additional fee for access to enhanced data granularity and/or peer comparison tools.

Returning to FIG. 1F, the “interest tracker” pane 103 includes a series of navigational controls 113 for accessing opportunities associated with broker interest requests. As discussed above in relation to the pipeline reports control 196a, the interest tracking feature connects interested brokers with available carriers for fulfilling new opportunities. Rather than accessing the opportunities via the pipeline reports control 196a of FIG. 1E, the carrier may select one of the navigational controls 113 to quickly review interest tracker submissions by product (using a “requests by product” control 113a), by client industry (using a “requests by client industry” control 113b), by deal size (using a “requests by deal size” control 113c), by status (using a “requests by status” control 113d), by category (using a “requests by category” control 113e), and/or by geographical region (using a “requests by geography” control 113f). Selection of one of the navigational controls 113, for example, may present the carrier with a view similar to the screenshot 2160 of FIG. 21D.

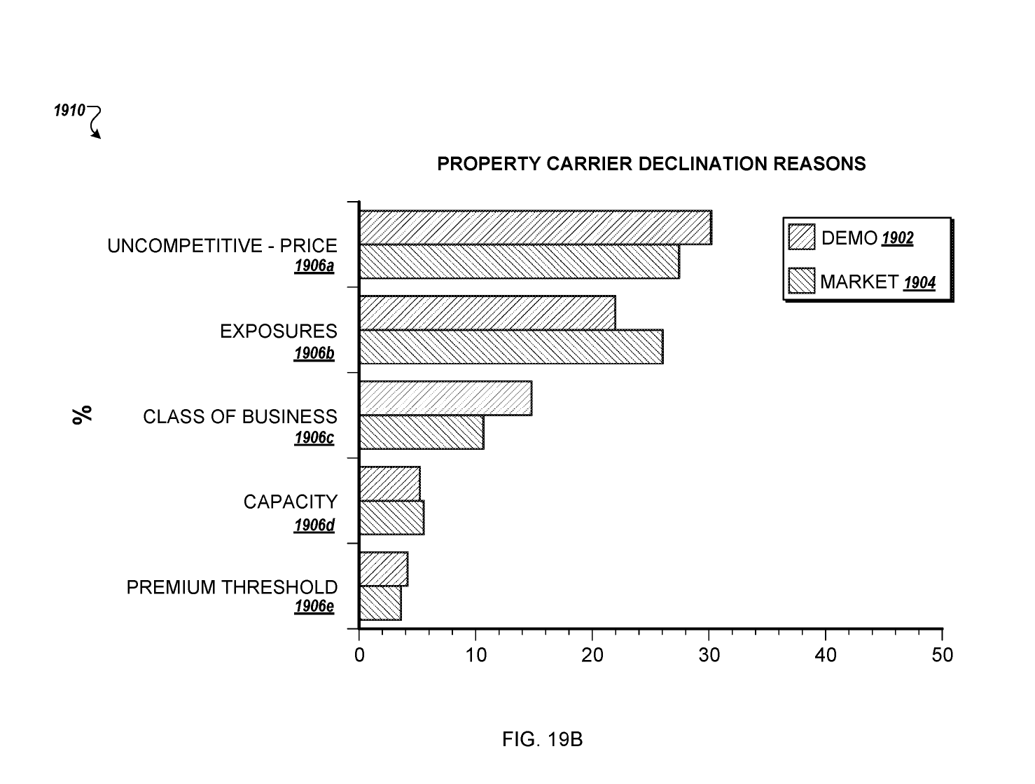

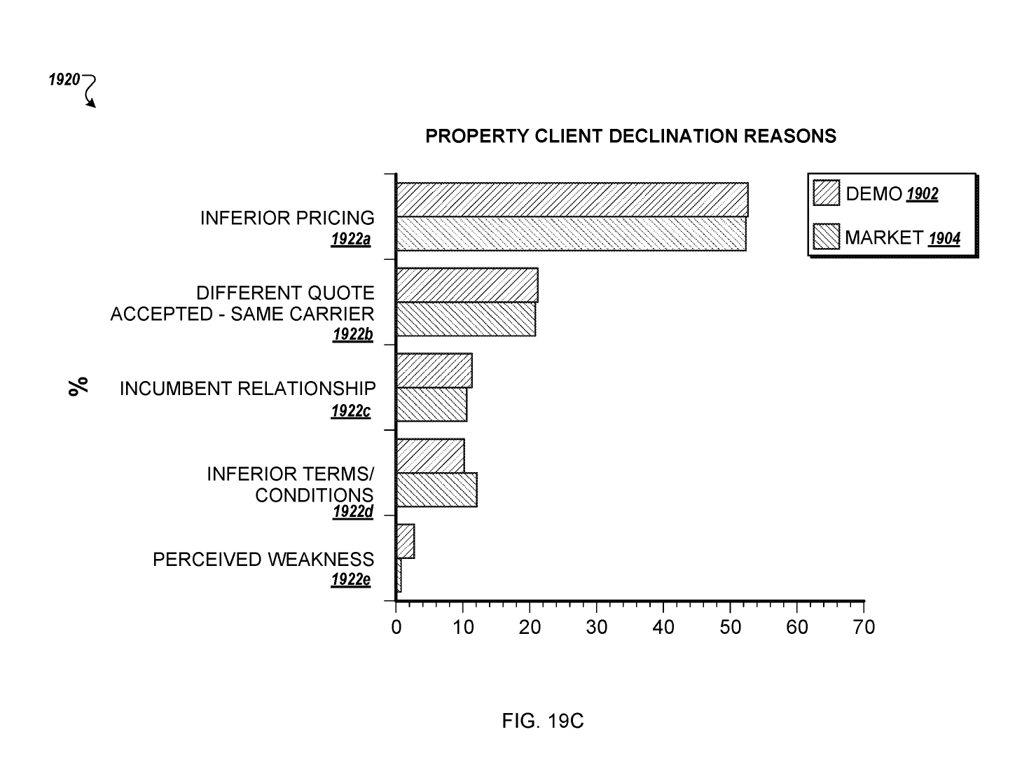

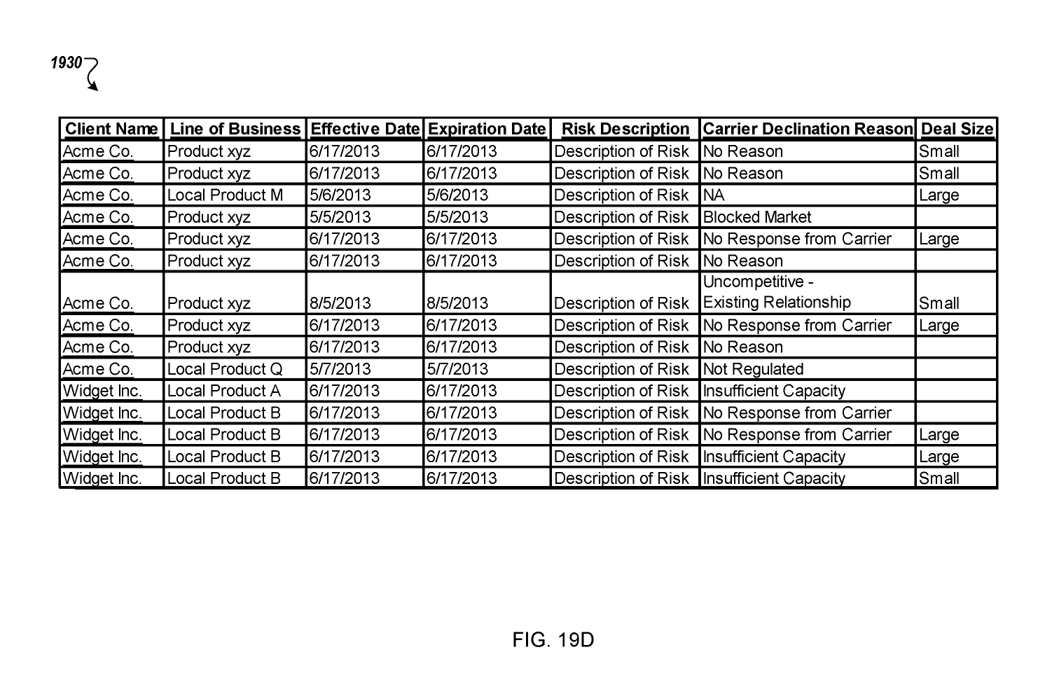

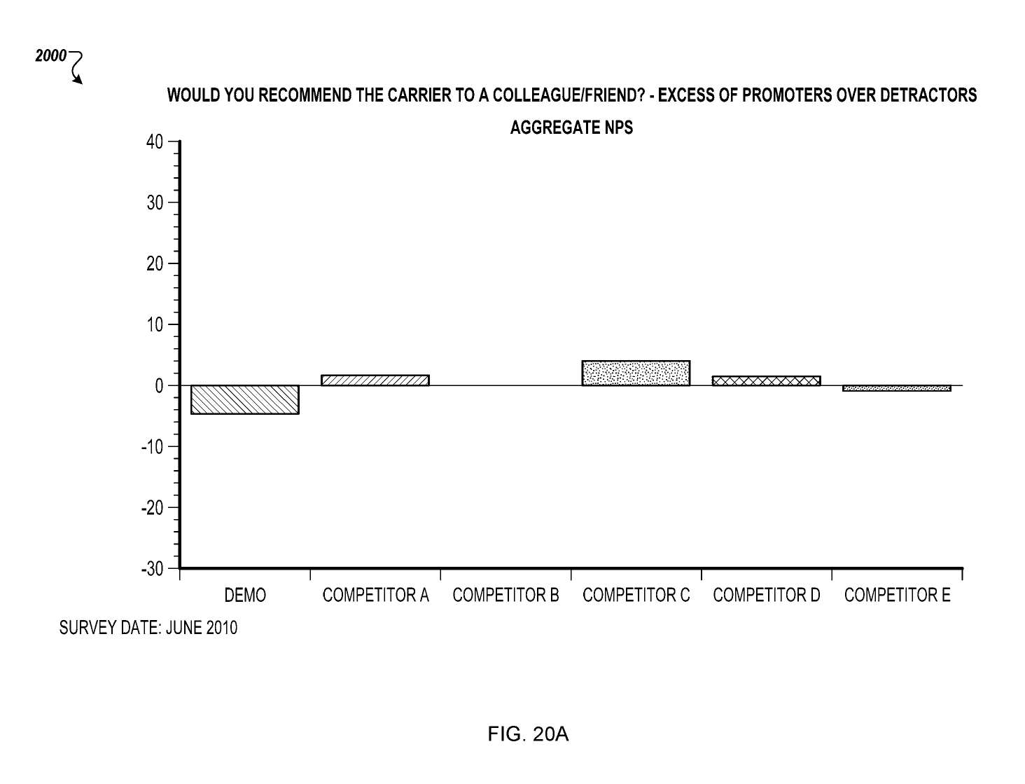

Turning to the “declination analysis” pane 107, a set of navigational controls 115 provides the carrier with the ability to review either carrier declination reasons (using a “carrier declinations” control 115a) or client declination reasons (using a “client declinations” control 115b). Carrier declination metrics are discussed in greater detail below, in relation to FIGS. 19A through 19D. For example, selection of the “carrier declinations” control 115a may cause presentation of a screenshot 1900 of FIG. 19A within the carrier dashboard 190. Further, the carrier declination metrics may be filtered using one or more filtering navigational controls 117. For example, upon selection of a “declinations by product” control 117e, the carrier may be presented with a screenshot 1910 of FIG. 19B. Similarly, selection of both the “client declinations” control 115b and the “declinations by product” control 117e may result in review of a screenshot 1920 of FIG. 19C. Other filters available via the declination analysis pane 107 include a “declinations by carrier appetite” control 117a, a “declinations by carrier division” control 117b, a “declinations by industry” control 117c, a “declinations by incumbency” control 117d, and a “declinations by deal size” control 117f. Filtering options are discussed in greater detail below in relation to FIGS. 19A through 19C.

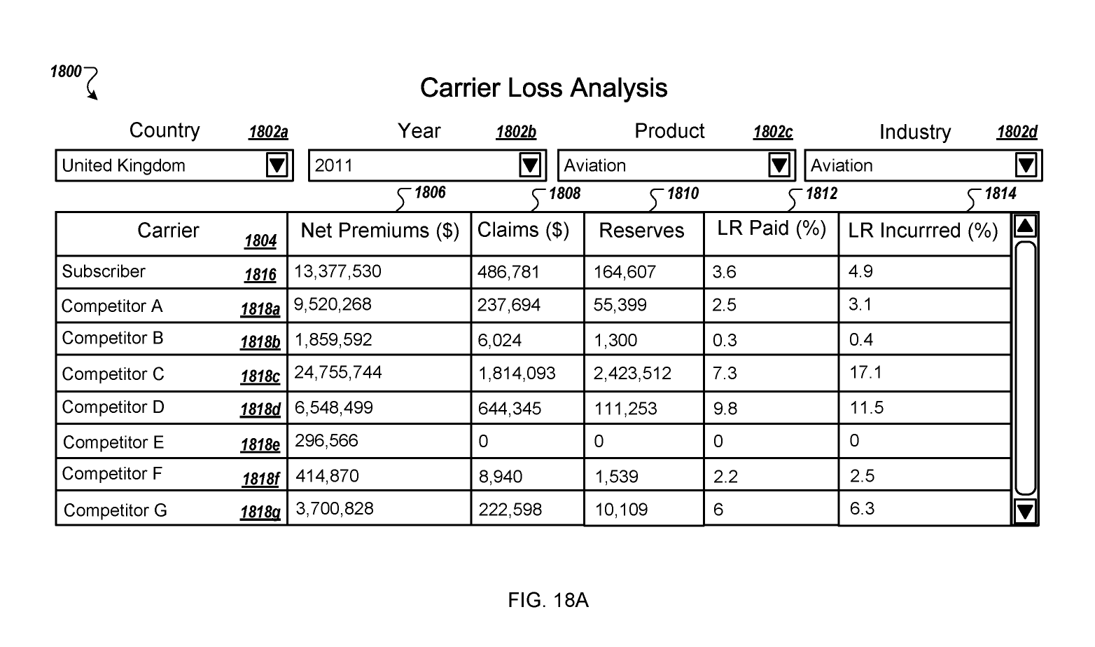

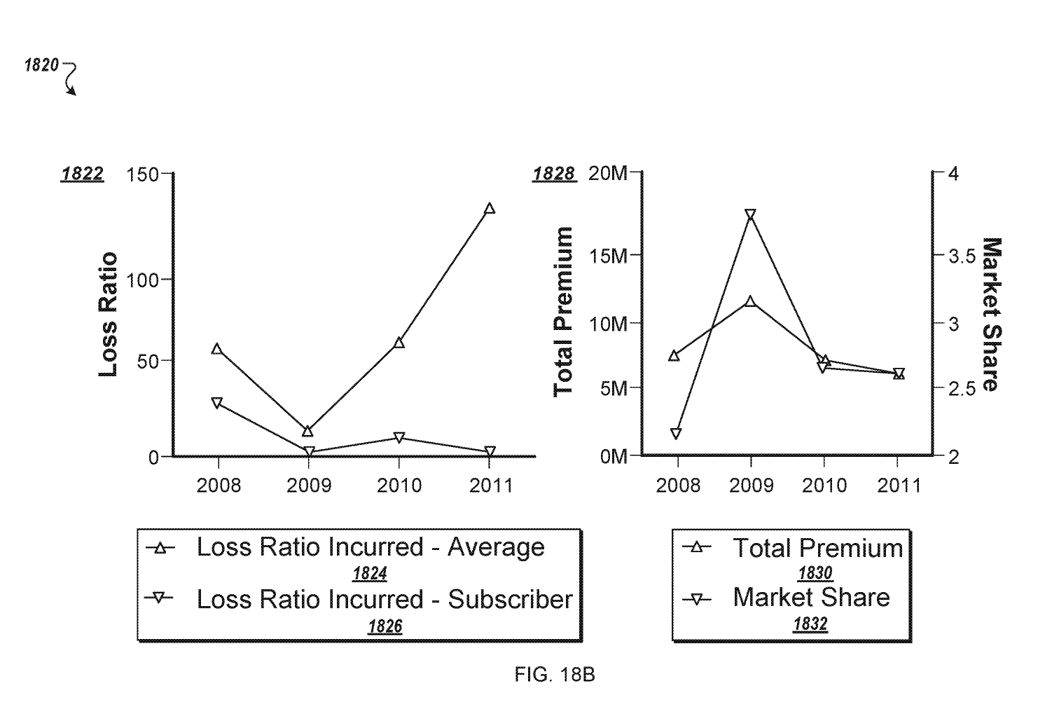

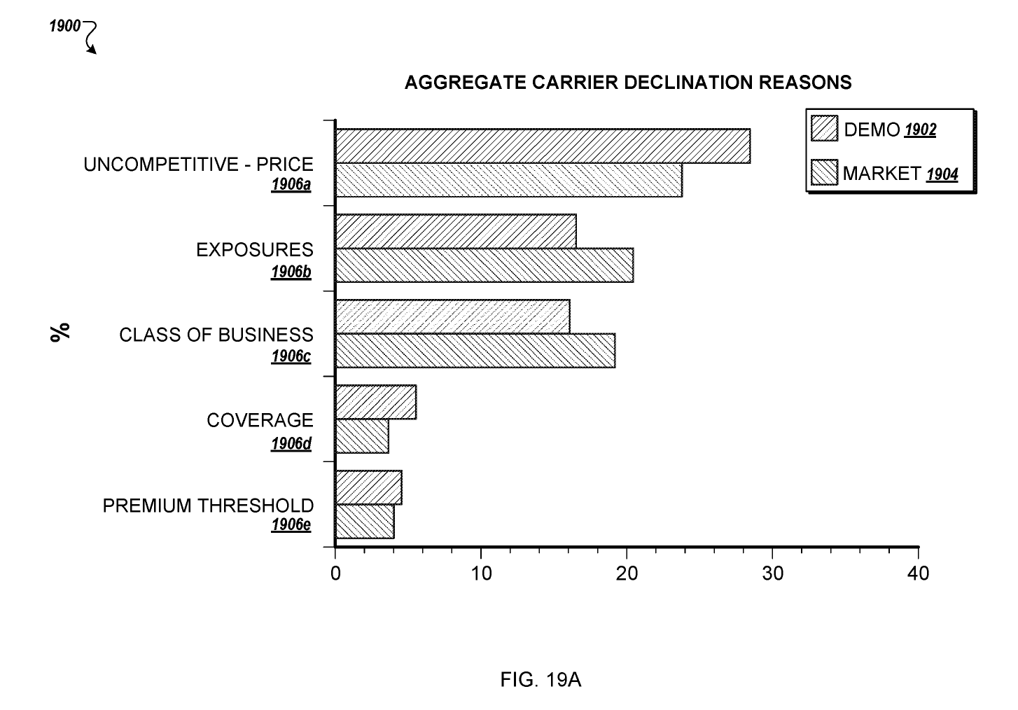

As shown in the “loss analysis” pane 109, a carrier may review losses incurred through individual accounts through a series of navigational controls 119. Upon selection of a “losses” control 119a, for example, the carrier may be presented with a display similar to a screenshot 1800 of FIG. 18A and/or a screenshot 1820 of FIG. 18B. Turning to FIG. 18A, the screenshot 1800 presents a table of records regarding carriers incurring losses in relation to premiums. Each record presents a carrier name 1804, net premiums amount 1806, claims amount 1808, reserves amount 1810, loss ratio paid 1812, and loss ratio incurred 1814. In some embodiments, a benchmarking component may be available, including a comparison of carrier loss metrics (e.g., loss ratio paid, loss ratio incurred) of the present carrier (subscriber 1816) and carrier loss metrics of peer competitors 1818. In some embodiments, selection of a particular field of the table in the screenshot 1800 activates presentation of a detailed view of record information.

As illustrated along the top of the screenshot 1800, a series of drop-down menus 1802 are available for filtering presentation of loss metrics. A “country” menu 1802a presents options for selection of a geographic region, similar to a “loss by geography” control 119d of FIG. 1F. A “year” menu 1802b enables the carrier to review loss data by calendar year. In other embodiments, the carrier may be presented the opportunity to select a date range (e.g., month, quarter, or customized span of dates, etc.). A “product” menu 1802c enables the carrier to review loss data by product line, similar to a “loss by product” control 119c of FIG. 1F. An “industry” menu 1802d enables the carrier to review loss data by client industry, similar to a “loss by industry” control 119d of FIG. 1F.

Further, the information may be illustrated in a graph presentation to identify trends in loss ratios over a period of time. Turning to FIG. 18B, a screenshot 1820 illustrates a loss ratio comparison graph 1822 of an average loss ratio 1824 and a subscriber loss ratio 1826 for a presented timeframe (e.g., years 2008 to 2011). The loss ratio comparison graph 1822 is illustrated next to a premium to market share comparison graph 1828, illustrating both a total premium 1830 for subscriber during a presented timeframe (e.g., years 2008 to 2011) as well as a market share 1832 for the subscriber during the timeframe.

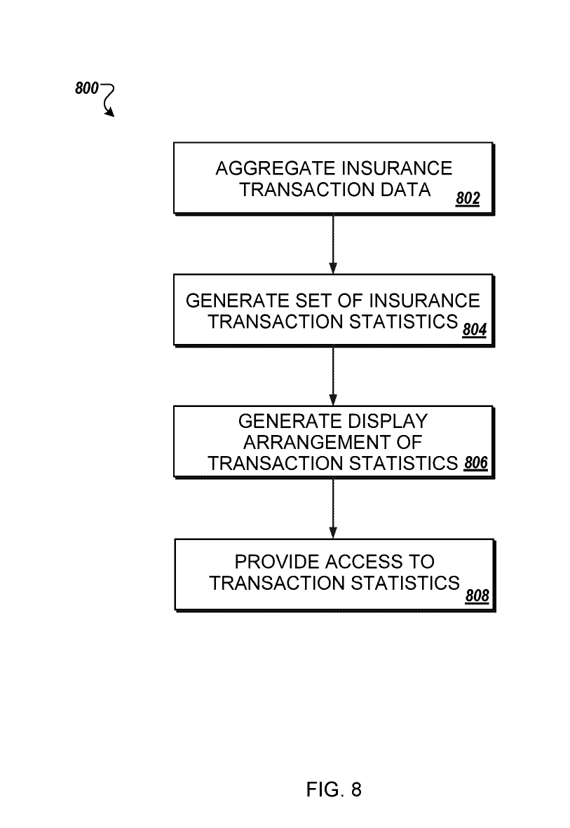

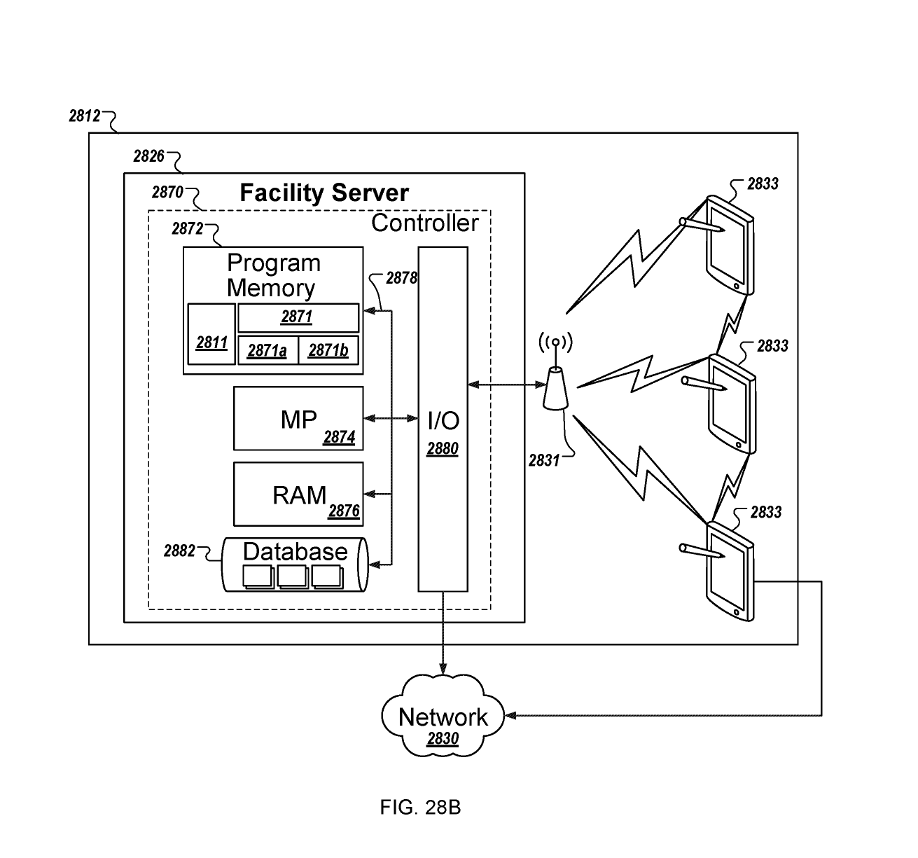

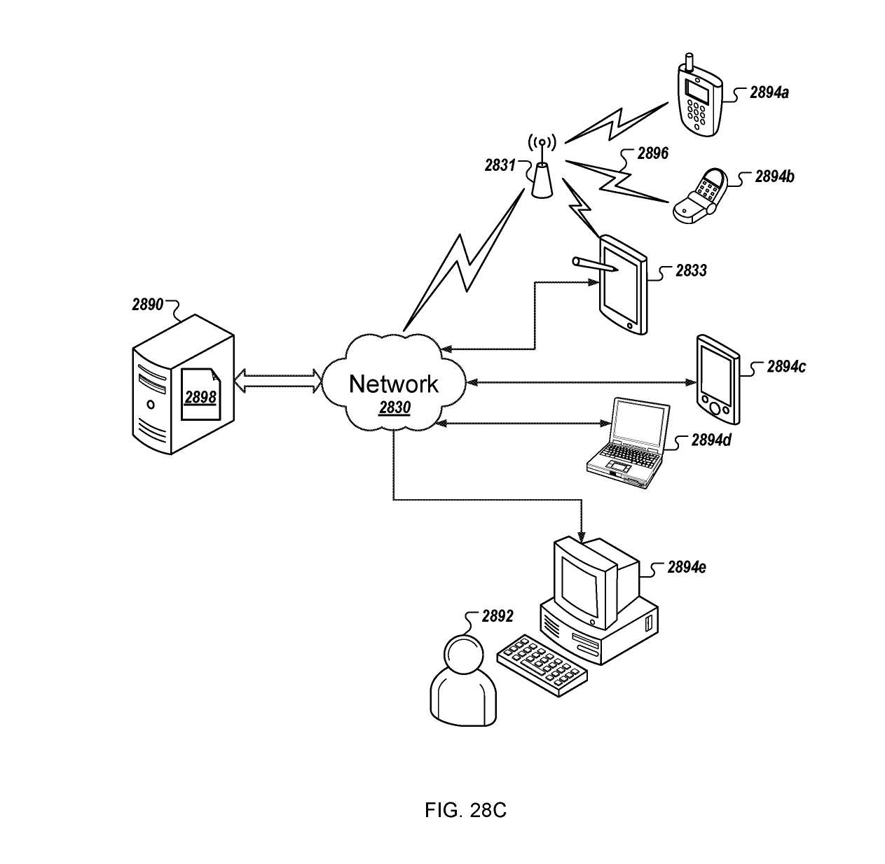

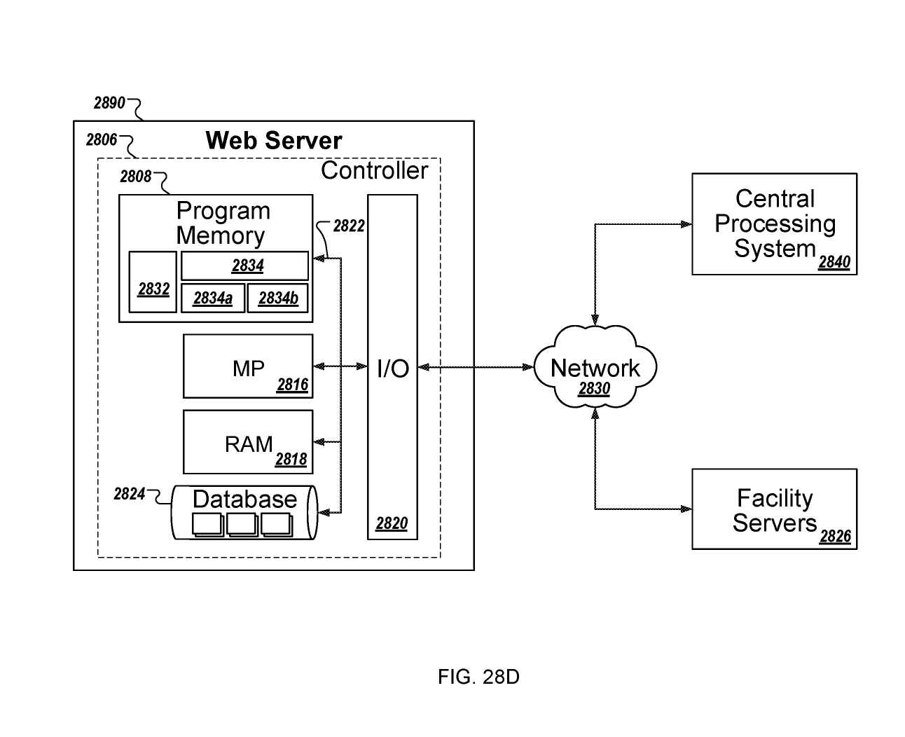

FIG. 8 illustrates a process flow diagram or flow chart of a method, routine, or process 800 that may be used to generate insurance policy transaction statistics according to an embodiment. A block 802 may access information from a number of broker computing devices that are communicatively coupled to a network and retrieve selected insurance transaction data from each of the number of computing devices. The insurance transaction data may be inputted or captured by a number of broker users at a number of broker computing devices remotely located from each other. Examples of broker computing devices and a network for connecting the broker computing devices are illustrated in FIGS. 28A-28D and are discussed further below. Block 802 may also store or archive the accessed information to an easily accessible data storage medium or device, such as a server, for further processing. The server may be one of a number of broker computing devices communicatively coupled to the network. The block 802 may aggregate data values for particular selected parameters across all the data collected (e.g., across the number of broker computing devices). A block 804 may generate a set of insurance policy transaction statistics (or simply insurance transaction statistics) based on the accessed insurance transaction data of block 802. The generation process of block 804 may involve or include an analysis or calculation of values based on the aggregated data of block 802. A block 806 may generate a display of one or more of the set of insurance policy transaction statistics for display on a display device, such as a broker computing device. Block 806 may involve or include generating a display arrangement of a set of insurance policy statistics. Generally, the display arrangement may include the set of insurance policy statistics and a layout of the set of insurance policy statistics. The layout may include display positions for each of the set of insurance policy statistics or relational data to indicate how each of the set of insurance policy statistics should be positioned relative to one another. The display arrangement may be generated based on a set of broker parameters that are inputted into a computing system implementing the process of FIG. 8. The broker parameters may be based on a particular workflow designed by the broker company. In one embodiment, the broker parameters may be based on an aggregate study of client relationships. The study may produce general or average client interaction schedules. For example, a client interaction schedule may include specific events associated with clients such as client sales pitching, creation of insurance policy structure, managing renewals, etc. along with a chronological sequence for the events and sub-events within the events. Each element of the client interaction schedule may be used to define the set of broker parameters, where the broker parameters may be used to generate one or both of the set of policy transaction statistics of the block 804 or the display arrangement of insurance transaction statistics of the block 806.

In some embodiments, the system may be used to selectively provide access to the insurance transaction statistics and/or display arrangements of the one or more sets of insurance transaction statistics (block 808). This may involve any authentication or authorization needed to determine a user's level of subscription. The system may also include transmission of the display arrangement (e.g., an image of the display arrangement or instructions for displaying the arrangement) (block 808).

The data aggregation (block 802) from a number of broker computing devices may involve a timed collection of selected data from each broker computing device to a central data store or database. The aggregation may be performed in response to an ad hoc request for one or more insurance policy transaction statistics. In particular, an ad hoc request to generate an insurance policy transaction statistic may be distinguished from statistics that are generated by a periodic reporting function, which may be initiated at fixed intervals (e.g., at the end of financial reporting periods). Further, the aggregation may be performed such that the generated insurance policy transaction statistic is based on transaction data that is available (e.g., inputted into one or more broker computing devices connected to the network) contemporaneously during a period of the request. In some embodiments, block 802 may be implemented by aggregating transaction data that is released, stored, or otherwise made available in response to the request. In this manner the aggregation may be called “real time” aggregation as the insurance transaction statistic is based on any data inputted into the system during the time of the request. Real time aggregation may be distinguished from archival aggregation of transaction data which may occur or may be performed only at fixed intervals (e.g., reporting periods). For example, archival aggregation may occur in conjunction with the periodic reporting function, where the reporting function and aggregation occur at fixed periods. In aggregating for a periodic reporting function, data that may be inputted after a cutoff period may not be included in the aggregation and/or report generation. More particularly, archival aggregation may only aggregate transaction data that has been released on a fixed schedule and may not include transaction data entered contemporaneously with an ad hoc request for generating a statistic. In some embodiments, selection of data may occur at a server that acts on the central store or database after non-filtered data from the broker computing devices is accessed and transferred to the database. Generally, the data from the broker computers may be inputted primarily by insurance brokers during the transaction of each insurance policy trade, from inception to binding (or other result, such as no response or lack of response). The majority of information within the global risk insight platform (GRIP) described herein may be broker data and/or client data. However, some data may be provided by carriers such as information on policy quotes and reasons carriers declined quotes.

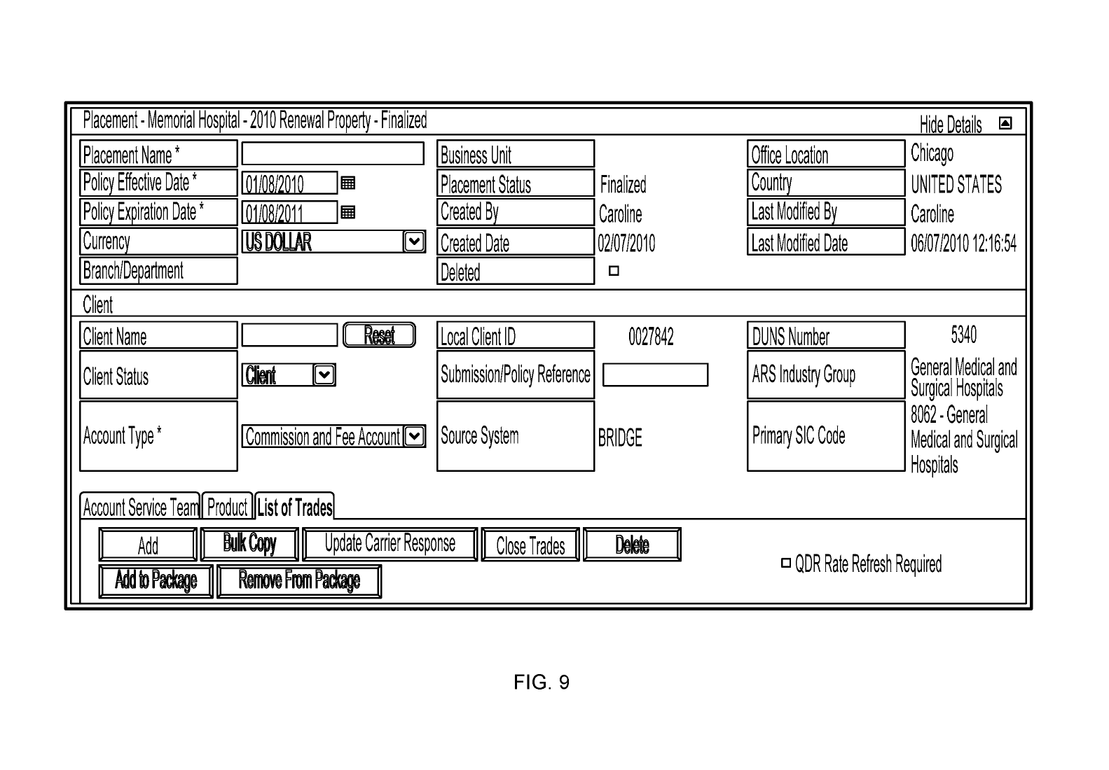

Table 1 lists a set of parameters that may be collected from broker computers as part of a data aggregation process. The parameters may include at least insurance policy placement name, policy effective date/start date, policy expiration date, business unit, placement status, currency, office location, country, client name, client status, account type, client ID, source system, Data Universal Numbering System (DUNS) number, ARS industry group, and primary Standard Industrial Classification (SIC) code. The list of parameters may describe a minimum list of insurance transaction data required to produce a useful set of insurance transaction statistics. FIG. 9 illustrates a screen adapted to receive the transaction data through a set of input fields.

TABLE 1

Insurance policy placement name
policy effective date/start date
policy expiration date
Business unit
placement status
Currency
office location
Country
client name
client status
account type
client ID
source system
DUNS number
ARS industry group
primary SIC code
Policy Premium
Client Declination Reasons
Carrier Rejection Reasons

Generally, the insurance transaction data may be collected at three key points during the process of placing an insurance policy: first, when a broker informs carriers about a client policy opportunity (known as a “trade” or a “submission”); second, when the chosen carriers provide a response to a policy proposal (“quote” or “decline”); and third, when the client decides which carrier option it wants to accept (a “hit”, a “win” or a “bind”). Opinion data may be collected using responses to questionnaires. The information may be collected by brokers and directly inputted by them into a database at the time of collection. A significant proportion of global premiums (corresponding to a large pool of insurance policy transaction data from a number of countries) brokered may be captured in the system. Moreover, the policies may cover a broad range of client industries and insurance products.

In block 802 of FIG. 8, the parameter values for each policy generated or managed by a broker via the broker computing device may be aggregated over multiple levels of increasing group scope (such as inter-company defined divisions) and geographic area. The data may be aggregated first locally and then regionally, and finally companywide, which may be on an international scale. The data may then be indexed and organized as described below to provide unique views of the data for company brokers, regardless of which computer contributed the information for the view. A benefit of aggregating an overall data set over such a sample is that the larger the presence of an insurance broker, the larger the accuracy of a data parameter. Even previously seldom used transaction statistics may become more useful because the data is now aggregated over a larger number of computers and consequently, over a larger number of data points.

The block 802 may also perform a data anonymizing process. Generally, anonymizing data may involve manipulating the data so that no individual pricing data or individual identity data can be retrieved from the data. All data available may be retrospective. Prior to being made available from the computer system, the data may undergo a “cleansing” or anonymizing process to ensure that data made available meets established standards. One process for anonymizing the data may involve commingling newly released data with a data pool made up of significantly older data points, themselves anonymized and aggregated. This pooling process may be used to help prevent possible facilitation of any collusive practices, whether in theory or in practice, through the introduction of the data introduced quarterly.

The block 804 may generate insurance policy transaction statistics that include at least an aggregate value of insurance policy premiums for insurance policies brokered by the insurance broker company. As discussed above, the insurance policy transaction statistic may be generated based on transaction data that is available in any one of the broker computing devices at the time of a request to generate the statistic. In some embodiments, the generation of the statistic may be continuous or ongoing. For example, as new data is being inputted into any one of the broker computing devices, the system may aggregate new inputs and update or regenerate a statistic. One insurance policy premium statistic may be generated by summing all collected policy premiums from the aggregated policy transaction data. It should be noted that calculations may be performed to determine specific aggregated premium values for different stages of policy transactions (e.g., for policies that are finalized or are at different stages of the transaction process). The block 804 may also anonymize any statistics generated so that no individual trade pricing or individual identity information can be extracted from the insurance transaction statistics.

The system may display (block 806) the combinations of insurance policy statistics described herein on a broker computing device that did not contribute all the insurance transaction data used to produce the statistic. In one embodiment, at least one broker computing device may display the described insurance transaction statistic combinations and arrangements where the broker computing device may not have contributed any transaction data during the aggregation process of block 802. As discussed above, it is important to foster communication of valuable data for assisting all broker members of a brokerage company to provide better customer service and to increase sales of insurance policies.

As discussed above, the system may generate (block 804) a number of different sets of insurance transaction statistics (a set including one or more elements). These sets of insurance transaction statistics may be generated based on the broker parameters and further combined and arranged in particular unique displays on a broker computing device.

A first set or combination of insurance policy transaction statistics that may be generated include a set of aggregate insurance premiums for a first period. The aggregate insurance premiums may be indexed or categorized by a region for the first period. The aggregate insurance premiums may be further indexed or categorized by insurance industry and/or insurance product for the first period. The first period may be a current period, which may be a current business or calendar quarter or annual period, or may be a user determined period. In some embodiments, an aggregate value may include a sum of all collected or accessed values for a selected parameter. The aggregate value may include a sum of all values collected when a request to aggregate and/or generate a statistic is received. In some embodiments, the aggregate value may be constantly calculated or updated as new information is being input into one or more of the broker computing devices that provides transaction data to the aggregation process. Thus, in one embodiment, the aggregate insurance premiums of the first set may be a summation of the total premiums for each of a number of policies collected by the described system.

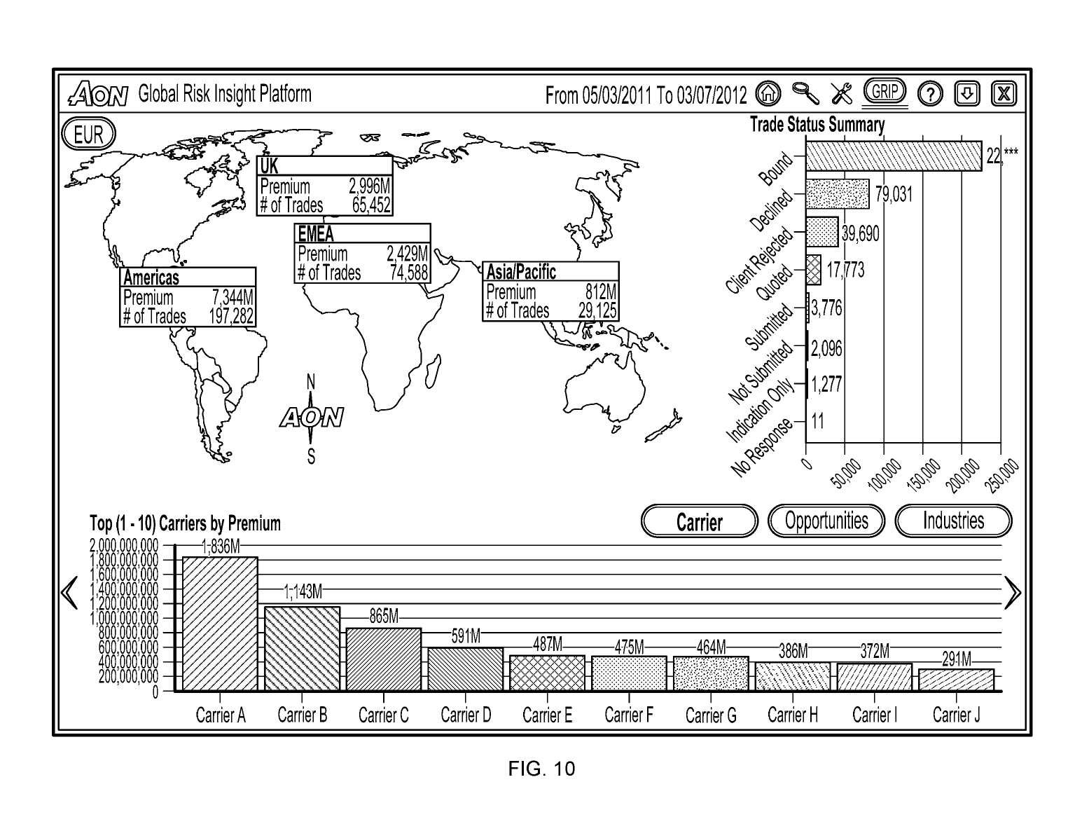

Another insurance transaction statistic that may be combined with the aggregate insurance premiums may be aggregate insurance policy trade counts that are indexed by the regions over the first period. Generally, a trade count may include submitted, quoted, bound, indication only, and/or response trades. The trade count may not, in some embodiments, include declined or rejected trades. In one embodiment, a display arrangement may be generated and displayed showing the trade counts with (e.g., adjacent to) corresponding aggregate insurance policy premium amounts. The combinations may be displayed, for example, with the corresponding aggregate insurance policy premiums by region when the aggregate insurance premiums are also displayed by region. FIG. 10 illustrates a display embodiment showing a set of aggregate insurance premiums mapped by geographic region with corresponding trade counts. For example, FIG. 10 illustrates that an Americas region has an aggregate insurance policy premium amount of 7,344 million dollars with a corresponding total trade count of 197,282 policies.

An additional insurance transaction statistic that may be combined with the first set of transaction statistics may be a set of insurance policy trade status parameters. FIG. 10 illustrates that a combination of insurance policy trade statistics may include a set of insurance policy trade status parameters. The set of insurance policy trade status parameters may include an indication of the current aggregate amounts of insurance policies in a set of categories that include submitted policies, bound policies, client rejected transactions, carrier declined transactions, quoted transactions, and no response (or lack of response) transactions. This section may provide a broker an immediate understanding of the general state of a broker's company regionally and internationally.

Insurance premiums for insurance policies may be aggregated based on the insurance carriers for which the policies were placed. Thus, for example, a particular carrier may have a corresponding aggregate premium statistic that indicates an aggregate amount of insurance premiums that were placed with that carrier (by the broker company) for the first period. Accordingly, a second set of insurance transaction statistics may include at least this set of aggregate premium parameters that are categorized by insurance carriers.

FIG. 10 illustrates an exemplary display arrangement that maps aggregate insurance premiums for each of a set of insurance carriers. The set of insurance carriers may be a subset of a total set of insurance carriers for which transaction data exists. The subset of insurance carriers may be determined by a system parameter or by a user selection. The subset of insurance carriers may be determined based on a size of the premiums (e.g., top 20 premium carriers). Further, the order of display of the insurance carriers may be ordered based on a size of the aggregate premium amount associated with each carrier (e.g., highest to lowest or lowest to highest).

A further addition to the second set of insurance transaction statistics may include aggregate insurance premiums categorized by insurance industry and/or by insurance products over a first period. FIG. 11 illustrates an embodiment displaying an arrangement of the data or information combination for a set of product categories having corresponding aggregate insurance premiums associated with each product category. FIG. 11 orders the insurance product categories by premium amounts, the largest premium amount products listed first. FIG. 11 also illustrates displaying an arrangement of information for a set of industry categories having corresponding aggregate insurance premiums associated with each industry. In some embodiments, the aggregate insurance premiums may be based on multiple regions (e.g., local city, region, country, company-wide/international). In other embodiments, the display arrangement may include functions to display an additional arrangement of information including sub-products and/or sub-industries. For example, FIG. 11 may display a breakdown of premiums based on sub-products and/or sub-industries when a pointer hovers over a main product or industry category.

FIG. 11 orders the insurance industry categories by premium amounts (based on designated geographic area), where the industries with the largest premium amounts are listed first. The number of industries and products displayed in one screen such as FIG. 11 may only show a subset of a total set of industries or products, respectively. In one embodiment, the display may provide a function that enables additional categories to be displayed, such as a scroll function. FIG. 11 displays the products and industries adjacent each other and parallel each other with a sliding scroll function in which the order of both the product category and top industries category is based on premium amounts per category. The adjacent and parallel arrangement of the products and industries allows a broker to quickly assess strengths of a broker company in insurance policy placement with respect to product and industry groups.

Using the displayed arrangement of information, a broker may be able to immediately determine amounts of premium placed for each product and client industry to support the broker's assertions of expertise in those products and industries during for example, a scheduled sales pitch. Generally, this is a common preliminary inquiry during initial meetings with potential clients. Accordingly, the speed at which this data can be communicated to a broker for handling a potential client is critical and the described information arrangement may guide the broker accordingly during a presentation.

FIG. 12 illustrates a third combination of insurance transaction statistics that include a premium amount of aggregate bound policies associated with each of a set of insurance carriers and an aggregate trade count statistic corresponding to the aggregate bound policies for each of the insurance carriers. The aggregate bound premium and trade count statistic may be indexed (meaning categorized or filtered) based on insurance product, industry, or both product and industry. As discussed above, a trade count may include submitted, quoted, bound, indication only, and response trades. The premium amount of the third combination or third set of transaction statistics may include only bound transactions. Bound transactions may be insurance policies that have been submitted, quoted for by an insurance carrier, and accepted by a client. The set of insurance carriers displayed in a particular screen may be a subset of a total set of insurance carriers in which associated premium and trade count data exists. The subset of insurance carriers may be determined by a user selection of the set. Alternatively, the subset may default to a top set of insurance carriers based on aggregate premium for bound polices, trade count for the bound policies, or both (e.g., based on a ratio of the two).

FIG. 12 further illustrates a particular graphical arrangement of the combination of transaction statistics as a chart in which the subset of insurance carriers for the data are displayed along a horizontal axis. A first vertical axis displays a scale indicating an amount of bound premium. A second vertical axis displays a scale indicating a number of trades. The arrangement of the chart allows an aggregate policy premium amount for bound trades to be displayed against an indication of a trade count for the number of bound policies corresponding with the aggregate bound premiums for each insurance carrier for a period of time. This combination or arrangement of transaction statistics may allow an insurance broker to quickly assess an insurance carrier's appetite for specific types of transactions (e.g., based on premium amount). For example, where a carrier's aggregate bound premium number is high relative to a trade count, the carrier may be focused on high premium deals. The opposite may be true for carriers where the bound premium number is low relative to the carrier's bound trade count.

In some embodiments, the vertical scales (e.g., scale ranges or scale factors) for aggregate bound premium amounts and bound trade counts may be adjusted based on a number of parameters. For example, the scales may be normalized so that aggregate bound premiums and bound trade counts for each of the displayed insurance carriers can be displayed within one screen for comparison. In some embodiments, an average ratio between aggregated bound premium amount and bound trade count may be calculated for each of the displayed insurance carriers. Another advantage of the display arrangement of FIG. 12 is that an insurance broker may effectively compare the efficiencies of (as determined by the bound premium to bound trade count numbers) each of the set of displayed insurance carriers. This may be helpful in discussions with both carriers and policy clients.

The third combination of insurance transaction statistics may provide advantages in a number of situations. For example, the combination may be advantageous during insurance renewal strategy formulation. The combination may indicate which carriers have recently been most competitive and recently have the strongest appetite for a client's insurance risk. The information combination and display arrangement may help an insurance broker facilitate client decisions. In preparing for an upcoming insurance policy renewal between a client and an existing incumbent insurance carrier, the display arrangement may be generated based on the client's primary industry as a filter. The results may indicate that the current insurance carrier (the incumbent) is not one of the top five carriers by premium for the client's industry, which may prompt advising the client to reconsider renewing with the incumbent. The display arrangement may also provide an insight into a carrier's preference for small or large premiums (e.g., ratio of trades to premium) to further guide the client as to which markets (e.g., which insurance carriers) might be the more suitable for the estimated premium for the client.

The information combination and display arrangement may help in another renewal situation. Based on client feedback, the client may prefer to stay with the incumbent insurance carrier for the renewal period. The client may be expecting a premium reduction at renewal. The information combination and display arrangement may indicate that the rates for the client's insurance product are flat and the incumbent insurance carrier appears to have a strong appetite for the insurance product. The client may then make an informed decision for the renewal period based on the most recent data.

A fourth combination of insurance transaction statistics include submit-to-quote ratios that are aggregated based on policy transactions associated with each of a set of insurance carriers. A submit-to-quote ratio is a ratio of a number of policy submissions that are quoted over a total number of policy submissions. Generally, a submission is a proposed policy that is submitted to a carrier for a price quotation. A quoted submission is a proposed or submitted policy in which an insurance carrier submits a bid (quote or price). Often times, not all submissions may be quoted or bid for, and thus, the submit-to-quote ratios are usually less than one.

FIG. 13 illustrates an embodiment of a displayed arrangement of insurance transaction statistics that include submit-to-quote ratios associated with each of a set of insurance carriers. The set of insurance carriers displayed in the screen of FIG. 13 may be a subset of a total set of insurance carriers having associated submit-to-quote statistics. The subset may be determined by a user selection of the set. Alternatively, the subset may default to a set of top insurance carriers based on submit-to-quote values (e.g., highest subset or lowest subset). In one embodiment, the set of displayed insurance carriers may be placed in order according to the value of their associated submit-to-quote ratios. FIG. 13 further illustrates that a menu function may be activated to filter the subset of displayed insurance carriers by product and/or industry. Thus the arrangement of statistics can be filtered/indexed/categorized based on insurance product, insurance industry, or both insurance product and insurance industry.

FIG. 13 further illustrates that an additional insurance transaction statistic to the fourth combination of the submit-to-quote transaction statistics may be a parameter indicating a percentage of quoted submissions attributed to a deductible amount and a limit amount for the quoted policies. FIG. 13 illustrates a table as part of a display arrangement that has deductible ranges disposed along a horizontal axis and limit ranges disposed along a vertical axis. Each entry in the table has a corresponding deductible and limit range. An entry in the table indicates a percentage of a total number of quoted submissions for a particular deductible and limit range. In one embodiment, the total number of quoted submissions may be restricted to the aggregate number of quoted submissions for the subset of displayed insurance carriers. Thus, for example, in FIG. 13, the 100 percent value of quoted submissions may refer to the total quoted submissions for the five insurance carriers listed in the display.

The combination of statistics provides insurance brokers with the advantage of being able to identify which markets may currently be quoting for placements with certain limit and deductible characteristics. Further, the arrangement of the statistics may allow brokers to efficiently determine which specific carriers have been quoting for a client in a given industry or product group. This may be helpful in the following situations. A first situation is responsive marketing. An incumbent insurance carrier may have promised a flat renewal for a client. At the eleventh hour, the incumbent insurance carrier may quote a double-digit increase. An insurance broker needs to be able to react immediately to determine which carriers may be most likely to quote the client's program so that a last-minute submission may be made. The information combination and corresponding display arrangement may allow a broker to immediately determine that one or more markets (e.g., insurance provider) have a high submit-to-quote ratio for the type of program the client needs and a submission may be directed to each market (e.g., insurance provider). In a second situation called “carrier participation” a client may be interested in alternative insurance policy structures. The client may, in this case, want to know which insurance carriers are quoting on certain program structures to best align their program with the right carriers. The display arrangement may allow a broker to immediately identify the optimal limit and deductible level for each of its carriers. In a third situation of program design, a client may inquire about appropriateness of their limit and deductible for an existing policy. The information combination and display arrangement may allow the broker to determine where the client fits into the mix of limits and deductible ranges for a current period and advise the client appropriately.

A fifth set or combination of transaction statistics and a display arrangement of the transaction statistics illustrates carrier declined submissions and declination reasons for those declined submissions. Generally, the GRIP system provides overviews from both the carrier and client perspective on the reasons why insurance proposals have been declined. The broker may generally input this information into a broker computer at the time that either the carrier or the client declines a quote, and is selected from one of twenty standardized declination reasons. The aggregate declinations may be categorized by insurance product and insurance industry. In some embodiments, when filtering by one or both of insurance product and insurance industry, only the policies for the particular insurance product and/or insurance industry may be examined for declination reasons. Thus, the percentages of the declination reasons may be only a portion of total declination reasons for all declined policies or transactions.

FIG. 14 illustrates an embodiment of a display arrangement involving the fifth set of transaction statistics. The declination policies used to determine percentages may be filtered by an insurance product (e.g., property) and an industry (e.g., manufacturing). In the arrangement of FIG. 14, a first chart lists a set of declination reasons and a percentage breakdown for each declination reason for all carriers specific to the selected product and industry. In the embodiment illustrated by FIG. 14, carrier declination reasons may include uncompetitive price, exposure limit issues, no response (or lack of response) from carrier, other declination reason, and insufficient underwriting data. FIG. 14 also shows at the top of the chart that the percentage of overall declination reasons attributed to the product and industry is 91 percent. In some embodiments, when no industry and no product group are selected, the number of carrier declined submissions may represent an aggregate of total declined submissions across all carriers (i.e., 100 percent).

The information or data arrangement of FIG. 14 illustrates that the number of carrier declined submissions may be filtered for a particular carrier and displayed adjacent to the declination percentages for all carriers (of a particular industry and/or product, if selected). In particular, FIG. 14 illustrates a display embodiment showing an arrangement of transaction statistics where a chart of overall carrier declination reasons is arranged adjacent to a chart of declination reasons for a specific or selected carrier. The carrier may be selected or targeted for analysis. FIG. 14 further includes a peer chart in which declination reasons can be aggregated for a select subset of carriers. FIG. 14 illustrates that at least a second peer chart may be disposed adjacent the first peer chart, the selected carrier chart, and the all carriers declination chart. In one embodiment, the subset of carriers for either the Peer 1 or Peer 2 group may be selected based on comparable peer carriers. The comparable peers may be determined based on a number of pre-programmed parameters such as, but not limited to, insurance industry and product, aggregate premiums, deductible and/or limit amounts of polices placed, etc. In one embodiment, Peer 1 and Peer 2 may be determined by choosing carriers that rank above and below the subject or selected carrier in terms of total rejection reasons. If the subject carrier is first in terms of premium volume ranking, then the next two carriers may be chosen as peers. If the subject carrier is the last in terms of premium volume ranking, then the preceding two carriers may be chosen.

The combination of statistics may provide insurance brokers with an advantage of being able to advise a client towards insurance carriers (markets) that may eventually be more receptive to their policy structures for specific industry and product groups. For example, if an incumbent carrier has a history of quote rejection for inferior pricing, a broker may consult the display of declination reasons for the incumbent carrier in relation to the overall carrier and peer carrier information and may advise the client to market a submission for an upcoming renewal accordingly. This could provide the client with premium savings.

The combination of carrier declination reasons and corresponding display arrangements may also have positive impacts on the following broker situations. A first situation may involve broker coaching of insurance carriers. In this situation a broker may use the aggregated information to discuss insurance carrier performance feedback. For example, an insurance carrier may meet with a broker company to introduce a new product. The underwriter or insurance carrier may ask for performance feedback from the broker. The broker may be able to use the display and information combination to demonstrate that the primary reason clients may by rejecting the carrier's quotes is inferior pricing. One may specifically identify that this carrier loses on pricing some percentage (e.g., 55%) of the time, but the carrier's peers lose on pricing less frequently (e.g., only about 30%).

In a second situation, a broker can use the information set or display arrangement of the described system to advise a client for an upcoming renewal. A broker may plan to approach three markets (insurance carriers) with a high risk for which it may be difficult to solicit bids. The client may want to know the rejection behavior of the three markets. Using the described display arrangement, the client may be advised of the top five reasons each of the carriers have rejected quotes as well as how they may match up against their peers.

A third situation may involve public perception of an insurance carrier. For example, a carrier may be under public financial pressure and clients may want to know how other insurance buyers perceive the carrier as a viable market. A broker can use the display arrangement of Client Rejection Reasons to determine why clients have declined to bind (or accept contracts) with that market (insurance carrier).

A sixth insurance transaction statistic set may include percent change in pricing and policy components for insurance policy renewals based on real time aggregated transaction data. The sixth set may show a rate of change or a percentage change in premium pricing for corresponding periods from a year ago. In other words, the rate change of a displayed quarter may be a percent change in the difference in a price value (e.g., a premium value) from the most recent quarter (e.g., second quarter of 2010) to the corresponding quarter from a year prior (e.g., second quarter 2009). FIG. 15A illustrates a display embodiment of renewal pricing trends for five previous quarters, Q4 2010, Q1 2011, Q2 2011, Q3 2011, Q4 2011. FIG. 15A illustrates the data as a bar graph with quarterly periods on a horizontal axis and percentage change of aggregate premium amounts on a vertical axis. The aggregate premiums may be filtered by insurance product and industry groups. Thus, for example, the percentage change in premiums may be specific to insurance policy contracts placed for a selected product and/or a selected industry.

In some embodiments, the sixth insurance transaction statistic or any of the insurance statistics described herein may be generated based on real time pricing information. For example, as transaction details (e.g., of policy premiums) are inputted into a broker computer for a particular recent transaction, that data may be tagged for more immediate aggregation and/or continual recalculation (or generation) of the sixth statistic (or any of the other statistics described herein). In some embodiments, real time aggregation, as used herein, may include a release of the data values of the selected parameter(s) for access by an aggregation function immediately after the completed policy transaction has been entered into the computing system. In some embodiments, the request for the statistic may trigger a release of the data values for aggregation. The release of the data values may involve allowing access to the selected parameter values (e.g., by the aggregation function) for generation of insurance statistics. Releasing data values as used herein may involve storing the data values in a manner that makes the data values available or accessible to the aggregation function. In some embodiments, real time aggregation may include initiation of a function to transmit and/or collect data values of the selected parameter(s) immediately after a completed policy transaction has been entered into a system. In some embodiments, real time aggregation may include a function to access/aggregate data values of the selected parameter(s) that are released, stored, or otherwise made available in response to a request to generate insurance statistics. In any case, while a first process of aggregating insurance transaction data described above is made on a quarterly basis, real time aggregation may involve aggregation of the values of selected parameters before a quarterly period is finished. In some embodiments, the real-time data may form the basis of a continual extrapolation of premium rate data to indicate predicted values of premium rates for the current quarter (or beyond the current quarter).

The generation of real time statistics may be a costly function in terms of computing power and bandwidth (e.g., continually transmitting transaction data over a network and executing functions to receive and process the data) and thus, in some embodiments, only one or a few parameters may be selected for real time, continuous aggregation and statistic generation. In some embodiments, the selected parameters for real time aggregation may be determined based on a legal status parameter associated with an access location or with a user identity. Alternatively, the display of any insurance statistics based on any parameters of real time aggregation may be based on the legal status parameter. Generally, the legal status parameter (as used herein) may be a parameter based on a local or regional law dictating what type of policy or transaction data may be used or displayed to certain entities. In some embodiments, premium pricing may be the selected parameter of focus. The insurance transaction statistic may involve a forecasted quarter that may represent a current quarter that is not yet complete or finished. For example, if the current day is Jan. 27, 2012, then a designated third quarter (01) of 2012 may not yet have finished. A value of a metric (e.g., premium pricing/rates) for Q1 2012 may represent a forecasted metric. FIG. 15A illustrates a forecasted current quarter of Q1 2012 as an example. Generally, the forecasted current quarter may be calculated based, in part, on policy contracts that have been bound during the current, unfinished quarterly period, where the data on the premiums of the policy contracts (or other parameters) may be continuously aggregated based on a shorter time period (e.g., by day, hour, minute, second rather than monthly or quarterly). Insurance transaction data for an unfinished quarter is generally data that has not been released by the system for general reports and aggregation. The forecasted current quarter may also be calculated by extrapolating the percentage change of prior quarters with the information collected for the current unfinished quarter.

FIG. 15B illustrates another combination of insurance transaction statistics that includes percent change in premiums broken down by a number of insurance industries for a selected product. An alternative embodiment may involve insurance transaction statistics that include percent change in premiums broken down by a number of insurance products for a selected insurance industry. The arrangement of FIG. 15B includes a bar chart where insurance industries are displayed on a vertical axis with corresponding percent changes in premiums indicated as bars on a horizontal axis. FIG. 15B illustrates that one arrangement may include an adjacent second bar graph of the same configuration except with forecasted percent changes for each industry based on a current, unfinished quarterly period.

FIG. 15C illustrates another combination of insurance transaction statistics that include percent change in renewal premiums along with changes in components of the policies renewed. In particular, FIG. 15C illustrates the percent change in renewal rate and renewal PPM and percent changes in policy limits, policy exposure amounts, and policy premiums.

The sixth set of statistics and the set of display arrangements may be used to start a price discussion with an insurance carrier. A broker may be able to compare current premium pricing against recent or historical pricing to identify pricing trends and develop optimal broking strategies. The combination of insurance transaction statistics may also assist a broker in preparing early renewal strategies and to manage client's renewal expectations.

The information combination and display arrangement may benefit a broker in the following situations. A first situation is when a broker is developing a renewal strategy plan for a client in a particular industry, for example, the aviation industry. The broker may use the information combination and display arrangement to provide a real-time pricing comparison of where the aviation insurance market is currently to where it was the previous year. If the rates are down about 1%, for example, from last year, the broker may advise the client that a significant market-driven rate increase may be unlikely.

In a second example, an insurance broker may be approached by a client who discovers from general news sources that the liability market may be hardening, meaning that the client may experience a 10% increase, for example, during the 2010 renewal cycle. In this situation, the client may be concerned about the client's upcoming products liability placement. Using the information combination and displays, a broker may be able to advise the client that while the general liability marketplace may appear to be hardening, the products liability marketplace may only be experiencing a modest hardening (e.g., a 1% to 2% increase).

A third illustrative situation involves determining a broking strategy. For example, an incumbent insurance carrier may have indicated that a construction client can expect a 5% price increase at renewal time. By consulting the information combination and display arrangements, a broker may quickly assess that rates for the construction industry have declined by 1%. Because the client's losses have remained relatively stable and their exposure values have decreased, the broker may be able to recommend remarketing at renewal (i.e., plan for new policy submissions to other carriers).

FIG. 16A illustrates a data display arrangement of one of three key metrics over a period of time that may be referred to as a “trading flow” set or display arrangement. The three key metrics may be a submission flow, a quote rate, and a Hit Rate. FIG. 16B illustrates a particular example of a submission flow statistic. The length of the periods for the key metrics may be adjusted, for example, to be monthly or quarterly periods. The key metrics may be indexed (categorized or narrowed) by insurance product, insurance industry, or region association (e.g., North American region). In an embodiment, the key metrics may also be indexed by carrier appetite, incumbency, and carrier division. Indexing by carrier appetite may include filtering the metric based on the capacity or requested limit of a carrier to accept submissions. Indexing by incumbency may include filtering the metric based on policy transactions that remain with an existing carrier. With respect to carrier divisions, indexing may be performed differently based on the entity accessing the data. For example, indexing may be performed differently for a carrier than a sub-carrier. Generally, indexing data may refer to a method of identifying data that has a particular characteristic or belongs to a particular category. This may be done, for example, by associating a tag, flag, or other parameter with the data. With respect to using a database, indexing may refer to associating a parameter with a discrete unit of data. The association of a parameter may be referred to as tagging the data or applying a flag to the data. More particularly, where a database includes a database record that may be represented as a row of a table, indexing the database record may involve associating a field or including a field with the database record to identify the database record or row with a particular category or characteristic. The associated parameter may then be used in various functions to separate database records by the characteristic. The aggregated insurance transaction statistics may be separated into specific categories such as an insurance product and/or an insurance industry. This separation into categories may be referred to herein as categorizing, narrowing, specifying, etc. In some cases, indexing of the data may also refer to the separation of the data into a specific category. Generally, when a statistic is described herein to be indexed or specific to a particular category, then the statistic may have been aggregated to exclude records that do not belong to the particular category when calculating the statistic. Thus, for example, when the “submission flow” is indexed by an insurance product such as property insurance, then the “submission flow” metric may be aggregated for and specific to only the property insurance transactions, excluding other transactions from product categories outside of property insurance.

For each of the three metrics, the display arrangement may narrow the metric data to (e.g., show aggregate data that is specific to) each of a set of insurance carriers, the set of insurance carriers including at least a selected or subject insurance carrier, wherein the subject insurance carrier may be displayed for comparison. The subject insurance carrier may correspond to a subscribed insurance carrier viewing the statistic or display arrangement of the statistic. The set of insurance carriers may be a subset of a total set of insurance carriers for which transaction data exists within the insurance marketplace environment. The subset of insurance carriers may be determined by a system parameter or by a user selection (e.g., by the selected insurance carrier using the described system). An average of each of the three metrics may be included, wherein the average is calculated based on the subset of carriers including the subject insurance carrier (in some embodiments, the subject carrier may not be included in the average).

Each of the three key metrics may be arranged for display as a line graph, as illustrated in FIG. 16A. A vertical axis of each graph may correspond to a value of the metric while a horizontal axis of the graph may represent time periods (e.g., divisions based on monthly or quarterly periods). FIG. 16A illustrates that each of the metrics may be indicated on the vertical axis as a percentage of overall transaction submissions. Each insurance carrier may be represented as a different color line. It should be noted that while FIG. 16A illustrates the data as a line graph, other types of graphs may be used as well. Each metric displayed may also include a plot of an average value of the metric for the determined set of competitors. In some embodiments, the average may be calculated to include the subject insurance carrier, while, in other embodiments, the average may be calculated to exclude the subject insurance carrier. FIG. 16B illustrates a submission flow graph for a casualty/liability segment where only the subject carrier is plotted along with an average competitor line. When comparable insurance carriers (e.g., peers) are difficult to determine for a selected insurance carrier, the average competitor plot may be displayed as a default without competitor (peer) plots. This may be the case when there are only a few competitors in a particular insurance segment and revealing submission data for a competitor(s) may indicate the identity of the competitor (i.e., the competitor information may not be anonymous). In an embodiment, individual competitors (carrier) may not be displayed unless at least a threshold number (e.g., three, five, ten, etc.) of comparable carriers can be determined. In an embodiment, an average may only be shown if there are at least a threshold number of comparable carriers.

The set of competitors may be determined based on a number of pre-programmed parameters such as, but not limited to, insurance industry and product, aggregate premiums, deductible/and or limit amounts of policies placed, etc. In one embodiment, the set of competitors may be determined by choosing carriers that rank above and below a threshold amount or level from the subject carrier in terms of premium volume. If the subject carrier is first in terms of premium volume ranking, then the next two carriers may be chosen as peers. If the subject carrier is the last in terms of premium volume ranking, then the preceding two carriers may be chosen.

Generally, a “submission flow” statistic may be a metric indicating an aggregate number of submissions for the selected insurance carrier over a total number of submissions. The “submission flow” statistic may also include a submission flow indicating an average number of submissions for a first set of insurance carriers that are competitors to the selected carrier over the total number of submissions. A “submission flow” display arrangement may be used to determine patterns of submissions for competitor insurance carriers by product and industry and the display may allow a selected insurance carrier to make an advantageous, timely solicitation for submissions in particular insurance areas (e.g., for a specific insurance product or industry).

A “quote rate” statistic may be a metric indicating an aggregate number of submissions to a carrier(s) that have been quoted for by the carrier(s). The “quote rate” statistic may be indicated as a percent of the aggregate number of submissions to a carrier(s) that have been quoted for by the carrier(s) over a total number of submissions to the carrier(s). A carrier may not quote on all submissions it receives.

A “hit rate” statistic may be a metric indicating an aggregate number of quoted submissions that are bound. In other words, the “hit rate” may represent a number of submissions that have been quoted by the insurance carrier and are accepted by insurance clients or policy buyers. The “hit rate” statistic may be indicated as a percent of the aggregate number of quoted submissions that are bound over a total number of quoted submissions. Generally, the “hit rate” statistic may be specific to a particular carrier or set of carriers. For example, the “hit rate” statistic may be an aggregate number of binds for a carrier over a total number of transactions quoted by the carrier. Similarly, for a set of carriers, the “hit rate” statistic may be an aggregate number of binds for the set of carriers over a total number of transactions quoted by the set of carriers.

FIG. 17 illustrates a data display arrangement of key metrics for four previous quarters for both the selected insurance carrier and top competitors (peers) to the insurance carrier. The set of competitors used in this data arrangement may be based on a paid service level for the selected or subject carrier. The key metrics may be narrowed by product, industry, and region. In this data arrangement, the key metrics may be further narrowed by incumbent or non-incumbent parameters. In an embodiment, the key metrics may also be indexed by carrier appetite and carrier division. Indexing by carrier appetite may include filtering the metric based on the capacity or requested limit of a carrier to accept submissions. With respect to carrier divisions, indexing may be performed differently based on the entity accessing the data. For example, indexing may be performed differently for a carrier than a sub-carrier. The key metrics may include “submission flow”, “quote rate”, “hit rate”, and “conversion rate.”

Conversion rate may represent the proportion of trades which ultimately result in binding quotes. Conversion rates may be calculated by multiplying submission rates (number of submissions for a carrier over total number of submissions) by quote rates (number of submissions quoted by one or more insurance carriers over a total number of submissions) and then by hit rates (number of quoted submissions that are bound over a total number of quoted submissions). As with submission rates, knowledge of conversion rates may allow a carrier to focus on particular industries and products in which it has an appetite for risk, and to greatly improve its service offering. The transparency of conversion rates, and carriers' desire to improve this metric, may increase competition for the benefit of clients.

FIG. 19A illustrates a data display arrangement 1900 of insurance policy trade declination statistics. A subject carrier is labeled “Demo” in FIGS. 19A, 19B, and 19C. The declination statistics may involve aggregate declination reasons for both clients and insurance carriers as identified by brokers of the broker company during transaction recording. For example, the total declined trades by an insurance carrier may be decomposed or separated into constituent parts, for example, by carrier declination reasons 1906. In one embodiment, the top declination reasons specific to the selected insurance carrier may be displayed along with a corresponding percentage indicating the rest of the market (provided as a benchmark), and labeled “market” 1904 in FIG. 19A. The declination statistics may be calculated to be specific for insurance product, insurance industry, and/or deal size (e.g., FIG. 19B is specific to a property category). Deal size may be separated where large deals are deals with premiums above an aggregated average premium or median premium while small deals are deals with premiums below the average or median. FIG. 19B illustrates that the carrier declination reasons 1906 may include at least one reason from the set of reasons including uncompetitive price, capacity, class of business, exposures, and premium threshold or client financials. Client rejected trades may be decomposed in a similar manner as illustrated in FIG. 19C. Client rejection or declination reasons 1922 may include at least one reason from the set of reasons including different quote accepted, inferior pricing, inferior terms and conditions, incumbent relationship, and carrier financials or perceived weakness.

Generally, the global risk insight platform carrier dashboard 190, illustrated in FIGS. 1E and 1F, may provide an overview from both the carrier and client perspective on the reasons why insurance proposals have been declined. This information may be input by the broker at the time that either the carrier or the client declines a quote, and is selected from one of many standardized declination reasons. Declination reasons may include capacity, class of business, loss experience, negative prior experience, no response, terms and conditions, uncompetitive, and/or underwriting concerns. Declination reasons may also be indexed by carrier appetite, incumbency and carrier division, similar to other display arrangements described herein. The carrier may then be presented with the top five reasons for declination (as a percentage of the total reasons for declination), and separated further according to the carrier's preferences by reference to product, industry and deal size. Higher subscription level carriers may be able to see their performance measured against a market average. By contrast, lower subscription level carriers may see only the market average. The declination display arrangements may be performance enhancing for the selected insurance carrier, as it may enable insurance carriers to determine key areas in which their performance can be improved.

To receive greater insight into trade declination metrics, in some embodiments, a particular bar in any one of the bar graphs represented in screenshots 1900, 1910, and 1920 may be selected to cause presentation of a detailed declination record analysis, for example as illustrated in a screenshot 1930 of FIG. 19D. Turning to FIG. 19D, detailed declination analysis includes information such as client name, line of business, effective date, expiration date, risk description, carrier declination reason, and deal size.

Portions of declination metrics data, either at the more abstract level presented in FIGS. 19A through 19C or on a refined level as presented in FIG. 19D, may be shared with other subscribers of the insurance marketplace environment (e.g., to contribute to peer metrics of competitors). Sharing, in some embodiments, is enabled through an anonymizing feature of the global risk insight platform, such that other subscribers cannot recognize data points as belonging to a particular subscriber.

FIG. 20A illustrates an insurance transaction statistic and data arrangement referred to as “broker insights.” The “broker insights” transaction statistic set may be based on an insurance carrier performance survey conducted by the insurance broker company that classifies and quantifies broker perceptions of insurance carriers across a number of areas or attributes. The surveys may be performed or executed on a periodic basis (e.g., at least once a year) on broker computers (e.g., based on interactions with clients). The surveys may be asked while performing general client processing.

A summary metric from the survey may be a Net Promoter Score (also referred to herein as an “NPS”) which may represent an overall metric compiled to indicate the proportion of respondents that reported positive, negative, or neutral towards a carrier. The NPS may be presented for the selected or subject insurance carrier and competitors associated with the selected insurance carrier across a number of dimensions, including respondent (a surveyed entity) line of business, client segment and respondent role.

An NPS rating may be obtained, for example, by asking customers, on a zero to ten rating scale, how likely they would be to recommend a product to a friend or colleague. Based on their responses, customers may be categorized into one of three groups: Promoters (e.g., 9-10 rating), Passives (e.g., 7-8 rating), and Detractors (e.g., 0-6 rating). The percentage of Detractors may be subtracted from the percentage of Promoters, for example, to obtain a Net Promoter Score. While a scale of 10 is used in the example above, any scale range may be implemented. Ranges for each category type may be a high, middle and low range. In particular, promoters would be a high end range, passives would be a middle range, and detractors would be a low end range.

Under a system implementing an NPS-based survey, broker company associates may be encouraged to supplement the question with further queries, thereby soliciting the reasons for a customer's rating of that company or product. The reasons may then be provided to front-line employees and management teams for follow-up action. Broker feedback may be used extensively when engaging actively with insurance carriers in assessing areas where carriers could improve their responsiveness for clients' benefit.

In the described system, NPS ratings may be obtained for key activity areas, such as underwriting performance and claims performance, and key product areas such as property, construction and casualty/liability. Follow-up questions may also be asked around a set of “attributes” of the carrier's performance, such as willingness to pay, empathetic claims handling, and efficiency. The carrier's score (based on the scale often) for each NPS attribute may then be presented against those of each of its top competitors (presented anonymously). In an embodiment, the top ten competitors may be presented. Carriers may typically regard NPS and attribute data points as key metrics in improving their product and service offering.

FIG. 20B illustrates a more granular review of Broker insight statistics including a detailed display on carrier performance based on segments of the lifecycle of the broking process. The lifecycle may include, for example, underwriting, post-placement, claims and overall relationship attributes. In one embodiment, survey demographics may be viewed from the Carrier Dashboard described in relation to FIGS. 1E and 1F to show the number and make-up of respondents to the survey in each Carrier Dashboard region.

Carriers' enhanced insights obtained from use of the Brokers Insight display may enable insurance carriers to deliver distinctive value for clients, by giving them a clearer understanding of the reasons underpinning success and failure, improving client satisfaction and competing more effectively. More carriers are able to benefit from the service, including those whose size and value currently precludes them from purchasing access to the system. Industry affiliates would be granted insights into macro and micro industry trends, which would enable them to assess insurance company performance.

FIG. 21A illustrates a data display arrangement referred to as a pipeline. The pipeline display generally shows transaction opportunities for an insurance carrier forecast over an upcoming period of time (e.g., over an upcoming six months). Generally, a pipeline opportunity represents an expiring policy that may be up for renewal. In some embodiments, a pipeline opportunity may also represent new policy interest. In other embodiments, a pipeline opportunity may also represent policies that may not be up for renewal in the near future, but where a client owning the policy may have a desire to renew early or restructure its policy. The pipeline opportunities may be filtered or narrowed by insurance product and insurance industry and by region. The pipeline opportunities may also be filtered or indexed by carrier appetite and incumbency. In an embodiment, pipeline opportunities may also be filtered by cross sale opportunities where the condition of one policy may present opportunities to sell a different policy. Additional reports may be displayed as an option based on a subscription level.

There may be two elements to the pipeline opportunity monitoring section of the carrier dashboard. The first may be a statistical analysis of a broker's renewal book of business, and the second may be a report of upcoming policy renewal opportunities. The pipeline display arrangement shows for each selected geographic area the total number and total value of renewal possibilities on a broker's book of business falling due in the next six months. Carriers may be able to view this information by product or by industry. In an embodiment, all carriers may have the same view of information. In an embodiment, not all carriers will have the same view. This display arrangement may assist carriers in planning their future business.

FIG. 21B illustrates a pipeline report that may be generated from a pipeline display that includes a column called “Policy ID.” Each row in the pipeline report may be a unique entry having a corresponding unique policy identifier relating to the underlying pipeline opportunity that the row may represent. The pipeline report lists opportunities arising from existing policies that are brokered that may be due for renewal in the near term. The information available in this display arrangement may include client name, industry, product, approximate deal size, region, and month of maturity. Carriers may have the ability to scan the record themselves for potential opportunities. This ability may be based on a service level. Once an insurance carrier becomes aware of a particular risk opportunity, they may be able express their interest in the opportunity. When a selected insurance carrier determines a particular opportunity in which the insurance carrier is interested, the policy ID may be referenced in a “register policy interest” screen for inputting an interest (not shown). Once the policy interest screen is filled out and submitted, a computer system implementing the methods described herein may then notify the broker company of the interest in the selected pipeline opportunity for further action. If a client is receptive to obtaining quotes from alternative carriers, a broker may then attempt to secure options for those carriers the client has selected.

Pipeline opportunity management in essence may operate as an introduction service prior to policy renewal time, increasing the visibility of upcoming renewal opportunities to carriers that have the risk appetites for that client's custom or specifications and thus broadening the clients' choice (e.g., by motivating insurance carriers to bid for renewals) where options may have otherwise been restricted to an incumbent. This may result in the introduction of increased competition into relationships that were previously locked, which may tend to result in more suitable coverage on better terms and conditions.

Traditional means of brokering introductions between clients and carriers at renewal time may have been somewhat haphazard and reliant entirely on the knowledge possessed by individual brokers. The carrier dashboard introduces a sophisticated and systematic introduction service which allows proactive matching of client needs to carrier risk appetite and which, in turn, may allow all parties to deploy their resources more efficiently and objectively.

FIG. 21C illustrates a screenshot 2140 including a bar graph representing opportunities at various stages 2144, where a broker initially registered interest in the opportunities via the global risk insight platform. By registering interest via the global risk insight platform, features of the global risk insight platform can push the interest request information to insurance carriers to prompt a timely response regarding the opportunity. As illustrated in the screenshot 2140, blocks of opportunities span the entire timeline of stages 2144, from a pending stage 2144a (e.g., pending a response from the carrier) to a bound stage 2144g. Intermediate stages represented may include, for example, a submitted stage 2144b, a carrier declined stage 2144c, a client rejected stage 2144d, a not suitable for submission stage 2144e, and a quoted stage 2144f. Additionally, the bar graph illustrates a total number of opportunity interest requests 2146 placed by insurance brokers during a time period defined by a “start” drop-down menu 2142a and an “end” drop-down menu 2142b. The carrier may optionally filter the information presented in the bar graph using a “category” drop-down menu 2142c for filtering by insurance product category, a “division” drop-down menu 2142d for filtering by carrier division, and/or a “region” drop-down menu 2142e for filtering by geographic region.

FIG. 21D illustrates a screenshot 2160 of a detail report regarding interest brokers have expressed in opportunities during a selected time period. A carrier may have accessed the screenshot 2160, for example, by selecting the column of the bar graph in the screenshot 2140 of FIG. 21C indicating total number of opportunity interest requests 2146. The detail report includes a table of opportunities registered by an interest tracker system of the global risk insight platform. Each opportunity may include a combination of the following details: interest registration date, client name, product, line of business, policy expiration date, client industry, broker name(s), broker email(s), deal size, and status. As in FIG. 21C, the series of drop-down menus 2142 are available for filtering the data presented in the table, for example by time period (using the “start” menu 2142a and “end” menu 2142b), category (using the “category” menu 2142c), carrier division (using the “division” menu 2142d) and/or geographical region (using the “region” menu 2142e).

FIG. 22A illustrates a data display arrangement referred to as “premium share”. The “premium share” display or statistics set may provide a breakdown of carrier written premium, overall market premium share, and a ratio or percent of carrier premium share over total market premium share. These statistics may be specific to each of a set of insurance product lines over the past 12 months in a selected geographic region (e.g., country).

The “premium share” statistics and corresponding display arrangements may provide a subject insurance carrier a general overview of their place in the overall market and the concentration of their business by segment.

The carrier dashboard described herein generally provides selected information to those insurance carriers that procure access to the carrier dashboard computing system. An essential function of the described system may be to provide an objective benchmarking tool by reference to which carriers may assess their performance in relation to other carriers on an anonymized and aggregated basis. This may allow carriers utilizing the system to focus their efforts on aspects of their business which require improvement, and ultimately to develop a better service offering for their existing and potential clients.

The system may function to collate and process historical and aggregated information crucial to the insurance policy decisions specific to insurers separately by class and geography around the globe. The information provided may include various business performance analytics that do not include individual trade pricing data. The data may be presented in a user-friendly format that may indicate in general terms the extent and approximate value of coverage which carriers are quoting and binding in particular classes and territories. Sophisticated algorithms may allow a broker to predict insurance buying behavior in the coming months, thereby informing strategic marketing and buying decisions and enabling its clients to stay ahead of the market.

Insurance carriers may also be able to obtain accumulated information on classes of business and territories in which they are interested. This benchmarking process may allow carriers to assess in general terms how they are performing relative to their peers, which may enable them to improve their products and services, and to make them more attractive to potential clients. Moreover, the platform may provide insight into market conditions across multiple geographies. As such, access to the GRIP technology may provide an indirect benefit of forging a more coherent marketplace, by facilitating cross-border coverage.

Generally, the global risk insight platform may utilize a relational database for the carrier dashboard. In some embodiments, an analysis database (cube) may be used. The database may be implemented with a database schema that includes tables containing the aggregated data, prepared and loaded by a broker procedure, for example using an SQL Server Integration Service, for the appropriate reporting period. The data in the database may comprise all necessary data to populate different screens of the dashboard. The database schema may exist primarily to service the Carrier Dashboard application and may be designed to make retrieval as simple as possible and optimize query performance. Most, if not all, aggregation and data manipulation may be performed upon loading of the data into the dashboard schema. Based on this design principle, the schema for the dashboard schema may use a small set of tables for each panel (display arrangement) within the dashboard. These tables may be pre-aggregated by an extract transform load (ETL) process to minimize joins and data manipulation at run-time. In addition, the database may use views (or indexed views if possible) to further minimize joins for the display panel chart data. Therefore the SQL queries will just do simple queries—avoiding complex SQL. The ETL process may pre-calculate averages for each carrier/product/industry combination as required by the panels. It may also pre-calculate the “market” values, i.e. sum of competitors where appropriate. A refresh of the data within the Dashboard database may be performed regularly by an ETL process. This process may include aggregation and transformation of the data to fit the analytical schema design of the Carrier Dashboard database and its retention of historical data. Some aggregation and data manipulation may also be performed upon user request through the Carrier Dashboard application.

The default dataset for the dashboard may be the most recent reporting period, e.g. the current month, quarter or year, as appropriate. However, to facilitate future extension of the dashboard, including potential reporting data comparison, the database schema may support the tagging of data according to the reporting period for which it was first supplied. This means that the data in the dashboard schema may grow over time and each new data load may augment the existing data, even if portions of it are potential copies of previous data.

In some embodiments, one or more computer devices are used to generate a risk portal that allows business entities to view and interact with a wide range of risk data. As used herein, business entities are not limited to for profit entities and includes government entities and nonprofit entities. FIG. 23 illustrates an example portal screenshot 2300 that includes risk data. The data used to populate screenshot 2300 may be transmitted from one or more devices, such as networked servers. The servers and/or other computer devices may generate a number of portals that each contains risk data relevant to a particular business entity.

Portal screenshot 2300 is divided into several sections. A global risk insight platform section 2302 may be included to allow a business entity to access information such as pricing insights, research insights and insurance market insights. In some embodiments, the data used to populate global risk insight platform 2302 may originate from a database of insurance placement data, delivering critical marketplace intelligence. The platform, for example, may provide insight across carriers, industries and products on every level, from individual transactions to global trends. The platform may also enable benchmarking of like risks placed throughout the globe, and at what price, in order to help clients evaluate insurer performance and anticipate shifts in the market.

Portal screenshot 2300, in some implementations, includes a video section 2304. Video section 2304 may include links to recorded programs 2306 that may be general in nature and/or targeted toward specific business entities. For example, a recorded program may relate to mitigating reputation risk concerns for a particular business entity. Video section 2304 may also include a live TV feed section 2308. Live TV feed section 2308 may be used to provide real time information to business entities. For example, during a hurricane live TV feed section 2308 may include an expert explaining how current hurricane developments may impact a business entity.

A risk management tools section 2310 may be included to provide users with a variety of risk management tools. A worldwide risk levels link 2312 may be selected to display a map that illustrates and explains risk levels around the world or within a specific geographic region. The map may be color coded to represent overall risks to supply chains, manufacturing capabilities, reputation and other elements. A global risk insight platform benchmarking service link 2314 may be selected to request a benchmark report.

Risk management tools section 2310 may also include a risk maturity index section. The risk maturity index section may include a link to provide an overview of a risk maturity index. In one embodiment, a risk maturity index is created from answers to a questionnaire on risk management processes, corporate governance and risk understanding.

Portal screenshot 2300, in some implementations, also includes risk information derived from one or more social media sources, such as blogs, Twitter® by Twitter, Inc. of San Francisco, Calif. and Facebook® by Facebook, Inc. of Menlo Park, Calif. Social media sources may show trends that are not reported by other sources of information. For example, a Facebook® group may be attempting to convince users to boycott a product and this event may not be reported by traditional news sources. Social media sources may also report news sooner than other traditional news sources.

Social media sources may be monitored to provide industry risk news in an industry risk news section 2318, reputation risk news in a reputation risk news section 2320 and supply chain risk news in a supply chain risk news section 2322. In some embodiments, business entities provide search criteria, search templates or other information used to located relevant social media posts. In various embodiments, social media information may be filtered with one or more computer devices, manually or with a combination of computer devices and manual filtering. Each section may include a news feed that identifies the social media source and provides a brief summary of the content. The news feed may be in the form of a hyperlink that allows user to link to the source of the content. In some embodiments, users may select the social media sources that will be monitored. Users may also provide specific areas to monitor and may provide search criteria. For example, a user may decide to delete industry risk news and substitute industry risk news section 2318 with a risk section relating to a newly released product. The user may provide search criteria for the newly released product.

Portal screenshot 2300 may also include a graph section 2324 that illustrates counts of mentions of the news events by a number of social media sources over a predetermined time period. Graph section 2324 shows relative numbers of mentions by a number of social media sources for three events, Event A, Event B and Event C. The events may include, in some examples, natural disasters, company boycotts or any other types of events that represent risks to business entities.

FIGS. 28A and 28B illustrate various aspects of an exemplary architecture implementing a GRIP platform 2800. The high-level architecture includes both hardware and software applications, as well as various data communications channels for communicating data between the various hardware and software components. The GRIP system 2800 may be roughly divided into front-end components 2802 and back-end components 2804. The front-end components 2802 are primarily disposed within a client network 2810 including one or more clients 2812. The clients 2812 may be located, by way of example rather than limitation, in separate geographic locations from each other, including different areas of the same city, different cities, different states, or even different countries. The front-end components 2802 include a number of workstations 2828. The workstations 2828 are local computers located in the various locations 2812 throughout the network 2810 and executing various GRIP applications.

Web-enabled devices 2814 (e.g., personal computers, tablets, cellular phones, smart phones, web-enabled televisions, etc.) may be communicatively connected to locations 2812 and the system 2840 through a digital network 2830 or a wireless router 2831, as described below.

Referring now to FIG. 28A, those of ordinary skill in the art will recognize that the front-end components 2802 could also include a number of facility servers 2826 disposed at the number of locations 2812 instead of, or in addition to, a number of workstations 2828. Each of the locations 2812 may include one or more facility servers 2826 that may facilitate communications between the web-enabled devices 2814 and the back-end components 2804 via a digital network 2830, described below, and between the terminals 2828, 2828A of the locations 2812 via the digital network 2830, and may store information for a number of customers/employees/accounts/etc. associated with each facility. Of course, a local digital network 2884 may also operatively connect each of the workstations 2828 to the facility server 2826. Unless otherwise indicated, any discussion of the workstations 2828 also refers to the facility servers 2826, and vice versa. Moreover, environments other than the locations 2812, such as the kiosks, call centers, and Internet interface terminals may employ the workstations 2828, the web-enabled devices 2814, and the servers 2826. As used herein, the term “location” refers to any of these points of contact (e.g., call centers, kiosks, Internet interface terminals, etc.) in addition to the locations 2812, etc. described above.

The front-end components 2802 communicate with the back-end components 2804 via the digital network 2830. One or more of the front-end components 2802 may be excluded from communication with the back-end components 2804 by configuration or by limiting access due to security concerns. For example, the web enabled devices 2814 may be excluded from direct access to the back-end components 2804. In some embodiments, the locations 2812 may communicate with the back-end components via the digital network 2830. In other embodiments, the locations 2812 and web-enabled devices 2814 may communicate with the back-end components 2804 via the same digital network 2830, but digital access rights, IP masking, and other network configurations may deny access of the web-enabled devices 2814. The web-enabled devices may also connect to the network 130 via the encrypted, wireless router 2831.

The digital network 2830 may be a proprietary network, a secure public Internet, a virtual private network or some other type of network, such as dedicated access lines, plain ordinary telephone lines, satellite links, combinations of these, etc. Where the digital network 2830 includes the Internet, data communication may take place over the digital network 2830 via an Internet communication protocol. In addition to one or more web servers 2890 (described below), the back-end components 2804 include a central processing system 2840 within a central processing facility. Of course, the locations 2812 may be communicatively connected to different back-end components 2804 having one or more functions or capabilities that are similar to the central processing system 2840. The central processing system 2840 may include one or more computer processors 2862 adapted and configured to execute various software applications and components of the wireless customer data transfer system 2800, in addition to other software applications, such as a medication management system.

The central processing system 2840 further includes a database 2846 (which may include one or more databases). The database 2846 is adapted to store data related to the operation of the GRIP system 2800. The central processing system 2840 may access data stored in the database 2846 when executing various functions and tasks associated with the operation of the system 2800.

Although the GRIP system 2800 is shown to include a central processing system 2840 in communication with three locations 2812, and various web-enabled devices 2814 it should be understood that different numbers of processing systems, locations, and devices may be utilized. For example, the digital network 2830 (or other digital networks, not shown) may interconnect the system 2800 to a number of included central processing systems 2840, hundreds of locations 2812, and thousands of web-enabled devices 2814. According to the disclosed example, this configuration may provide several advantages, such as, for example, enabling near real-time uploads and downloads of information as well as periodic uploads and downloads of information. This provides for a primary backup of all the information generated in the wireless customer data transfer process. Alternatively, some of the locations 2812 may store data locally on the facility server 2826 and/or the workstations 2828.

FIG. 28A also depicts one possible embodiment of the central processing system 2840. The central processing system 2840 may have a controller 2855 operatively connected to the database 2846 via a link 2856 connected to an input/output (I/O) circuit 2866. It should be noted that, while not shown, additional databases may be linked to the controller 2855 in a known manner.

The controller 2855 includes a program memory 2860, the processor 2862 (may be called a microcontroller or a microprocessor), a random-access memory (RAM) 2864, and the input/output (I/O) circuit 2866, all of which are interconnected via an address/data bus 2865. It should be appreciated that although only one microprocessor 2862 is shown, the controller 2855 may include multiple microprocessors 2862. Similarly, the memory of the controller 2855 may include multiple RAMs 2864 and multiple program memories 2860. Although the I/O circuit 2866 is shown as a single block, it should be appreciated that the I/O circuit 2866 may include a number of different types of I/O circuits. The RAM(s) 2864 and the program memories 2860 may be implemented as semiconductor memories, magnetically readable memories, and/or optically readable memories, for example. A link 2835 may operatively connect the controller 2855 to the digital network 2830 through the I/O circuit 2866.

FIG. 28B depicts one possible embodiment of the front-end components 102 located in one or more of the locations 2812 from FIG. 28A. Although the following description addresses the design of the locations 2812, it should be understood that the design of one or more of the locations 2812 may be different from the design of others of the locations 2812. Also, each of the locations 2812 may have various different structures and methods of operation. It should also be understood that while the embodiment shown in FIG. 28B illustrates some of the components and data connections that may be present in a location 2812, it does not illustrate all of the data connections that may be present in a location 2812. For exemplary purposes, one design of a location is described below, but it should be understood that numerous other designs may be utilized.

Each of the locations 2812 has one or more tablets 2833 and/or a facility server 2826. The digital network 2884 and wireless router 2831 operatively connect the facility server 2826 to the number of tablets 2833 and/or to other web-enabled devices 2814 and workstations 2828. The digital network 2830 may be a wide area network (WAN), a local area network (LAN), or any other type of digital network readily known to those persons skilled in the art. The digital network 2830 may operatively connect the facility server 2826, the tablets 2833, the workstations 2828, and/or the other web-enabled devices 2814 to the central processing system 2840.

Each tablet 2833, workstation 2828, client device terminal 2828a, or facility server 2826 includes a controller 2870. Similar to the controller 2855 from FIG. 28A, the controller 2870 includes a program memory 2872, a microcontroller or a microprocessor (MP) 2874, a random-access memory (RAM) 2876, and an input/output (I/O) circuit 2880, all of which are interconnected via an address/data bus 2878. In some embodiments, the controller 2870 may also include, or otherwise be communicatively connected to, a database 2882. The database 2882 (and/or the database 2846 of FIG. 28A) includes data such as customer records, insurer information records, and other rules and miscellaneous information. As discussed with reference to the controller 2855, it should be appreciated that although FIG. 28B depicts only one microprocessor 2874, the controller 2870 may include multiple microprocessors 2874. Similarly, the memory of the controller 2870 may include multiple RAMs 2876 and multiple program memories 2872. Although the FIG. 28B depicts the I/O circuit 2880 as a single block, the I/O circuit 2880 may include a number of different types of I/O circuits. The controller 2870 may implement the RAM(s) 2876 and the program memories 2872 as semiconductor memories, magnetically readable memories, and/or optically readable memories, for example.

Either or both of the program memories 2860 (FIG. 28A) and 2872 may also contain machine-readable instructions (i.e., software) 2871, for execution within the processors 2862 (FIG. 28A) and 2874, respectively. The software 2871 may perform the various tasks associated with operation of the location or locations, and may be a single module 2871 or a number of modules 2871a, 2871b. While the software 2871 is depicted in FIGS. 28A and 28B as including two modules, 2871a and 2871b, the software 2871 may include any number of modules accomplishing tasks related to location operation.

In addition to the controller 2870, the tablets 2833, the workstations 2828 and the other web-enabled devices 2814 may further include a display and a keyboard as well as a variety of other input/output devices (not shown) such as a scanner, printer, mouse, touch screen, track pad, track ball, isopoint, voice recognition system, digital camera, bar code scanner, RFID reader, etc. A location employee may sign on and occupy each tablet 2833, workstation 2828 or client device terminal 2828a to assist the employee in performing his or her duties. Employees may sign onto the tablet 2833, workstation 2828 or the client device terminal 2828a using any available technique, such as entering a user name and password. If an employee signs on to the system using a tablet 2833, the network 2884 communicates this information to the facility server 2826, so that the controller 2870 may identify which employees are signed onto the system 2800 and which tablet 2833, workstation 2828 or client device terminal 2828a the employee is signed onto.

Various software applications resident in the front-end components 2802 and the back-end components 2804 implement functions related to location operation, and provide various user interface means to allow users (e.g., brokers) to access the system 2800. One or more of the front-end components 2802 and/or the back-end components 2804 may include a user-interface application 2811 for allowing a user to input and view data associated with the system 2800, and to interact with the GRIP system described below. In one embodiment, the user interface application 2811 is a web browser client, and the facility server 2826 or the central processing system 2840 implements a server application 2813 for providing data to the user interface application 2811. However, the user interface application 2811 may be any type of interface, including a proprietary interface, and may communicate with the facility server 2826 or the central processing system 2840 using any type of protocol including, but not limited to, file transfer protocol (FTP), telnet, hypertext-transfer protocol (HTTP), etc. Moreover, some embodiments may include the user interface application 2811 running on one of the web-enabled devices 2814, while other embodiments may include the application 2811 running on the tablet 2833 in a location 2812. The central processing system 2840 and/or the facility server 2826 may implement any known protocol compatible with the user-interface application 2811 running on the tablets 2833, the workstations 2828 and the web-enabled devices 2814 and adapted to the purpose of receiving and providing the necessary information during the data transfer process.

For purposes of implementing the GRIP system 2800, the user interacts with location systems (e.g., the central processing system 2840) via a number of web pages. FIG. 28C depicts a web server 2890 connected via the network 2830 to a number of tablets 2833 and other web-enabled devices through which a user 2892 may initiate and interact with the GRIP system 2800. The web enabled devices may include, by way of example, a smart-phone 2894a, a web-enabled cell phone 2894b, a tablet computer 2833, a personal digital assistant (PDA) 2894c, a laptop computer 2894d, a desktop computer 2894e, a portable media player (not shown), etc. Of course, any web-enabled device appropriately configured may interact with the GRIP system 2800. The web-enabled devices 2833 and 2894 need not necessarily communicate with the network 2830 via a wired connection. In some instances, the web enabled devices 2833 and 2894 may communicate with the network 2830 via wireless signals 2896 and, in some instances, may communicate with the network 2830 via an intervening wireless or wired device 2831, which may be a wireless router, a wireless repeater, a base transceiver station of a mobile telephony provider, etc. Each of the web-enabled devices 2833 and 2894 may interact with the web server 2890 to receive web pages, such as the web page 2898 depicted in FIG. 28C, for display on a display associated with the web-enabled device 2833 and 2894. It will be appreciated that although only one web server 2890 is depicted in FIG. 28C, multiple web servers 2890 may be provided for the purpose of distributing server load, serving different web pages, implementing different portions of the location web interface, etc.

Turning now to FIG. 28D, the web server 2890, like the facility server 2826, includes a controller 2806. Similar to the controllers 2855 and 2870, the controller 2806 includes a program memory 2808, one or more microcontrollers or microprocessors (MP) 2816, a random-access memory (RAM) 2818, and an input/output (I/O) circuit 2820, all of which are interconnected via an address/data bus 2822. In some embodiments, the controller 2806 may also include, or otherwise be communicatively connected to, a database 2824 or other data storage mechanism (e.g., one or more hard disk drives, optical storage drives, solid state storage devices, etc.). The database 2824 may include data such as customer web profiles, product data, web page templates and/or web pages, and other data necessary to interact with the user 2892 through the network 2830. As discussed with reference to the controllers 2855 and 2870, it should be appreciated that although FIG. 28D depicts only one microprocessor 2816, the controller 224 may include multiple microprocessors 2816. Similarly, the memory of the controller 2806 may include multiple RAMs 2818 and multiple program memories 2808. Although the FIG. 28D depicts the I/O circuit 2820 as a single block, the I/O circuit 2820 may include a number of different types of I/O circuits. The controller 2806 may implement the RAM(s) 2818 and the program memories 2808 as semiconductor memories, magnetically readable memories, and/or optically readable memories, for example.

In addition to being connected through the network 2830 to the user devices 2833 and 1694, as depicted in FIG. 28C, FIG. 28D illustrates that the web server 2890 may also be connected through the network 2830 to the central processing system 2840 and/or one or more facility servers 2826. As described below, connection to the central processing system 2840 and/or to the one or more facility servers 2826 facilitates the GRIP system 2800.

The program memory 2808 and/or the RAM 2818 may store various applications for execution by the microprocessor 2816. For example, an application 2832 may provide a user interface to the server, which user interface may, for example, allow a network administrator to configure, troubleshoot, or test various aspects of the server's operation, or otherwise to access information thereon. A server application 2834 operates to populate and transmit web pages to the web-enabled devices 2894, receive information from the user 2892 transmitted back to the server 2890, and forward appropriate data to the central processing system 2840 and the facility servers 2826, as described below. Like the software 2871, the server application 2834 may be a single module 2834 or a number of modules 2834a, 2834b. While the server application 2834 is depicted in FIG. 28D as including two modules, 2834a and 2834b, the server application 2834 may include any number of modules accomplishing tasks related to implantation of the web server 2890. By way of example, the module 2834a may populate and transmit the web pages and/or may receive and evaluate inputs from the user 2892 to facilitate in the wireless transfer of data from a first tablet to a second tablet, while the module 2834b may communicate with one or more of the back end components 104 to provide the requested data.

Typically, a user may launch or instantiate a user interface application (e.g., a web browser or other client application) from a web-enabled device, such as the web-enabled devices 2833 and 2894, to access the web server 2890 cooperating with the system 2840 to implement the GRIP system 2800.

One or more processors can be utilized to implement any functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

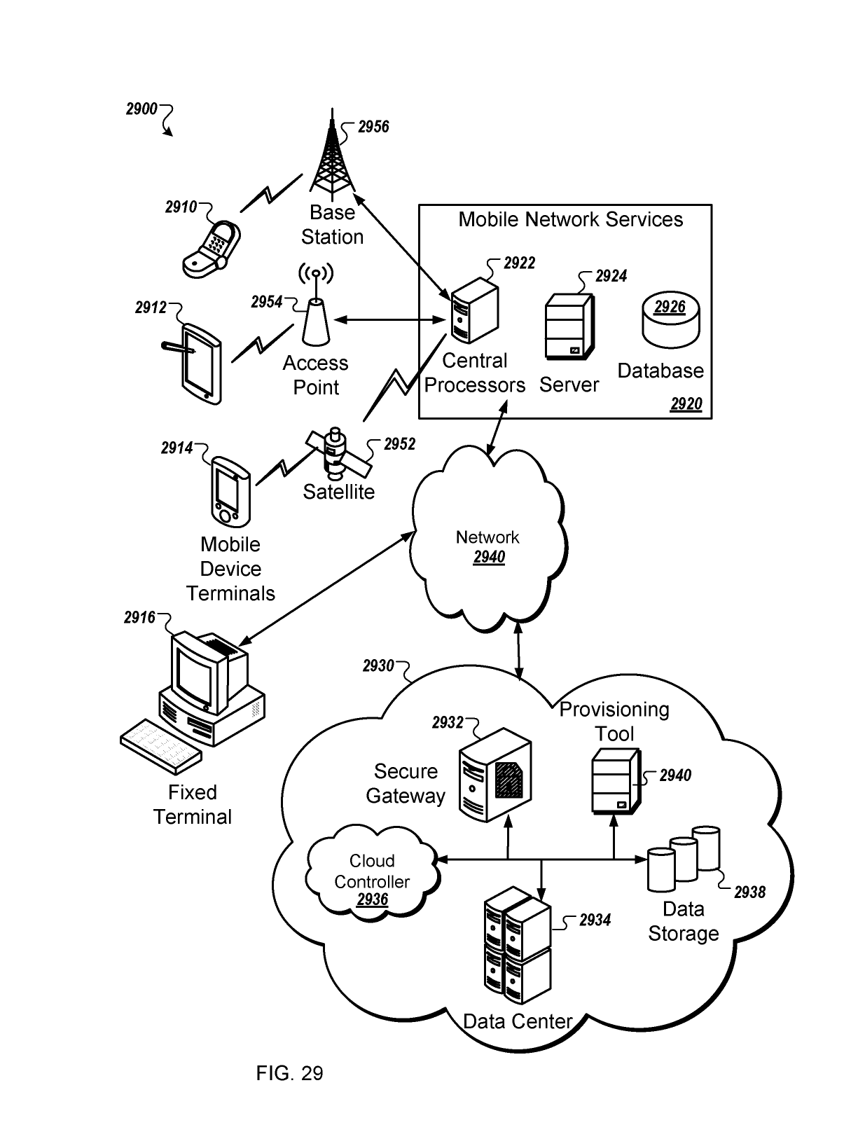

In some implementations, the functions and features described herein may also be executed by various distributed components of a system 2900. For example, one or more processors may execute these system functions, wherein the processors are distributed across multiple components communicating in a network. The distributed components may include one or more client and server machines, which may share processing, as shown on FIG. 29, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 2930, such as GOOGLE Cloud Platform™ to perform at least portions of methods or algorithms detailed above. The processes associated with the methods described herein can be executed on a computation processor, such as the GOOGLE Compute Engine by data center 2934. The data center 2934, for example, can also include an application processor, such as the GOOGLE App Engine, that can be used as the interface with the systems described herein to receive data and output corresponding information. The cloud computing environment 2930 may also include one or more databases 2938 or other data storage, such as cloud storage and a query database. In some implementations, the cloud storage database 2938, such as the GOOGLE Cloud Storage, may store processed and unprocessed data supplied by systems described herein.

The systems described herein may communicate with the cloud computing environment 2930 through a secure gateway 2932. In some implementations, the secure gateway 2932 includes a database querying interface, such as the GOOGLE BigQuery platform.

The cloud computing environment 2902 may include a provisioning tool 2940 for resource management. The provisioning tool 2940 may be connected to the computing devices of a data center 2934 to facilitate the provision of computing resources of the data center 2934. The provisioning tool 2940 may receive a request for a computing resource via the secure gateway 2932 or a cloud controller 2936. The provisioning tool 2940 may facilitate a connection to a particular computing device of the data center 2934.

A network 2940 represents one or more networks, such as the Internet, connecting the cloud environment 2930 to a number of client devices such as, in some examples, a cellular telephone 2910, a tablet computer 2912, a mobile computing device 2914, and a desktop computing device 2916. The network 2940 can also communicate via wireless networks using a variety of mobile network services 2920 such as WI-FI, BLUETOOTH, cellular networks including EDGE, 3G and 4G wireless cellular systems, or any other wireless form of communication that is known. In some embodiments, the network 2902 is agnostic to local interfaces and networks associated with the client devices to allow for integration of the local interfaces and networks configured to perform the processes described herein.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

1: (canceled)

2: A system of graphical user interfaces for managing transactional negotiations between a client and a provider, the system comprising:
a pipeline report graphical user interface comprising a plurality of rows, each row of the plurality of rows identifying a respective renewal opportunity of a plurality of renewal opportunities, wherein each renewal opportunity comprises
a respective client name of a plurality of clients, and at least one of a) a respective product category of a plurality of product categories and b) a respective product type of a plurality of product types, and
an interactive control configured, upon selection, to register interest in the respective renewal opportunity;
an interest registration graphical user interface, presented to a provider responsive to selecting a particular interactive control of a particular renewal opportunity of the plurality of renewal opportunities presented in the pipeline report graphical user interface, for registering interest in the particular renewal opportunity;
a stages of interest tracking graphical user interface, presented to the provider for tracking negotiation progress between the particular client of the particular renewal opportunity and the provider, wherein,
the stages of interest tracking graphical user interface comprises
a chart identifying a number of interest registrations at each stage of a plurality of stages, wherein the plurality of stages comprises a submitted stage, a declined stage, a quoted stage, and a bound stage, and
an interactive control associated with each stage of the plurality of stages,
wherein, upon registering interest via the interest registration graphical user interface, registration of the particular renewal opportunity is included within a count corresponding to the submitted stage; and
a detailed interest tracking graphical user interface, presented to the provider responsive to selecting a particular stage of the plurality of stages within the stages of interest tracking graphical user interface for tracking negotiation details related to the particular renewal opportunity, wherein
the detailed interest tracking graphical user interface comprises a plurality of rows identifying a respective registered opportunity of a plurality of registered opportunities, wherein
each row of the plurality of rows comprises a registration date, the client name, the respective product of the plurality of products, and a respective status, wherein the status corresponds to a respective stage of the plurality of stages of interest, and
a particular row of the plurality of rows corresponds to the particular renewal opportunity.

3: The system of claim 2, wherein the stages of interest tracking graphical user interface further illustrates a total number of opportunity interest requests placed within a timeframe.

4: The system of claim 3, wherein the stages of interest tracking graphical user interface further comprises at least one timeframe control configured, upon selection, to filter the presented information within an adjusted timeframe.

5: The system of claim 2, wherein the stages of interest tracking graphical user interface comprises an interactive product type control configured, upon selection, to present the number of interest registrations at each stage of the plurality of stages as the number of interest registrations corresponding to a selected product type of the plurality of product types.

6: The system of claim 2, wherein the stages of interest tracking graphical user interface comprises an interactive product type control configured, upon selection, to present the number of interest registrations at each stage of the plurality of stages as the number of interest registrations corresponding to a selected carrier division of a plurality of carrier divisions.

7: The system of claim 2, wherein:
the pipeline report graphical user interface identifies the plurality of renewal opportunities within a date range corresponding to at least one of a) a registration date and b) a policy expiration date; and
the pipeline report graphical user interface comprises an interactive timeframe control configured for adjusting the date range.

8: The system of claim 2, wherein the pipeline report comprises an interactive product type control configured, upon selection, to cause filtering of the plurality of rows based upon a selected product type of the plurality of product types.

9: The system of claim 2, wherein:
each renewal opportunity comprises a respective geographic region of a plurality of geographic regions; and
the pipeline report graphical user interface comprises an interactive geographic region control configured, upon selection, to cause filtering of the plurality of rows based upon a selected geographic region of the plurality of geographic regions.

10: The system of claim 2, wherein the detailed interest tracking graphical user interface includes, for each row of the plurality of rows, respective broker contact information.

11: The system of claim 2, wherein the pipeline report graphical user interface comprises another plurality of rows each corresponding to a respective opportunity to enter into a transaction for a new insurance policy.

12: A system comprising:
means for receiving, via a network from a first set of computing systems, a plurality of registrations, wherein
each respective registration of the plurality of registrations corresponds to a respective policy of a plurality of policies, and
each respective registration indicates interest, by a corresponding entity associated with a respective computing system of the first set of computing systems, in pursuing a transaction associated with the respective policy;
means for receiving, from another computing device, a request for a pipeline opportunity report, wherein
the request comprises a) at least one timeframe attribute and b) at least one policy attribute;
means for identifying, in real time responsive to the request, two or more registrations of the plurality of registrations, each registration of the two or more registrations including
a respective date coinciding with a first timeframe attribute of the at least one timeframe attribute, and
a respective policy attribute corresponding to a particular policy attribute of the at least one policy attribute, wherein at least a portion of the two or more registrations each correspond to one of a plurality of preexisting policies expiring within a given timeframe identified by the first timeframe attribute;
means for preparing, for presentation upon the other computing device, a graphic presentation regarding the two or more registrations, wherein the graphic presentation includes, for each registration of the two or more registrations, information regarding the respective policy; and
means for providing, via the network, to the other computing device, access to the graphic presentation via a dashboard interface.

13: The system of claim 12, wherein the graphic presentation comprises a plurality of input controls configured, upon selection, to provide, via the network to the dashboard system, one of a) a respective updated value of the at least one timeframe attribute, and b) a respective updated value of the at least one policy attribute.

14: The system of claim 12, wherein each registration of the plurality of registrations corresponds to a respective product type of a plurality of product types, and the graphic representation comprises an interactive product type control configured, upon selection, to cause filtering of the two or more registrations based upon a selected product type of the plurality of product types.

15: The system of claim 12, wherein:
each registration of the plurality of registrations corresponds to a respective geographic region of a plurality of geographic regions; and
the graphic representation comprises an interactive geographic region control configured, upon selection, to cause filtering of the two or more registrations based upon a selected geographic region of the plurality of geographic regions.

16: The system of claim 12, wherein the first timeframe attribute identifies a date range corresponding to at least one of a) a registration date and b) a policy expiration date.

17: The system of claim 12, wherein the at least one policy attribute comprises one or more of i) a product category, ii) an insurance carrier division, iii) a geographic region, iv) a client industry, iv) a product type, and v) a deal size.

18: The system of claim 12, wherein at least a subset of the plurality of registrations correspond to a respective opportunity to enter into a transaction for a new insurance policy.

19: The system of claim 12, wherein at least a subset of the plurality of registrations correspond to a respective opportunity for insurance carriers other than an incumbent insurance carrier to enter into a transaction for replacement of a preexisting insurance policy upon expiration of the preexisting insurance policy.

20: The system of claim 12, further comprising:
means for receiving, responsive to providing the graphic presentation, a request for a detailed pipeline opportunity report; and
means for preparing, for presentation upon the other computing device, a second graphic presentation regarding at least one of the two or more registrations, wherein the second graphic presentation includes, for each registration of the at least one registration, detailed information regarding the respective policy.

21: The system of claim 12, wherein the second graphic presentation comprises a means for registering interest with a selected policy corresponding to one of the at least one registration.
